(19) United States
(12) Patent Application Publication
(10) Pub. No.: US 2026/0179793 A1
(43) Pub. Date: Jun. 25, 2026

(54) PIPE CONNECTION ASSEMBLY

(71) Applicant: GE-Hitachi Nuclear Energy Americas LLC, Wilmington, NC (US)

(72) Inventors: Louis C. EICHENBERGER, Weatherford, TX (US); Michael A. ARCARO, Wilmington, NC (US)

(73) Assignee: GE-Hitachi Nuclear Energy Americas LLC, Wilmington, NC (US)

(21) Appl. No.: 18/989,825

(22) Filed: Dec. 20, 2024

(51) Int. Cl. G21C 13/036; F16L 37/107; F16L 37/252

(52) U.S. Cl. CPC G21C 13/036; F16L 37/107; F16L 37/252

(57) ABSTRACT

A pipe connection assembly includes fixed and removable pipes and an anti-rotation assembly. The fixed pipe extends to a fixed pipe proximate end through a sidewall thickness of a vessel body such that the fixed pipe proximate end is open to a vessel interior and fixed in relation to the vessel body. The removable pipe extends between a removable pipe proximate end and a removable pipe distal end. The fixed and removable pipes include respective first and second pipe connectors at the fixed and removable pipe proximate ends. The first and second pipe connectors collectively define a bayonet connection. The removable pipe detachably connects with the fixed pipe via the bayonet connection. The anti-rotation assembly at least partially limit movement of the removable pipe in relation to the vessel independently of the bayonet connection, based on the removable pipe detachably connecting with the fixed pipe.

### BACKGROUND

### Field

Example embodiments described herein relate in general to connections within vessels, including vessels of industrial process units, such as pressure vessels of nuclear reactors, and in particular to providing vessel internal piping connections, such as within a relatively small space within a pressure vessel.

### Description of Related Art

Industrial process units, including for example nuclear reactors, may transfer a fluid (e.g., a process fluid, working fluid, etc.) into and out of a vessel associated with the process unit via one or more fluid conduits, piping, or the like. For example, in the case of nuclear reactors, a nuclear reactor may include a pressure vessel that encloses a nuclear reactor core, where the nuclear reactor may be configured to circulate a coolant fluid (e.g., water, steam, liquid metal such as sodium, or the like) into and/or out of the pressure vessel.

In some cases, a vessel may include a vessel body (e.g., a hollow cylindrical vessel structure defining a sidewall of the vessel and having an exposed top opening and in some example embodiments further defining a bottom of the vessel) and a vessel head (e.g., a block-like vessel structure configured to be coupled with the top opening of the vessel body to partially or entirely cover the top opening of the vessel body) that collectively define a closed enclosure of the vessel interior. The vessel head may be detachable from the vessel body to enable access to the vessel interior and vessel internals (e.g., process components, fixtures, piping, etc.) located therein. As a result, vessel internals may be accessed, repaired, removed, replaced, or the like based on reversibly detaching the vessel head from the vessel body.

In some cases, one or more conduits (e.g., pipes, piping, or the like) may extend through a thickness of the vessel body and/or the vessel head into the vessel interior to enable fluid transfer between the vessel interior and exterior. However, in the case where the vessel head is detachable from the vessel body to enable vessel interior access, detaching the vessel head from the vessel body may entail disconnecting and/or isolating piping that penetrates through the vessel head, which may entail complex operations including for example hot work (work associated with hot components, piping, or the like), contaminated work (work associated with contaminated components, piping, or the like) and/or various complex operations. In addition, the vessel head may further require the process unit to include additional devices, isolation connections, valves, connections, or the like to enable such operations. Furthermore, vessel internal components and/or internal piping within the vessel interior (collectively referred to herein as vessel internals) may have low clearances with a vessel body sidewall inner surface and define relatively small arcuate spaces (e.g., annular spaces) between the vessel internals and the vessel body sidewall inner surface(s) within the vessel interior. In such cases, pipe connections with side fluid pipe penetrations within the arcuate spaces may be difficult to access (e.g., to perform at-pipe connection work) from an exposed top opening of the vessel body to connect pipes within the vessel interior to the side penetrating piping. Furthermore, in view of the low clearances, removal of some vessel internals (e.g., vessel internal piping) prior to accessing side fluid pipe connections into the vessel interior may be difficult, particularly in cases where the side fluid pipe penetration is relatively distant in a vertical direction from the top opening of the vessel body.

### SUMMARY

According to some example embodiments, a pipe connection assembly may include a fixed pipe, a removable pipe, and an anti-rotation assembly. The fixed pipe may extend to a fixed pipe proximate end through a sidewall thickness of a vessel body of a vessel such that the fixed pipe proximate end is open to a vessel interior and fixed in relation to the vessel body. The vessel interior may be at least partially defined by one or more vessel body sidewall inner surfaces of the vessel body. The fixed pipe may include a first pipe connector at the fixed pipe proximate end. The removable pipe may extend between a removable pipe proximate end and a removable pipe distal end. The removable pipe may include a second pipe connector at the removable pipe proximate end. The first and second pipe connectors may collectively define a bayonet connection. The removable pipe may be configured to detachably connect with the fixed pipe via the bayonet connection. The anti-rotation assembly may be configured to at least partially restrict movement of the removable pipe in relation to the vessel independently of the bayonet connection, based on the removable pipe being detachably connected with the fixed pipe via the bayonet connection.

One pipe connector of the first pipe connector or the second pipe connector may define one of a socket or a plug, and another pipe connector of the second pipe connector or the first pipe connector may define another one of the plug or the socket. The one pipe connector of the first pipe connector or the second pipe connector may further define a lug pipe connector including one or more lugs each extending radially in relation to a central axis of the one pipe connector, and the other pipe connector may further define a notch pipe connector including one or more notches configured to receive the one or more lugs. The removable pipe may be configured to detachably connect with the fixed pipe via the bayonet connection based on moving the removable pipe proximate end towards the fixed pipe proximate end in an axial direction, the axial direction parallel to a central axis of the removable pipe proximate end, to cause the one or more lugs to be inserted into separate, respective notches of the one or more notches via separate, respective axial notch openings in the axial direction and cause the plug to be at least partially inserted into the socket in the axial direction. The removable pipe may be configured to detachably connect with the fixed pipe via the bayonet connection based on rotating at least the removable pipe proximate end around the central axis of the removable pipe proximate end in relation to the fixed pipe proximate end to cause azimuthal engagement between the notch pipe connector and the lug pipe connector concurrently with the plug being at least partially inserted into the socket.

The one or more notches may each have a notch depth extending through at least a portion of a pipe sidewall thickness of the notch pipe connector. The one or more lugs may each be configured to extend through at least a portion of a notch depth of a respective notch of the one or more notches based on being inserted into the respective notch.

The one or more notches may each have a notch depth extending through an entirety of the pipe sidewall thickness of the notch pipe connector.

The one or more lugs may each be configured to each extend into a respective notch of the one or more notches and to further extend through some or all of the pipe sidewall thickness based on being inserted into the respective notch.

The one or more lugs may each extend radially inwards to a radial lug height from an inner surface of the socket. The one or more notches may each extend radially inwards to a notch depth through some or all of a pipe sidewall thickness of the plug from an outer surface of the plug.

The first pipe connector at the fixed pipe proximate end may define both the socket and the lug pipe connector. The second pipe connector at the removable pipe proximate end may define both the plug and the notch pipe connector.

The pipe connection assembly may further include at least one of an outer seal/stop structure on an outer surface of the plug and configured to engage the socket to at least partially seal an interface between opposing surfaces of the plug and the socket, or an inner seal/stop structure on an inner surface of the socket and configured to engage the plug to at least partially seal an interface between opposing surfaces of the plug and the socket.

Each notch of the one or more notches may define an axial notch section and an azimuthal notch section. The axial notch section may extend axially in parallel with a central axis of the notch pipe connector from an axial notch opening at an axial end of the notch pipe connector. The azimuthal notch section may extend at least partially azimuthally around the central axis of the notch pipe connector from the axial notch section.

Each notch of the one or more notches may define a chamfer notch section extending both axially and azimuthally between the axial notch section and the azimuthal notch section.

The bayonet connection may be configured to resist an ejection force exerted on the removable pipe in the axial direction, based on a fluid moving between respective conduits of the fixed pipe and the removable pipe, such that the bayonet connection is configured to transfer a load between a pipe sidewall of the fixed pipe and a pipe sidewall of the removable pipe to counteract the ejection force.

The bayonet connection may define a load path to resist the ejection force, the load path extending at least partially in the axial direction through at least one of the plug or the socket to an axial interface between the lug pipe connector and the notch pipe connector.

The anti-rotation assembly may include a first conduit structure, a second conduit structure, and a retainer pin. The first conduit structure may be connected to the removable pipe. The first conduit structure may include a first conduit extending at least partially through the first conduit structure. The second conduit structure may be connected to the vessel. The second conduit structure may include a second conduit extending at least partially through the second conduit structure. The retainer pin may be configured to extend at least partially through each of the first conduit and the second conduit based on the first and second conduits being at least partially aligned to at least partially define a collective conduit extending through both the first and second conduits.

The pipe connection assembly may further include a retaining element configured to engage the retainer pin to at least partially limit movement of the retainer pin out of at least the first conduit.

The retaining element may be directly connected to a vessel head of the vessel independently of the vessel body.

The second conduit may extend entirely between opposite outer surfaces of the second conduit structure. The first conduit may extend through a limited portion of the first conduit structure to a bottom end defined by a bottom inner surface of the first conduit, such that the first conduit structure is configured to structurally support a distal end of the retainer pin at the inner surface of the first conduit.

According to some example embodiments, a nuclear reactor may include a pressure vessel, the pressure vessel including a vessel body and a vessel head on a top opening of the vessel body, respective inner surfaces of the vessel body and the vessel head at least partially defining a pressure vessel interior of the pressure vessel. The nuclear reactor may further include nuclear reactor core, a steam separator, and a steam dryer that are each within the pressure vessel interior, the steam dryer at least partially defining an arcuate space between an outer surface of the steam dryer and a vessel body sidewall inner surface of the vessel body. The nuclear reactor may further include the pipe connection assembly, the fixed pipe of the pipe connection assembly extending through a sidewall thickness of the vessel body such that the fixed pipe proximate end is open to the arcuate space within the pressure vessel interior, the removable pipe of the pipe connection assembly detachably connected with the fixed pipe within the arcuate space to establish fluid communication between an exterior of the pressure vessel and the pressure vessel interior via a conduit extending through the sidewall thickness of the vessel body, the conduit at least partially defined by respective conduits of the fixed pipe and the removable pipe.

The removable pipe may be coupled to a fluid discharge assembly at the removable pipe distal end of the removable pipe, such that the pipe connection assembly is configured to direct a fluid to the fluid discharge assembly to be discharged into the pressure vessel interior through the sidewall thickness of the vessel body.

According to some example embodiments, a method of operating a vessel including the pipe connection assembly may include circulating a fluid between the vessel interior and an exterior of the vessel via flow of the fluid between the fixed pipe and the removable pipe detachably connected with the fixed pipe via the bayonet connection.

According to some example embodiments, a method of configuring a vessel to include a pipe connection assembly may include providing a vessel body including a fixed pipe. The vessel body may include one or more vessel body sidewall inner surfaces at least partially defining a vessel interior. The fixed pipe may extend through a sidewall thickness of the vessel body to a fixed pipe proximate end. The fixed pipe proximate end may be open to the vessel interior and fixed in relation to the vessel body. The fixed pipe may include a first pipe connector at the fixed pipe proximate end. The method may include detachably connecting a removable pipe within the vessel interior with the fixed pipe via a bayonet connection. The removable pipe may extend between a removable pipe proximate end and a removable pipe distal end. The removable pipe may include a second pipe connector at the removable pipe proximate end. The first and second pipe connectors may collectively define the bayonet connection. The method may include connecting the removable pipe to at least a portion of the vessel body independently of the bayonet connection to at least partially restrict movement of the removable pipe in relation to the vessel body independently of the bayonet connection, based on the removable pipe being detachably connected with the fixed pipe via the bayonet connection.

One pipe connector of the first pipe connector or the second pipe connector may define one of a socket or a plug, and another pipe connector of the second pipe connector or the first pipe connector may define another one of the plug or the socket. The one pipe connector of the first pipe connector or the second pipe connector may further define a lug pipe connector including one or more lugs each extending radially in relation to a central axis of the one pipe connector, and the other pipe connector further defines a notch pipe connector including one or more notches configured to receive the one or more lugs. The detachably connecting the removable pipe with the fixed pipe via the bayonet connection may include moving the removable pipe proximate end towards the fixed pipe proximate end in an axial direction, the axial direction parallel to a central axis of the removable pipe proximate end, to cause the one or more lugs to be inserted into separate, respective notches of the one or more notches via separate, respective axial notch openings in the axial direction, and cause the plug to be at least partially inserted into the socket in the axial direction. The detachably connecting the removable pipe with the fixed pipe via the bayonet connection may include rotating at least the removable pipe proximate end around the central axis of the removable pipe proximate end in relation to the fixed pipe proximate end to cause azimuthal engagement between the notch pipe connector and the lug pipe connector concurrently with the plug being at least partially inserted into the socket.

the one or more notches may each have a notch depth extending through at least a portion of a pipe sidewall thickness of the notch pipe connector. The one or more lugs may each be configured to extend through at least a portion of a notch depth of a respective notch of the one or more notches based on being inserted into the respective notch.

The one or more notches may each have a notch depth extending through an entirety of the pipe sidewall thickness of the notch pipe connector.

The one or more lugs may each be configured to each extend into a respective notch of the one or more notches and to further extend through some or all of the pipe sidewall thickness in the radial direction based on being inserted into the respective notch.

The one or more lugs may each extend radially inwards to a radial lug height from an inner surface of the socket. The one or more notches may each extend radially inwards to a notch depth through some or all of a pipe sidewall thickness of the plug from an outer surface of the plug.

The first pipe connector at the fixed pipe proximate end may define both the socket and the lug pipe connector. The second pipe connector at the removable pipe proximate end may define both the plug and the notch pipe connector.

The detachably connecting the removable pipe with the fixed pipe via the bayonet connection may include at least one of engaging an outer seal/stop structure on an outer surface of the plug with the socket to at least partially seal an interface between opposing surfaces of the plug and the socket, or engaging an inner seal/stop structure on an inner surface of the socket with the plug to at least partially seal an interface between opposing surfaces of the plug and the socket.

Each notch of the one or more notches may define an axial notch section and an azimuthal notch section. The axial notch section may extend axially in parallel with a central axis of the notch pipe connector from an axial notch opening at an axial end of the notch pipe connector. The azimuthal notch section may extend at least partially azimuthally around the central axis of the notch pipe connector from the axial notch section.

Each notch of the one or more notches may define a chamfer notch section extending both axially and azimuthally between the axial notch section and the azimuthal notch section.

The bayonet connection may be configured to resist an ejection force exerted on the removable pipe in the axial direction, based on a fluid moving between respective conduits of the fixed pipe and the removable pipe, such that the bayonet connection is configured to transfer a load between a pipe sidewall of the fixed pipe and a pipe sidewall of the removable pipe to counteract the ejection force.

The bayonet connection may define a load path to resist the ejection force, the load path extending at least partially in the axial direction through at least one of the plug or the socket to an axial interface between the lug pipe connector and the notch pipe connector.

Connecting the removable pipe to at least the portion of the vessel independently of the bayonet connection may include extending a retainer pin at least partially through each of a first conduit and a second conduit. The first conduit may extend at least partially through a first conduit structure. The first conduit structure may be connected to the removable pipe. The second conduit may extend at least partially through a second conduit structure. The second conduit structure may be connected to the vessel. The retainer pin may extend at least partially through both the first conduit and the second conduit based on the first and second conduits being at least partially aligned to at least partially define a collective conduit extending through both the first and second conduits.

The method may further include engaging a retaining element with the retainer pin to at least partially limit movement of the retainer pin out of at least the first conduit.

The retaining element may be directly connected to a vessel head of the vessel independently of the vessel body.

The second conduit may extend entirely between opposite outer surfaces of the second conduit structure. The first conduit may extend through a limited portion of the first conduit structure to a bottom end defined by a bottom inner surface of the first conduit, such that the first conduit structure may be configured to structurally support a distal end of the retainer pin at the inner surface of the first conduit.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is a schematic view of a process unit that includes a vessel with a pipe connection assembly, according to some example embodiments. FIG. 1B is a cross-sectional view along view line IB-IB′ in FIG. 1A, according to some example embodiments. FIG. 1C is an expanded view of region A in FIG. 1A, according to some example embodiments. FIG. 1D is an expanded view of region B in FIG. 1C, according to some example embodiments. FIG. 1E is a cross-sectional view along view line IE-IE′ in FIG. 1C, according to some example embodiments. FIG. 1F is a cross-sectional view along view line IF-IF′ in FIG. 1E, according to some example embodiments.

FIG. 2A is an expanded view of region C of FIG. 1C, according to some example embodiments. FIG. 2B is a cross-sectional view along view line IIB-IIB′ in FIG. 2A, according to some example embodiments. FIG. 2C is a cross-sectional view along view line IIC-IIC′ in FIG. 2A, according to some example embodiments. FIG. 2D is a cross-sectional view along view line IID-IID′ in FIG. 2A, according to some example embodiments.

FIG. 3A is an expanded view of region C of FIG. 1C, according to some example embodiments. FIG. 3B is a cross-sectional view along view line IIIB-IIIB′ in FIG. 3A, according to some example embodiments.

FIG. 4A is an expanded view of region C of FIG. 1C, according to some example embodiments. FIG. 4B is a cross-sectional view along view line IVB-IVB′ in FIG. 4A, according to some example embodiments.

FIG. 5A is an expanded view of region C of FIG. 1C, according to some example embodiments. FIG. 5B is a cross-sectional view along view line VB-VB′ in FIG. 5A, according to some example embodiments.

FIG. 6A is an expanded view of region A in FIG. 1A, according to some example embodiments. FIG. 6B is a cross-sectional view along view line VIB-VIB′ in FIG. 6A, according to some example embodiments. FIG. 6C is an expanded view of region A in FIG. 1A, according to some example embodiments.

FIG. 7A is a flowchart illustrating a method of configuring a process unit that includes a vessel to complete a pipe connection assembly, according to some example embodiments. FIG. 7B is a flowchart illustrating a method of configuring a process unit to disconnect a pipe connection assembly, according to some example embodiments.

FIG. 8 is a cross-sectional view of a vessel including a pipe connection assembly, according to some example embodiments.

FIG. 9 is a schematic view of a nuclear power plant that includes a pressure vessel with a pipe connection assembly, according to some example embodiments.

### DETAILED DESCRIPTION

Hereinafter, some example embodiments will be explained in detail with reference to the accompanying drawings. Like numbers refer to like elements throughout the specification. In flowcharts described with reference to the drawings, the order of operations may be changed, several operations may be merged, certain operations may be divided, and certain operations may not be performed.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a. tolerance of ±10%).

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

It will be understood that elements and/or properties thereof described herein as being “substantially” the same, equal, and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Although described with reference to specific examples and drawings, modifications, additions, and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

It will be understood that a “nuclear reactor” as described herein may include any or all of the well-known components of a nuclear reactor, including a nuclear reactor core with or without nuclear fuel components, control rods, or the like. It will be understood that a nuclear reactor as described herein may include any type of nuclear reactor, including but not limited to a Boiling Water Reactor (BWR), a Pressurized Water Reactor (PWR), a liquid metal cooled reactor, a Molten Salt Reactor (MSR), or the like. As described herein, a nuclear reactor may include an Advanced Boiling Water Reactor (ABWR), an Economic Simplified Boiling Water Reactor (ESBWR), a BWRX-300 reactor, or the like.

It will be understood that a “fluid” or “coolant fluid” as described herein may include any well-known coolant fluid that may be used in cooling any part of a nuclear plant and/or nuclear reactor, including water, a liquid metal (e.g., liquid sodium), a gas (e.g., helium), a molten salt, any combination thereof, or the like. It will be understood that a “fluid” as described herein may include a gas, a liquid, or any combination thereof.

The present inventive concepts relate to pipe connection assemblies which enable a connection between rigid (and therefore high-pressure capable) pipes. Such a connection of the pipe connection assembly may be suitable for a wide range of environment and may be configured to be established quickly (e.g., without using any flange connections with bolts) and at least partially submerged within a fluid (e.g., underwater) using simple, manually operated tooling or via direct manual manipulation of at least one of the pipes forming (e.g., defining) the connection by an operator (e.g., based on a human operator grasping a portion of at least one of the pipes forming the connection).

The pipe connection assembly according to some example embodiments may replace the use of bolted flanges (e.g., bolted flange connections) for connection of vessel internal piping (e.g., fixed and removable pipes) within the interior of a vessel. The pipe connection assembly according to some example embodiments may significantly reduce installation/removal time between the vessel internal piping (e.g., fixed and removable pipes) within the interior of the vessel, risk of foreign material within the vessel interior associated with attempts to connect or disconnect the vessel internal piping (dropped bolts or washers), or need for complicated remote operated tooling to establish the connection of the vessel internal piping.

The pipe connection assembly according to some example embodiments may reduce, minimize, or preclude the need for pipe connections in the vessel head (e.g., top fluid pipe penetrations through the vessel head thickness), which would otherwise have to be disconnected and/or isolated before the vessel head could be removed (e.g., detached from the vessel body) to remove one or more of the vessel internal process components within the vessel interior (e.g., one or more of the vessel internals, vessel internal piping, or the like). Because the pipe connection assembly does not require significant at-pipe connection work to detachably connect the removable and fixed pipes, the pipe connection assembly is suitable for low clearance applications as the insertion depth needed to engage the removable pipe to the fixed pipe can be reduced or minimized by the design of the pipe connectors and pipe thickness/metal strength.

The pipe connection assembly according to some example embodiments of the inventive concepts may be uniquely suited to installations inside a vessel where connected piping must be removed to allow maintenance on and/or removal of vessel internals (e.g., devices, fixtures, and/or components within the vessel interior). The pipe connection assembly is well suited for use where there is limited clearance (low clearance) between an inner surface of the vessel (e.g., the vessel body sidewall inner surface or the fixed pipe proximate end) and vessel internals that may be removed after vessel internal piping (e.g., at least the removable pipe) has been removed from the vessel interior. As a result, the pipe connection assembly may enable the establishment of low-profile permanent vessel internal attachments within relatively small, low-clearance arcuate spaces within the vessel of a process unit (e.g., a pressure vessel).

The pipe connection assembly according to some example embodiments of the inventive concepts may enable easy and potentially beyond arms reach (remote/manual) pipe installation and/or removal from the vessel interior, including pipe installation and/or removal (e.g., detachable connection) to establish a connection of a removable pipe that is at least partially submerged in a fluid (e.g., underwater) within the vessel interior to an end of a fixed pipe that is totally submerged in the fluid within the vessel interior. In some example embodiments, the pipe connection assembly provides a bayonet connection that provides a high integrity connection between a fixed pipe (extending through a sidewall thickness of a vessel body) and a removable pipe within the vessel interior that can be applied where very limited space is available for permanently installed equipment within the vessel interior due to the need to remove equipment below the bayonet connection.

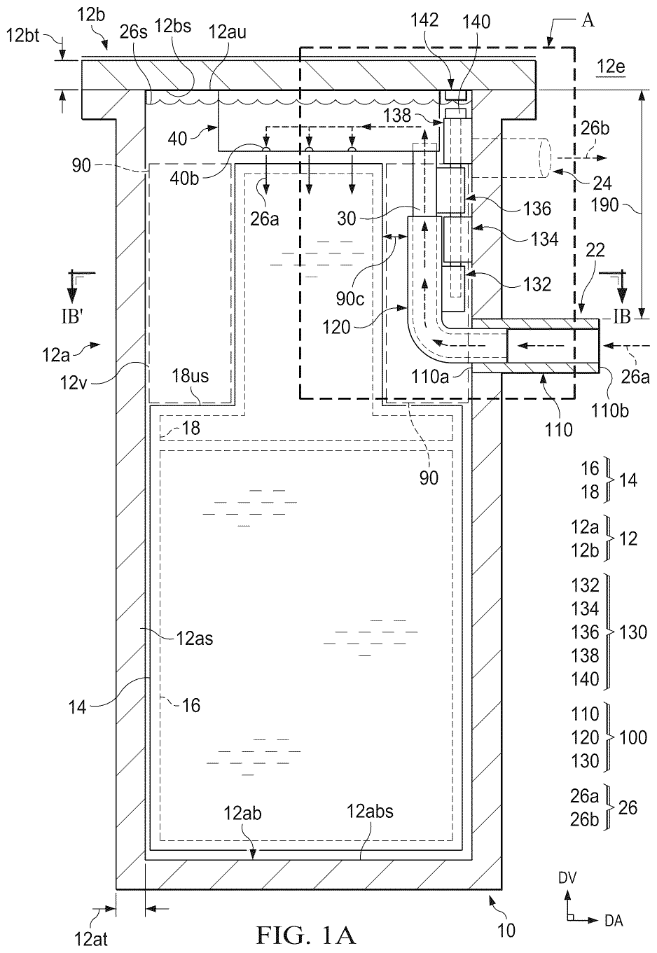

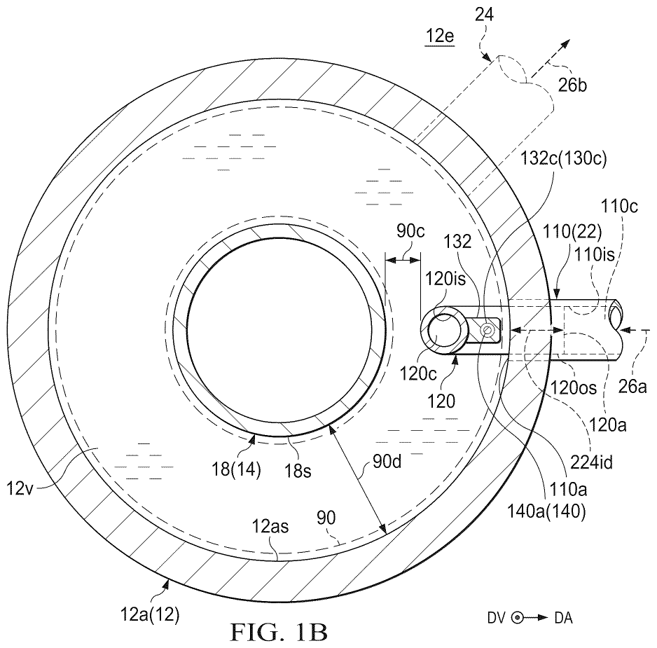

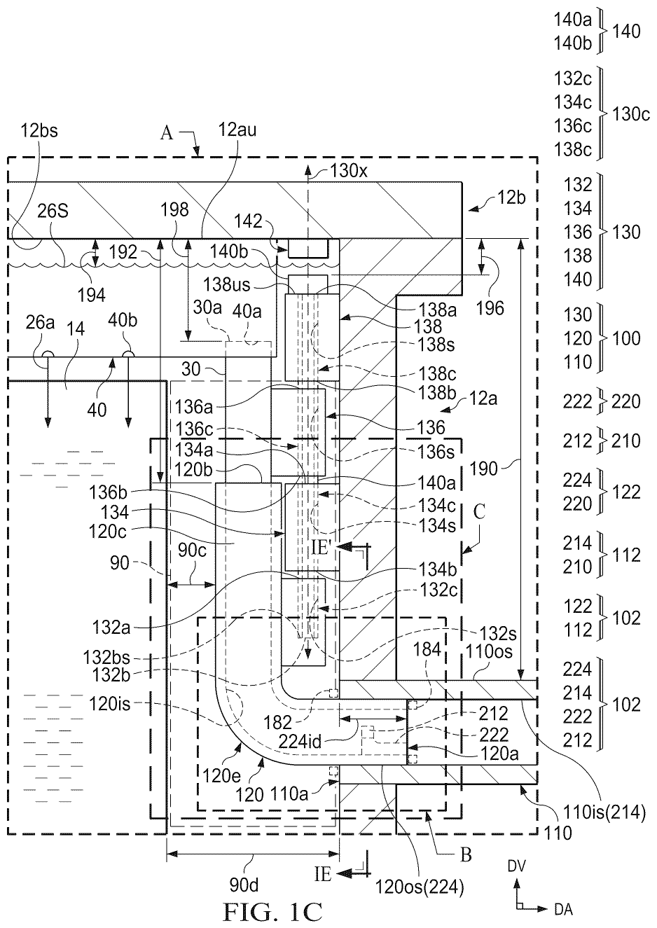

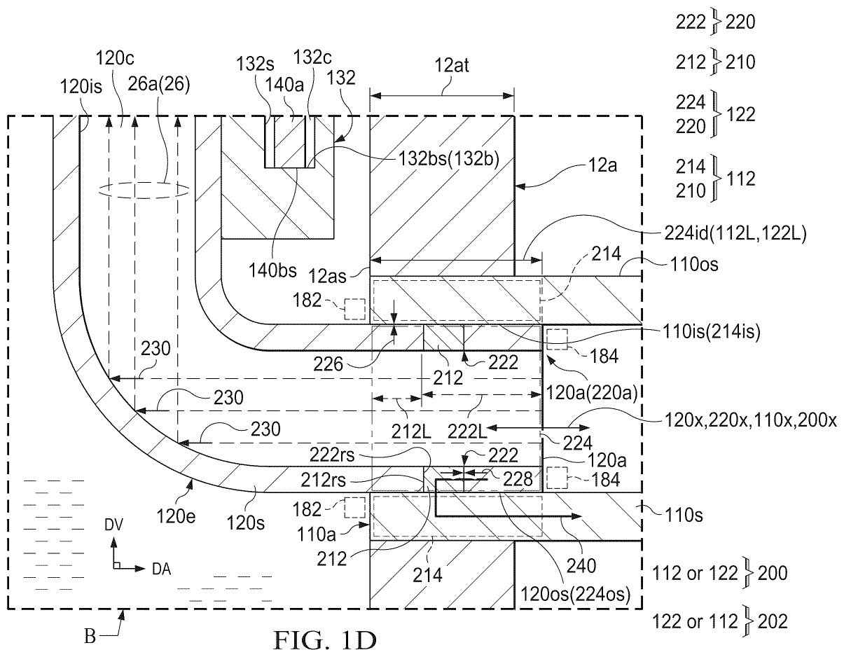

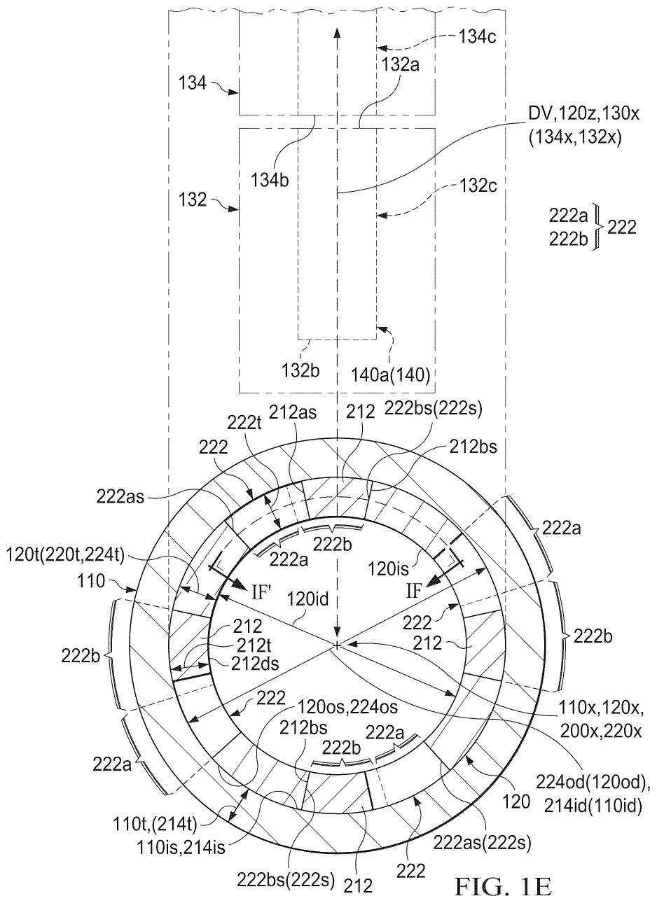

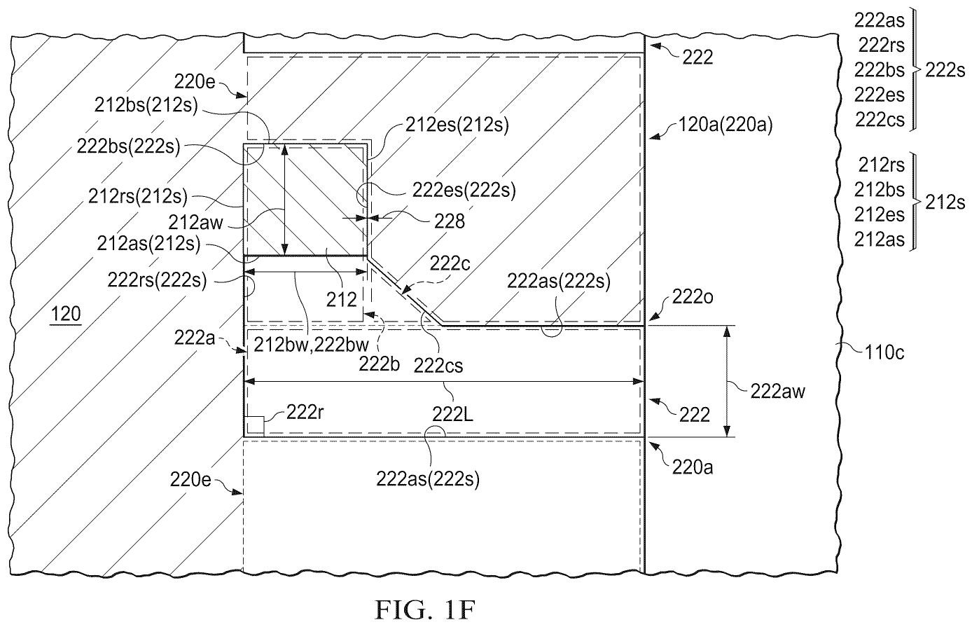

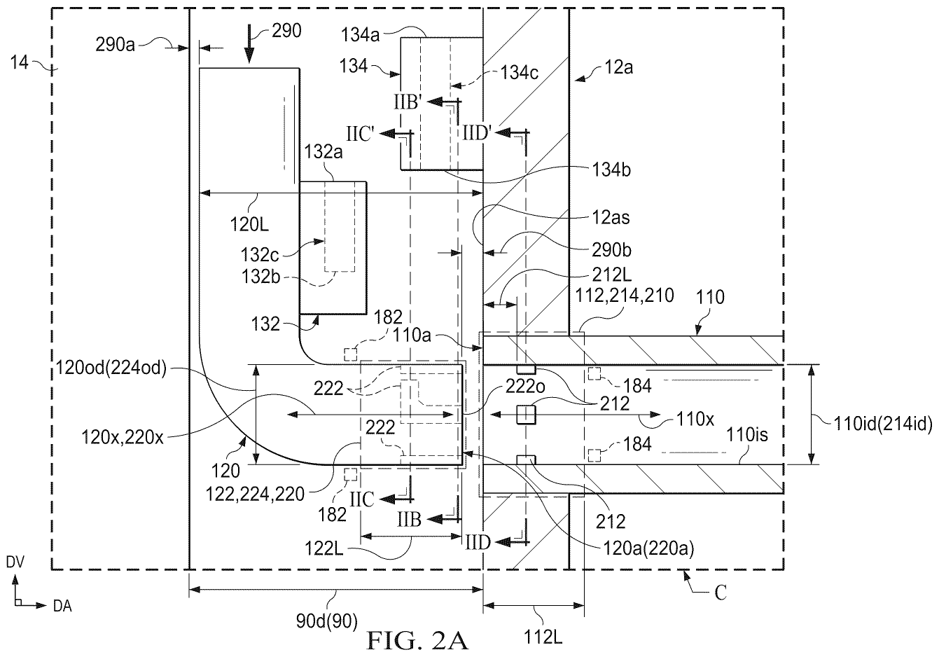

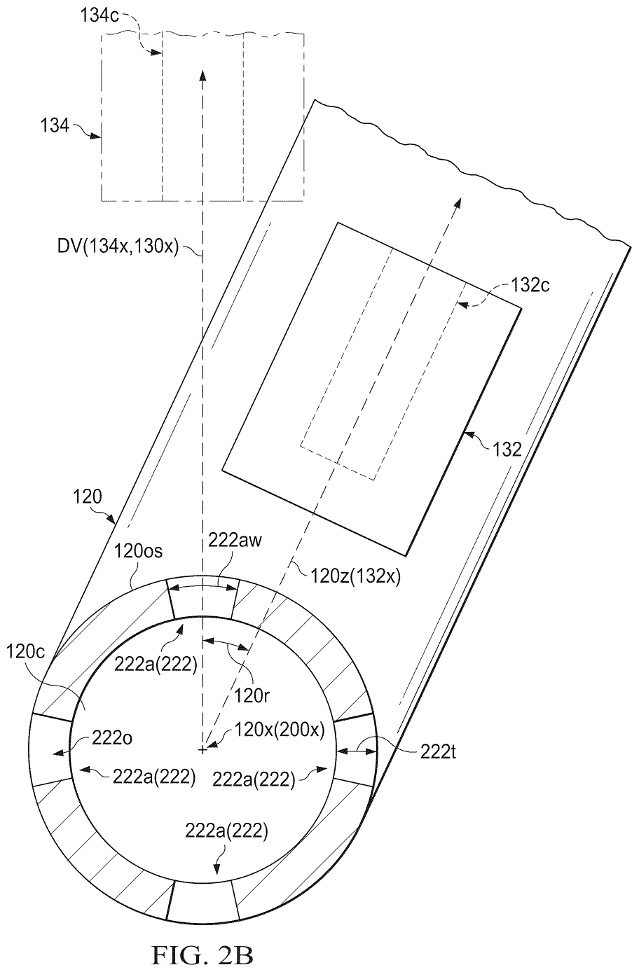

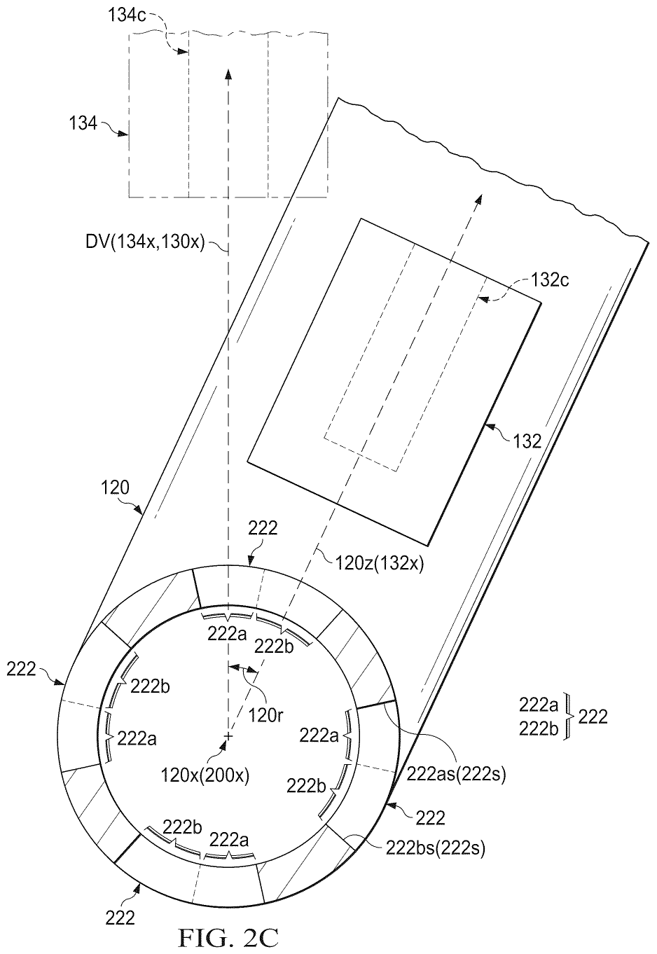

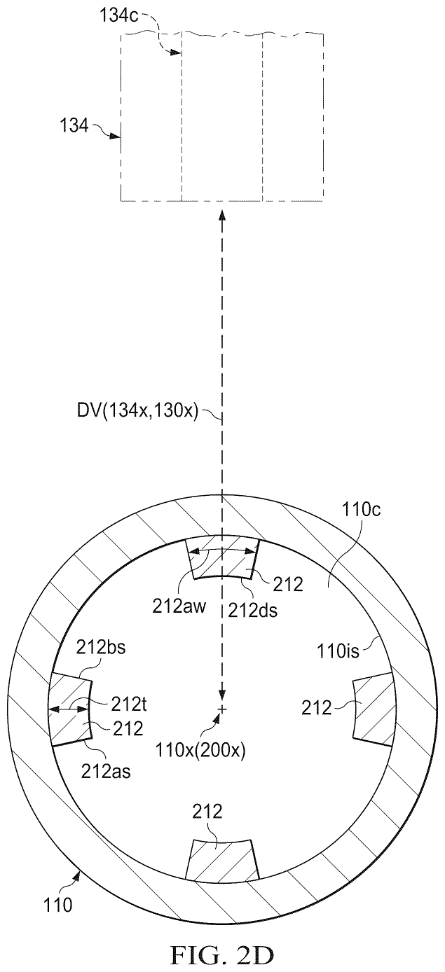

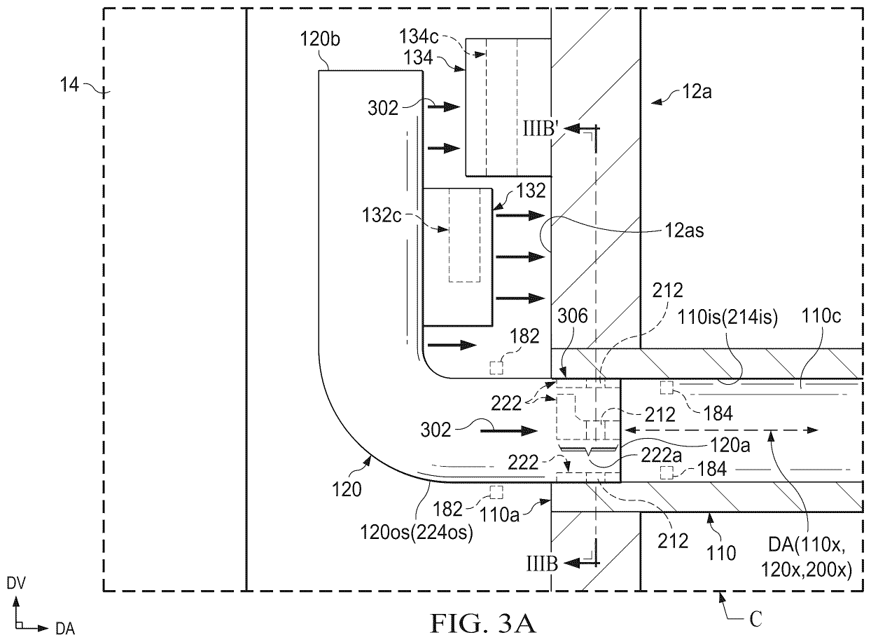

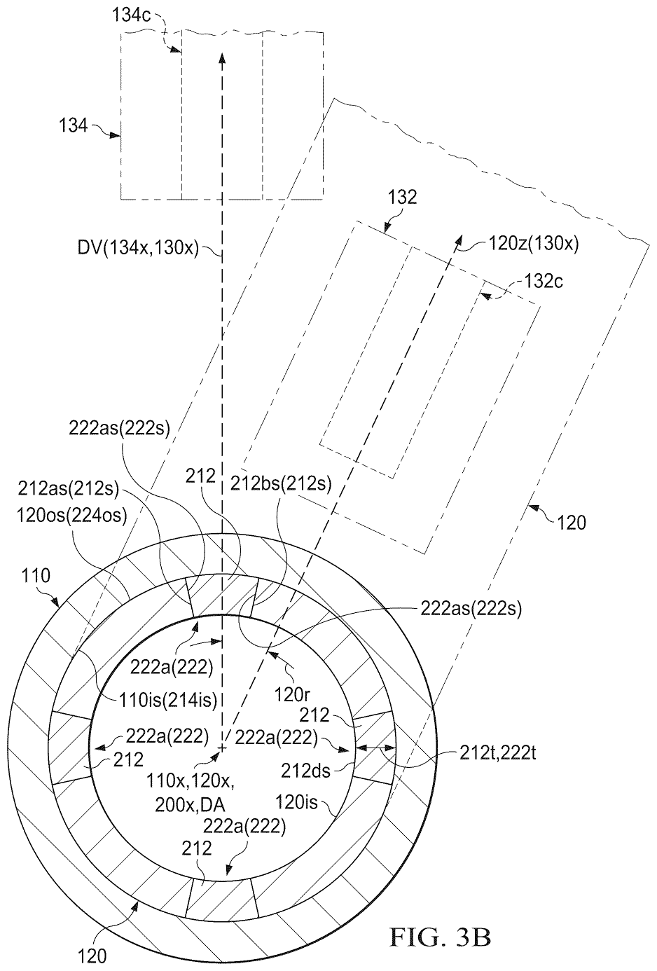

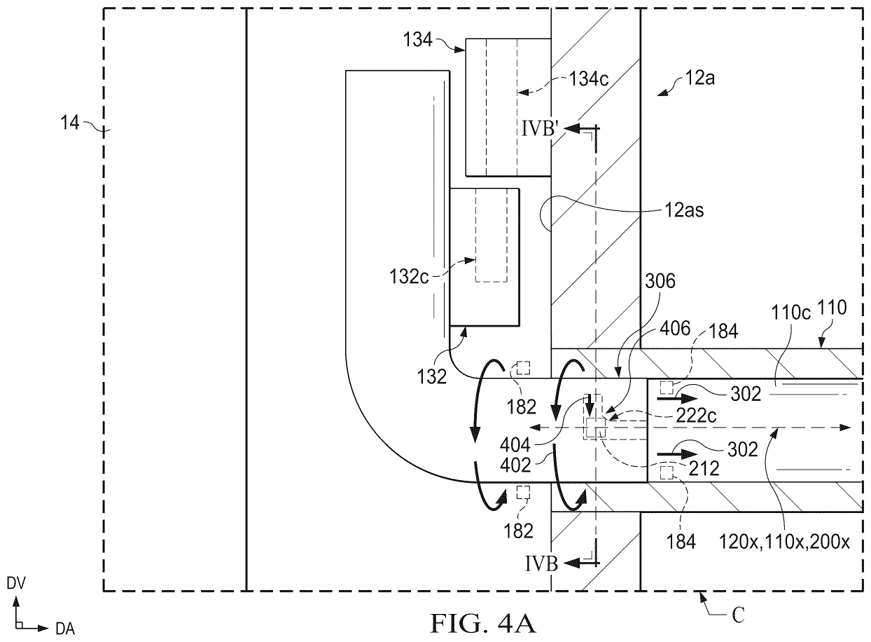

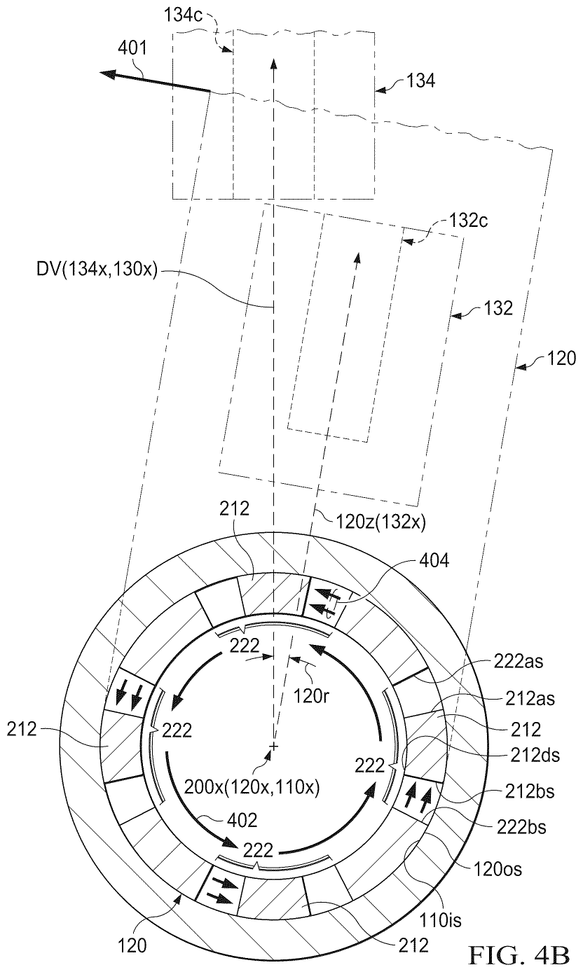

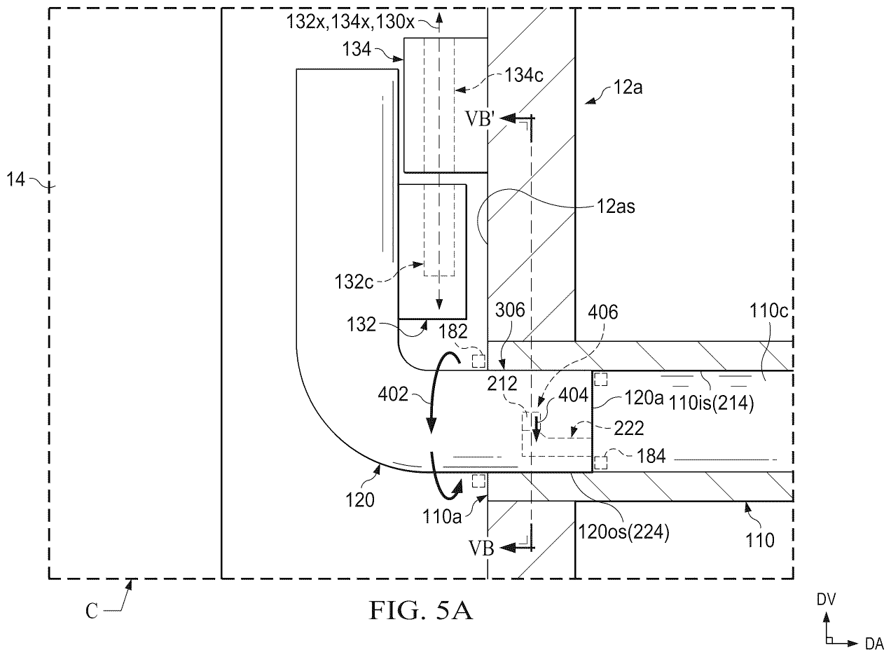

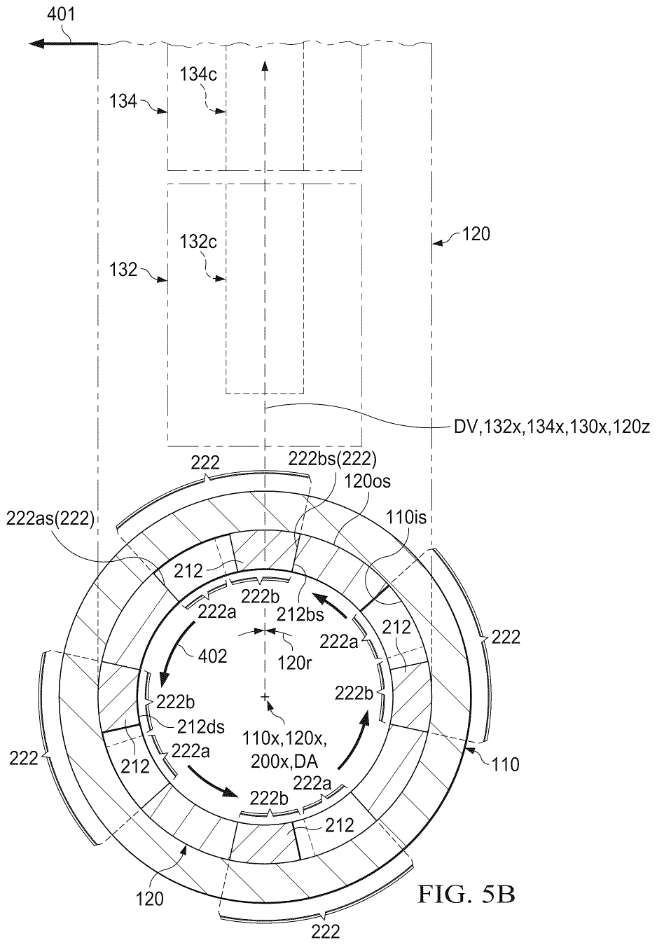

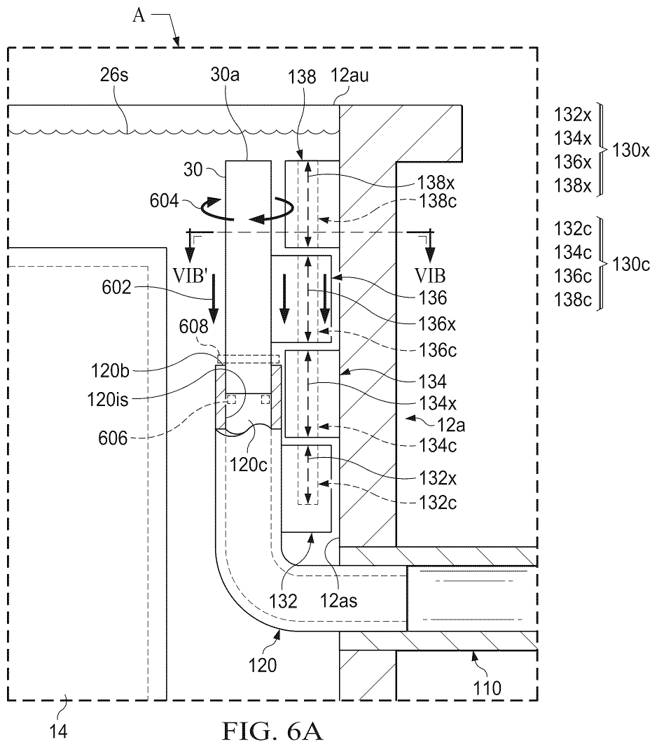

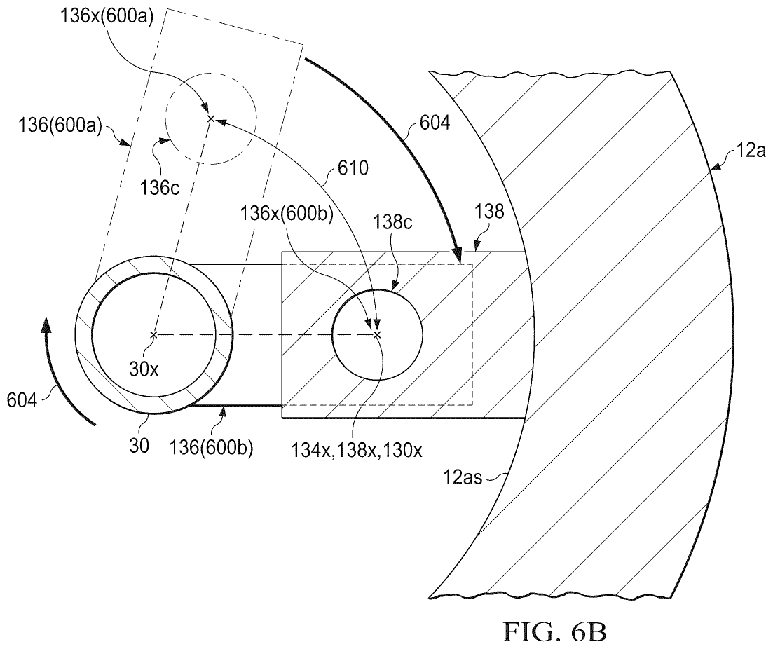

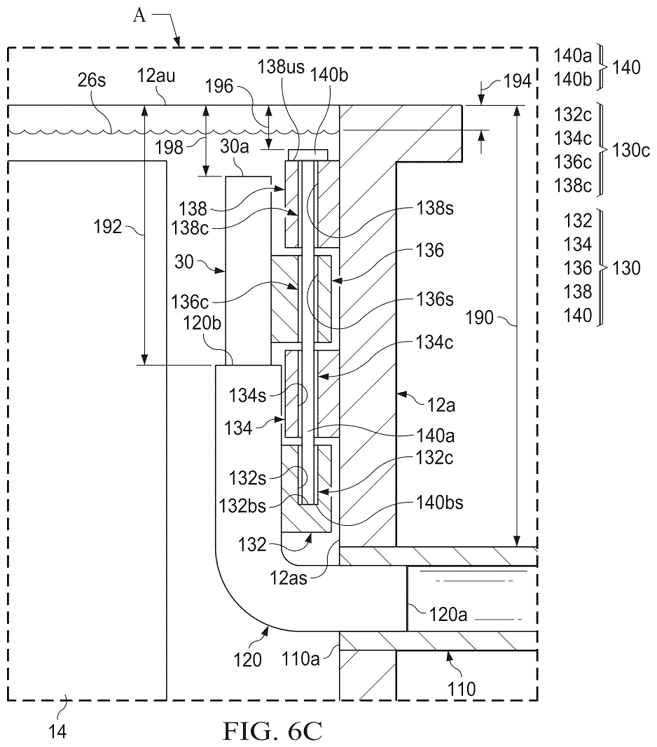

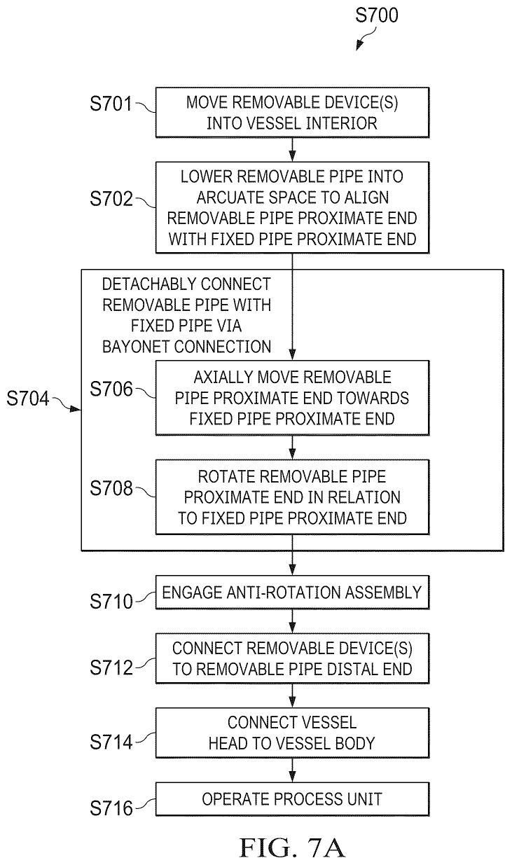

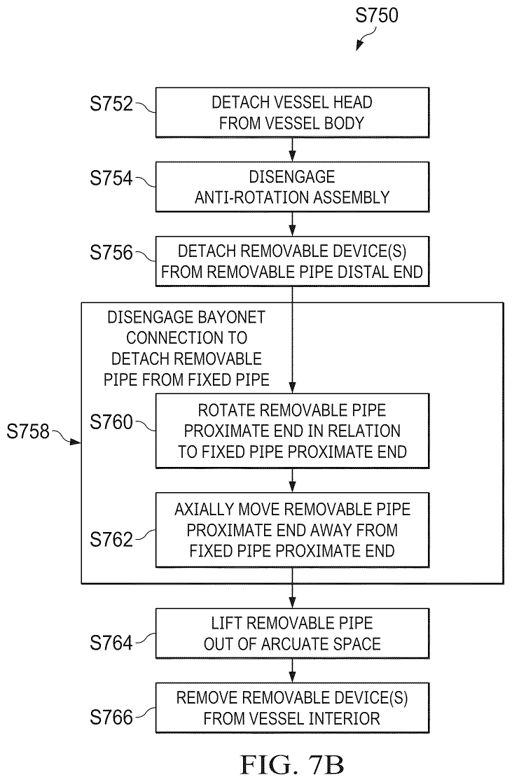

FIG. 1A is a schematic view of a process unit that includes a vessel with a pipe connection assembly, according to some example embodiments. FIG. 1B is a cross-sectional view along view line IB-IB′ in FIG. 1A, according to some example embodiments. FIG. 1C is an expanded view of region A in FIG. 1A, according to some example embodiments. FIG. 1D is an expanded view of region B in FIG. 1C, according to some example embodiments. FIG. 1E is a cross-sectional view along view line IE-IE′ in FIG. 1C, according to some example embodiments. FIG. 1F is a cross-sectional view along view line IF-IF′ in FIG. 1E, according to some example embodiments. FIG. 2A is an expanded view of region C of FIG. 1C, according to some example embodiments. FIG. 2B is a cross-sectional view along view line IIB-IIB′ in FIG. 2A, according to some example embodiments. FIG. 2C is a cross-sectional view along view line IIC-IIC′ in FIG. 2A, according to some example embodiments. FIG. 2D is a cross-sectional view along view line IID-IID′ in FIG. 2A, according to some example embodiments. FIG. 3A is an expanded view of region C of FIG. 1C, according to some example embodiments. FIG. 3B is a cross-sectional view along view line IIIB-IIIB′ in FIG. 3A, according to some example embodiments. FIG. 4A is an expanded view of region C of FIG. 1C, according to some example embodiments. FIG. 4B is a cross-sectional view along view line IVB-IVB′ in FIG. 4A, according to some example embodiments. FIG. 5A is an expanded view of region C of FIG. 1C, according to some example embodiments. FIG. 5B is a cross-sectional view along view line VB-VB′ in FIG. 5A, according to some example embodiments. FIG. 6A is an expanded view of region A in FIG. 1A, according to some example embodiments. FIG. 6B is a cross-sectional view along view line VIB-VIB′ in FIG. 6A, according to some example embodiments. FIG. 6C is an expanded view of region A in FIG. 1A, according to some example embodiments. FIG. 7A is a flowchart illustrating a method of configuring a process unit that includes a vessel to complete a pipe connection assembly, according to some example embodiments. FIG. 7B is a flowchart illustrating a method of configuring a process unit to disconnect a pipe connection assembly, according to some example embodiments.

Referring to FIG. 1A, in some example embodiments, a process unit 10 (also referred to herein as an industrial process unit, a process assembly, or the like) may operate to perform at least a portion of an industrial process and may include a vessel 12 defining a vessel interior 12v. The vessel 12 may be configured to accommodate one or more vessel internal process components 14 within the vessel interior 12v. As shown, the one or more vessel internal process components 14 (also referred to herein as vessel internals, vessel internal components, vessel internal devices, vessel internal members, or the like) may include a stack of one or more lower vessel internal process components 16 and one or more upper vessel internal process components 18, but example embodiments are not limited thereto. The one or more vessel internal process components 14 may be configured to at least partially perform an industrial process, including for example generating heat and transferring (discharging, rejecting, emitting, etc.) the generated heat to a fluid 26 to induce a phase change (e.g., vaporization) of at least a portion of the fluid 26, although example embodiments are not limited thereto.

The vessel 12 may include intake piping 22 and discharge piping 24. The intake piping 22 and the discharge piping 24 may each independently include piping that may extend (“penetrate”) through a thickness of a sidewall or other structure of the vessel 12 (e.g., as a fluid pipe penetration) to establish fluid communication between the vessel interior 12v and an exterior 12e of the vessel 12. The vessel 12 may be configured to circulate a fluid 26 through the vessel interior 12v based on directing an intake fluid 26a into the vessel interior 12v via the intake piping 22 and directing a discharge fluid 26b out of the vessel interior 12v via the discharge piping 24. In some example embodiments, the one or more vessel internal process components 14 may interact with the fluid 26 in the vessel interior 12v, including for example emitting heat into the fluid 26 to induce evaporation of at least a portion of the fluid 26. For example, the intake fluid 26a may be a liquid that is directed into the vessel interior 12v, and the one or more vessel internal process components 14 may include a lower vessel internal process component 16 that includes a heat source that may emit (discharge, reject, etc.) heat into the liquid intake fluid 26a in the vessel interior 12v to vaporize at least a portion of the liquid intake fluid 26a to generate a vapor discharge fluid 26b. The one or more vessel internal process components 14 may include a set of one or more upper vessel internal process components 18 (e.g., a steam separator, a steam dryer, or any combination thereof) that may remove liquid intake fluid 26a droplets from the vapor discharge fluid 26b so that the vapor discharge fluid 26b rises to the top end of the vessel interior 12v as a “dry” or substantially dry vapor. The discharge fluid 26b may be directed out of the vessel interior 12v via the discharge piping 24.

In some example embodiments, the process unit 10 may include a nuclear reactor that generates heat through nuclear reactions within a reactor core within the vessel 12 (which may be a pressure vessel). For example, the lower vessel internal process component 16 may include a nuclear reactor core, although example embodiments are not limited thereto. In some example embodiments, the fluid 26 may include water, such that the intake fluid 26a may be liquid water (also referred to herein as feedwater) and the discharge fluid 26b may be steam, but example embodiments are not limited thereto. For example, the fluid 26 may be any working fluid, coolant fluid, or the like, and the intake fluid 26a and the discharge fluid 26b may have a same phase (e.g., may both be liquid or may both be gas/vapor) or may have different phases, but example embodiments are not limited thereto. For example, the upper vessel internal process component 18 may include at least one of a steam separator or a steam dryer, but example embodiments are not limited thereto. It will be understood that example embodiments of the process unit 10 are not limited to a nuclear reactor.

As shown in at least FIGS. 1A to 1C, in some example embodiments, the vessel 12 may include a vessel body 12a and a vessel head 12b that collectively define and enclose the vessel interior 12v. As shown, the vessel body 12a may be a generally cylindrical structure having cylindrical sidewalls with one or more vessel body sidewall inner surfaces 12as at least partially defining a cylindrical portion of the vessel interior 12v. As further shown, the vessel body 12a may include a cylindrical structure that defines at least an open-topped cylindrical enclosure, such that the vessel body 12 has (e.g., defines) an open top end, also referred to herein interchangeably as a vessel body top opening 12au defining an opening into the vessel interior 12v from a top end of the vessel body 12a. Based on the vessel body 12a having (e.g., defining) a top opening 12au, the vessel body 12a may at least partially define the vessel interior 12v as an open-topped cylindrical enclosure (e.g., an open-ended cylindrical enclosure, an open enclosure, or the like). The vessel body 12a may have or define a closed vessel body bottom end 12ab as shown in FIG. 1A. For example, as shown, the vessel body 12a may have a vessel body bottom surface 12abs defining a closed vessel body bottom end 12ab of the vessel body 12a. However, example embodiments are not limited thereto, and in some example embodiments, the vessel body 12a may at least partially define an open vessel body bottom end 12ab that may be connected to a separate structure to cover the vessel body bottom end 12ab and to define a bottom end of the vessel interior 12v.

In some example embodiments, the vessel 12 may be a thick-walled vessel configured to support a high internal pressure within the vessel interior 12v. For example, the vessel body sidewall thickness 12at may be relatively great in magnitude, for example such that the minimum vessel body sidewall thickness 12at may be about 4.5 inches to about 7.1 inches, although example embodiments are not limited thereto. In some example embodiments the minimum vessel body sidewall thickness 12at in the vessel body 12a may be about 136 mm, although example embodiments are not limited thereto. For example, the vessel head thickness 12bt may be relatively great in magnitude, for example such that the minimum vessel head thickness 12bt may be about 2.7 inches to about 6.8 inches, although example embodiments are not limited thereto. In some example embodiments the minimum vessel head thickness 12bt in the vessel head 12b may be about 136 mm, although example embodiments are not limited thereto.

In some example embodiments, the vessel head 12b may be detachably coupled to the vessel body 12a at the vessel body top opening 12au to close (e.g., cover) the top opening 12au to thereby enclose, or seal, the vessel interior 12v such that at least the vessel body sidewall inner surfaces 12as and the underside 12bs of the vessel head 12b collectively at least partially define the vessel interior 12v as a closed or substantially closed enclosure. The vessel body 12a and the vessel head 12b may be configured to be coupled together via a flanged connection. However, example embodiments are not limited thereto, and the vessel body 12a and the vessel head 12b may be connected together via various types of connections. In some example embodiments, the vessel head 12b may be detachable from the vessel body 12a to “open” the vessel interior 12v through the exposed vessel body top opening 12au, to enable maintenance, inspection, and/or replacement of at least some of the vessel internals within the vessel interior 12v, including at least some of the one or more vessel internal process components 14 that may be within the vessel interior 12v (e.g., at least an upper vessel internal process component 18) to at least partially configure the process unit 10 to perform an industrial process.

In some example embodiments, the vessel head 12b may not include any fluid pipe penetrations through the vessel head thickness 12bt (referred to herein as top fluid pipe penetrations). In example embodiments where one or more top fluid pipe penetrations extend through in the vessel head 12b, detachment of the vessel head 12b from the vessel body 12a may entail complex operations to disconnect and/or isolate vessel piping, connections, and/or devices included in such top fluid pipe penetrations in order to enable movement of the vessel head 12b in relation to the vessel body 12a. Such complex operations may include hot work due to operations to disconnect and/or isolate hot piping that may be configured to direct heated fluids therethrough, contaminated work due to operations to disconnect and/or isolate piping that is contaminated by fluid 26, etc. For example, in example embodiments where the discharge piping 24 extends through the vessel head thickness 12bt to the vessel interior 12v in a top fluid pipe penetration, and where the discharge piping 24 is configured to direct a hot discharge fluid 26b (e.g., high pressure steam) therethrough, removal of the vessel head 12b from the vessel body 12a may entail complex operations to disconnect and/or isolate discharge piping 24 which may include hot work, contaminated work, work to manipulate and/or interact with cladding around the discharge piping 24, or the like. In example embodiments where top fluid pipe penetrations through the vessel head 12b are absent (e.g., discharge piping 24 extends through the vessel body sidewall thickness 12at in a side fluid pipe penetration), the vessel head 12b may be detached from the vessel body 12a without performing such complex operations to disconnect and/or isolate fluid pipe connections through the fluid top penetrations in the vessel head 12b. As a result, omission of any top fluid pipe penetrations through the vessel head 12b may simplify operations to expose or cover the vessel body top opening 12au via detachment or replacement of the vessel head 12b on the vessel body top opening 12au (e.g., as part of a maintenance cycle, turnaround operation, outage, or the like). Accordingly, based on the vessel head 12b not including any top fluid pipe penetrations, process unit 10 operations may be simplified, and operating costs and time associated with operation and/or maintenance of the process unit 10 (e.g., outage time associated with removal and/or replacement of the vessel head 12b) may be reduced or minimized.

In example embodiments where the vessel head 12b does not include any top fluid pipe penetrations, the vessel body 12a may include fluid pipe penetrations through the vessel body sidewall thickness 12at to circulate intake fluid 26a (e.g., liquid fluid, including for example liquid water) into the vessel interior 12v, for example via intake piping 22, and to further circulate discharge fluid 26b (e.g., vapor fluid, including for example steam) out of the vessel interior 12v, for example via discharge piping 24. Such intake piping 22 and discharge piping 24 may each include a side fluid pipe penetration through the vessel body sidewall thickness 12at. Each side fluid pipe penetration may include one or more conduits (pipes) extending through the vessel body sidewall thickness 12at to establish fluid communication between the vessel interior 12v and an exterior 12e of the vessel 12.

Still referring to FIGS. 1A to 1C, one or more vessel internal process components 14, for example an upper vessel internal process component 18, may occupy a substantial portion of the plan cross-section (shown in FIG. 1B) of an upper portion of the vessel interior 12v. As a result, one or more outer surfaces of the one or more vessel internal process components 14, for example one or more outer surfaces 18s of the upper vessel internal process component 18, may cooperate with one or more vessel body sidewall inner surfaces 12as to collectively define an arcuate space 90 within the vessel interior 12v that is defined between the one or more vessel internal process components 14 (e.g., the upper vessel internal process component 18) and the vessel body 12a. As shown in FIG. 1A, the one or more vessel internal process components 14 (e.g., the upper vessel internal process component 18) may include one or more upper surfaces 18us that at least partially define a lower end of the arcuate space 90 in a vertical direction DV. As described herein, the vertical direction DV may extend in parallel with a longitudinal axis of the vessel body 12a. As shown in FIG. 1B, the arcuate space 90 may be an annular space that may extend around an entirety of the one or more vessel internal process components 14 (e.g., upper vessel internal process component 18) in a plan view that is perpendicular to the vertical direction DV. But example embodiments are not limited thereto, and in some example embodiments the arcuate space 90 may extend around a limited portion of the circumference of the one or more vessel internal process components 14 (e.g., upper vessel internal process component 18) in a plan view such as shown in FIG. 1B.

Still referring to at least FIGS. 1B and 1C, in some example embodiments the one or more vessel internal process components 14 (e.g., upper vessel internal process component 18) and the vessel body 12a may collectively define an arcuate space 90 within the vessel interior 12v that has a relatively small radial clearance 90d (e.g., a low clearance, a small clearance, etc.), for example 6 inches to 8 inches, in a radial direction extending radially (e.g., perpendicular to the vertical direction DV) from the longitudinal axis of the vessel interior 12v, although example embodiments are not limited thereto. The radial clearance 90d may be a smallest distance between an outer surface 18s of the upper vessel internal process component 18 and a vessel body sidewall inner surface 12as of the vessel body 12a.

In some example embodiments, including example embodiments where the vessel head 12b does not include any top fluid pipe penetrations and thus the intake piping 22 and the discharge piping 24 are provided via side fluid pipe penetrations, such side fluid pipe penetrations may extend to one or more low-clearance arcuate spaces 90 within the vessel interior 12v. As a result, any vessel internal piping (e.g., pipe connections or fittings) connected to any such side fluid pipe penetrations into the arcuate space(s) 90 may have relatively small minimum clearance 90c with the one or more vessel internal process components 14 (e.g., a relatively small minimum clearance 90c with an outer surface 18s of the upper vessel internal process component 18).

Accordingly, connections between vessel internals/piping within the arcuate space(s) 90, and side fluid pipe penetrations extending to the arcuate space(s) 90 through the vessel body sidewall thickness 12at, may be configured to be installed and removed from a relatively low clearance (e.g., low radial clearance, low horizontal clearance, etc.) environment at least partially defined by the arcuate space(s) 90. Such connections may be configured to be engaged and disengaged without performing complex pipe work operations, and/or at-pipe connection work. Such connections may omit separate fasteners at the connection which may post a foreign material risk in the vessel interior 12v. As shown in at least FIGS. 1A and 1C, such connections may be engaged and disengaged at a location that is submerged beneath a fluid surface 26s of fluid 26 within the vessel interior 12v.

In some example embodiments, vessel internal piping (e.g., pipes) may be removed from the arcuate space(s) 90 via the vessel body top opening 12au based on the vessel head 12b being detached from the vessel body 12a, prior one or more vessel internal process components 14 (e.g., upper vessel internal process component 18, for example a steam dryer) being removed from the vessel interior 12v via the vessel body top opening 12au). For example, vessel internal piping may be removed from the arcuate space(s) 90 to provide additional clearance for subsequent removal of one or more vessel internal process components 14 (e.g., upper vessel internal process component 18) through the top opening 12au. In some example embodiments, vessel internal piping 30 may be installed into the arcuate space(s) 90 after the one or more vessel internal process components 14 (e.g., upper vessel internal process component 18) are installed in the vessel interior 12v, to provide additional clearance for installation of one or more vessel internal process components 14 in the vessel interior 12v prior to installation of the vessel internal piping 30 in the arcuate space(s) 90. In some example embodiments, the vessel internal piping 30 in the arcuate space(s) 90 may be connected to one or more vessel internal fixtures 40 which may be positioned proximate to and/or at least partially above the one or more vessel internal process components 14.

In some example embodiments, a side fluid pipe penetration into the vessel interior 12v through the vessel body sidewall inner surface 12as may be located at a first vertical distance 190 below the vessel body top opening 12au. In some example embodiments, the first vertical distance 190 may be greater than a reach of an average human arm, such that a human operator at the vessel body top opening 12au may be precluded from implementing direct at-pipe connection work at a connection between a pipe in the arcuate space 90 and a fixed pipe of the side fluid pipe penetration at the first vertical distance 190 below the vessel body top opening 12au. For example, the first vertical distance 190 may be between about 3 feet and about 5 feet, between about 3 feet and about 6 feet, between about 3 feet and about 8 feet, between about 3 feet and about 10 feet, or greater than about 10 feet, but example embodiments are not limited thereto.

In some example embodiments, a highest-elevation end of a removable pipe when connected to a fixed pipe of a side fluid pipe penetration in the vessel interior 12v may be located at a second vertical distance 192 below the top opening 12au. In some example embodiments, the second vertical distance 192 may be greater than a reach of an average human arm, such that a human operator at the vessel body top opening 12au may be precluded from manually (e.g., directly, via grasping with a hand) manipulating a removable pipe within in the arcuate space 90 to connected with a fixed pipe of the side fluid pipe penetration. As a result, a human operator may manipulate the removable pipe remotely, for example via manual manipulation of a tool that is connected to the removable pipe. For example, the second vertical distance 192 may be between about 3 feet and about 5 feet, between about 3 feet and about 6 feet, between about 3 feet and about 8 feet, between about 3 feet and about 10 feet, or greater than about 10 feet, but example embodiments are not limited thereto.

In some example embodiments, the level of the fluid surface 26s of fluid 26 in the vessel interior 12v may be above the uppermost level of the removable pipe in the vessel interior 12v when connected with a fixed pipe therein, such that a third vertical distance 194 of the fluid surface 26s from the vessel body top opening 12au may be smaller than the second vertical distance 192, such that the removable pipe may be completely submerged within the fluid 26 in the vessel interior 12v to be connected with a fixed pipe of a side fluid pipe penetration. In such example embodiments, an operator may manipulate the removable pipe remotely via operation of a tool that is connected to the removable pipe in order to reduce or minimize interaction between the operator and the fluid 26, to thereby reduce or minimize operator exposure to fluid 26 that may be hot, contaminated, etc.

Referring now to FIGS. 1A to 6C, in some example embodiments a pipe connection assembly 100 may include a fixed pipe 110 and a removable pipe 120, where the removable pipe 120 may be configured to detachably connect with the fixed pipe 110 at least partially within the vessel interior 12v via a bayonet connection 102. The bayonet connection 102 may be referred to interchangeably herein as a bayonet socket connection, a bayonet sleeve connection, a turn and latch socket connection, a turn and latch sleeve connection, a turn to latch socket connection, a turn to latch sleeve connection, a turn and lock socket connection, a turn and lock sleeve connection, a socket locking mechanism, a sleeve locking mechanism, or the like.

The fixed pipe 110 may have a fixed pipe proximate end 110a (also referred to interchangeably herein as a proximate end opening of the fixed pipe 110 or a proximate end face of the fixed pipe 110) and a fixed pipe distal end 110b. The fixed pipe 110 may have one or more inner surfaces 110is that define a fixed pipe conduit 110c extending through the fixed pipe 110 between the fixed pipe proximate end 110a and the fixed pipe distal end 110b. As shown, the fixed pipe 110 may extend to the fixed pipe proximate end 110a through a vessel body sidewall thickness 12at of a sidewall of the vessel body 12a such that the fixed pipe proximate end 110a is open (e.g., exposed) to the vessel interior 12v and fixed in relation to the vessel body 12a. The fixed pipe 110 may be understood to be a pipe at least partially defining a side fluid pipe penetration through the vessel body sidewall thickness 12at into the vessel interior 12v.

As shown, the first vertical distance 190 may be a distance in the vertical direction DV from the vessel body top opening 12au to an uppermost outer surface 110os of the fixed pipe 110 at the fixed pipe proximate end 110a. The first vertical distance 190 may also be understood to be a vertical distance of the bayonet connection 102 between the fixed pipe 110 and the removable pipe 120 from the vessel body top opening 12au in the vertical direction DV. As further shown, the second vertical distance 192 may be a distance in the vertical direction DV from the vessel body top opening 12au to an uppermost portion of the removable pipe 120 (e.g., the removable pipe distal end 120b as shown) when the removable pipe 120 is detachably connected to the fixed pipe 110 via the bayonet connection 102 as shown at least in FIG. 1C. As shown, the fixed pipe 110 may include a first pipe connector 112 at the fixed pipe proximate end 110a of the fixed pipe 110. As described herein, the first pipe connector 112 may define one of a socket structure (“socket”) or a plug structure (“plug”) and may further define at least one of a lug pipe connector or a notch pipe connector. The fixed pipe 110 may comprise any material, including for example any metal material. For example, the fixed pipe 110 may be a stainless-steel pipe.

As shown, the first pipe connector 112 may include a portion of the fixed pipe 110 extending in an axial length 112L (e.g., axial distance) from the fixed pipe proximate end 110a to a furthest point along the central axis 110x of the fixed pipe proximate end 110a at which the fixed pipe 110 may engage with the removable pipe 120 in a sleeved or socket engagement to result in overlap between the fixed pipe 110 and the removable pipe 120 in a direction perpendicular to the central axis 110x (e.g., overlap in the vertical direction DV). Such axial length 112L may be defined as a distance between the fixed pipe proximate end 110a and a point, e.g., defined by an inner seal/stop structure 184 (also referred to herein interchangeably as a seal, a stop, or any combination thereof), that is the furthest axial extent that the first pipe connector 112 is configured to engage (e.g., in a sleeved or socket engagement) with a separate, second connector of the removable pipe 120. In some example embodiments, the first pipe connector 112 may be defined by a portion of the fixed pipe 110 extending along axial length 112L from the fixed pipe proximate end 110a, where axial length 112L corresponds to an insertion depth 224id that is a maximum extent that a plug 224 as described herein is configured to be inserted into a complementary socket 214 of the pipe connection assembly 100 to at least partially define the sleeved or socket engagement between the removable pipe 120 and the fixed pipe 110.

The removable pipe 120 may have a removable pipe proximate end 120a (also referred to interchangeably herein as a proximate end opening of the removable pipe 120 or a proximate end face of the removable pipe 120) and a removable pipe distal end 120b. The removable pipe 120 may have one or more inner surfaces 120is that define a conduit 120c extending through the removable pipe 120 between the removable pipe proximate end 120a and the removable pipe distal end 120b. As shown, the removable pipe 120 may include a bend 120e (also referred to herein interchangeably as an elbow, a curvature, or the like) along its length between the removable pipe proximate end 120a and the removable pipe distal end 120b such that the central axis 120x of the removable pipe 120 at the removable pipe proximate end 120a extends in a different direction than a central axis of the removable pipe 120 at the removable pipe distal end 120b and furthermore such that the conduit 120c extending through the removable pipe 120 has a corresponding bend. However, example embodiments are not limited thereto, and in some example embodiments the removable pipe 120 may not include any bends or curvatures and may extend axially along a single central axis (e.g., central axis 120x). As shown, the removable pipe 120 may include a second pipe connector 122 at the removable pipe proximate end 120a. As described herein, the second pipe connector 122 may include one of a socket structure (“socket”) or a plug structure (“plug”) and may further include one of a lug pipe connector or a notch pipe connector. The removable pipe 120 may comprise any material, including for example any metal material. For example, the removable pipe 120 may be a stainless-steel pipe.

As shown, the second pipe connector 122 may include a portion of the removable pipe 120 extending in an axial length 122L from the removable pipe proximate end 120a to a furthest point along the central axis 120x of the removable pipe proximate end 120a at which the removable pipe 120 may engage with the fixed pipe 110 to result in overlap between the fixed pipe 110 and the removable pipe 120 in a direction perpendicular to the central axis 120x (e.g., sleeved or socket engagement therebetween). The axial length 122L may be defined as a distance between the removable pipe proximate end 120a and a point, e.g., defined by an outer seal/stop structure 182, that is the furthest axial extent that the second pipe connector 122 is configured to engage with a separate, first pipe connector of the fixed pipe 110 in a sleeved or socket connection. In some example embodiments, the second pipe connector 122 may be defined by a portion of the removable pipe 120 extending along axial length 122L from the removable pipe proximate end 120a where axial length 122L corresponds to an insertion depth 224id that is a maximum extent that a plug 224 as described herein is configured to be inserted into a complementary socket 214 of the pipe connection assembly 100 to establish the sleeved or socket connection between the removable pipe 120 and the fixed pipe 110. As shown, axial lengths 112L and 122L may be the same length, and accordingly the first and second pipe connectors 112 and 122 may have a same length along respective central axes 110x and 120x from respective proximate ends 110a and 120a.

In some example embodiments, the first and second pipe connectors 112 and 122 may collectively define a bayonet connection 102. The removable pipe 120 may be configured to detachably connect (e.g., detachably engage) with the fixed pipe 110 within the vessel interior 12v (e.g., within an arcuate space 90 defined between one or more vessel internal process components 14 (e.g., an upper vessel internal process component 18) in the vessel interior 12v and the one or more vessel body sidewall inner surfaces 12as via the bayonet connection 102. The bayonet connection 102 may enable the removable pipe 120 to be detachably connected to the fixed pipe 110 such that that the connection therebetween is load bearing and may be engaged or disengaged (e.g., installed or removed) without direct manual manipulation of the removable pipe 120, for example based on an operator at the top opening 12au remotely manipulating the removable pipe 120 based on operating a tool that is connected to the removable pipe 120 to remotely manipulate at least the removable pipe proximate end 120a (e.g., in example embodiments where the second vertical distance 192 is greater than about 3 feet and/or the removable pipe 120 is completely submerged beneath the fluid surface 26s when connected with the fixed pipe 110 via the bayonet connection 102).

In example embodiments where the side fluid pipe penetration at least partially defined by the fixed pipe 110 is located at the first vertical distance 190 below the top opening 12au and where the arcuate space 90 has a relatively small radial clearance 90d (e.g., less than 1 foot), an operator (e.g., a human operator) may not be able to fit within the arcuate space 90 from the top opening 12au to directly interact with the removable pipe 120 and/or the fixed pipe 110 at the location of the connection therebetween (e.g., bayonet connection 102) in the vessel interior 12v. Such an operator may therefore remain outside the vessel interior 12v (e.g., at the vessel body top opening 12au), while manipulating (remotely or directly) the removable pipe 120 in the arcuate space 90 to manipulate engagement of a connection between an opposite, proximate end of the removable pipe 120 and the fixed pipe 110 at the first vertical distance 190 below the vessel body top opening 12au. As a result, particularly in example embodiments where at least the connection between the removable pipe 120 and the fixed pipe 110 (and/or the entire removable pipe 120) is submerged below the fluid surface 26s within the vessel interior 12v, the operator may be limited in ability to directly observe the connection point (e.g., the bayonet connection 102) and to directly handle and manipulate the removable pipe 120 that includes the second pipe connector 122 to engage or disengage the bayonet connection 102 with the fixed pipe 110. Furthermore, the operator, even when manipulating the removable pipe 120 remotely via operation of a tool that is connected to the removable pipe 120, may be limited in ability to apply an axial force along a central axis of the removable pipe proximate end 120a and/or the fixed pipe proximate end 110a to cause the removable pipe proximate end 120a to move axially towards the fixed pipe 110 to engage the fixed pipe proximate end 110a. It will be understood that in some example embodiments the first vertical distance 190 may be relatively small (e.g., about 1 foot to about 2 feet), such that the removable pipe 120 may be directly (manually) manipulated by an operator from the top opening 12au to detachably connect with the fixed pipe 110.

Referring generally to FIGS. 1C to 5B, in some example embodiments one pipe connector 200 of the first pipe connector 112 or the second pipe connector 122 may define one of a socket 214 or a plug 224, and another pipe connector 202 of the second pipe connector 122 or the first pipe connector 112 may define another one of the plug 224 or the socket 214. The socket 214 and the plug 224 are configured to engage each other in a socket connection (also referred to herein as a plug/socket connection, a spigot/socket connection, a sleeve connection, or the like) where at least a part of the plug 224 is inserted into an enclosure defined by the socket 214 to an insertion depth 224id within the socket 214.

The socket 214, also referred to herein interchangeably as a sleeve, may have a socket inner diameter 214id, defined by an inner surface of the one pipe connector 200, that is equal to or greater than a plug outer diameter 224od, which may be defined by an outer surface of the other pipe connector 202, such that the plug 224 may be configured to be at least partially inserted into the socket 214 (e.g., inserted to an insertion depth 224id). The plug 224 and the socket 214 may be configured to engage each other, for example such that an outer surface 224os of the plug 224 contacts and engages in sliding engagement with the inner surface 214is of the socket 214. The plug 224 and the socket 214 may be configured to fit together (based, for example, upon at least a part of the plug 224 being inserted into the socket 214 and/or the socket 214 sleeving the plug 224) to at least partially establish a seal of an interface 226 (also referred to as a socket interface, a sleeve interface, or the like) between the fixed pipe 110 and the removable pipe 120 via a seal of an interface between opposing (e.g., contacting) surfaces of the socket 214 and the plug 224.

In some example embodiments, including the example embodiments shown in FIGS. 1C to 5B, the first pipe connector 112 of the fixed pipe 110 includes (e.g., defines) the socket 214 and the second pipe connector 122 of the removable pipe 120 includes (e.g., defines) the plug 224. For example, as shown in FIGS. 1C to 5B, a portion of an inner surface 110is of the fixed pipe 110 at the fixed pipe proximate end 110a (e.g., extending along axial length 112L from the fixed pipe proximate end 110a) may define the socket 214 of the first pipe connector 112 as a portion of the fixed pipe conduit 110c at the fixed pipe proximate end 110a having an inner diameter 110id (which may be the socket inner diameter 214id) that is equal to or greater than the outer diameter 120od defined by the outer surface 120os of the removable pipe 120 at the removable pipe proximate end 120a (which may be the plug outer diameter 224od). A portion of an outer surface 120os of the removable pipe 120 at the removable pipe proximate end 120a may define the plug 224 of the second pipe connector 122 as a portion of the removable pipe 120 at the removable pipe proximate end 120a (e.g., extending along axial length 122L from the removable pipe proximate end 120a) having an outer diameter 120od (which may be the plug outer diameter 224od) that is equal to or smaller than the inner diameter 110id defined by the inner surface 110is of the fixed pipe 110 at the fixed pipe proximate end 110a (which may be the socket inner diameter 214id). A portion of the removable pipe 120 extending from the removable pipe proximate end 120a and at least partially defining the plug 224 may be configured to be inserted to an insertion depth 224id into the portion of the fixed pipe 110 at least partially defining the socket 214 at the fixed pipe proximate end 110a, such that an outer surface 120os of the removable pipe 120 at the removable pipe proximate end 120a may engage in sliding socket engagement to establish an interface 226 with the inner surface 110is of the fixed pipe 110 at the fixed pipe proximate end 110a and further such that the fixed pipe 110 may enclose (e.g., sleeve) the inserted portion of the removable pipe 120.

In some example embodiments, the removable pipe 120 and the fixed pipe 110 may independently have any range of sizes (e.g., inner and/or outer diameters), such that an outer diameter of one of the removable pipe 120 or the fixed pipe 110 (e.g., the plug outer diameter 224od) is equal to or substantially equal to the inner diameter of another one of the fixed pipe 110 or the removable pipe 120 (e.g., the socket inner diameter 214id). For example, in some example embodiments, including the example embodiments shown in FIGS. 1A to 6C, the removable pipe 120, having a second pipe connector 122 that defines the plug 224, may be 4-inch stainless steel pipe having an outer diameter 120od (and thus a plug outer diameter 224od) of about 4.5 inches, an inner diameter 120id of about 3.152 inches to about 4.260 inches, and a removable pipe sidewall thickness 120t (which is also the plug sidewall thickness 224t, referred to herein interchangeably as the pipe sidewall thickness of the plug 224, and the notch connector sidewall thickness 220t, also referred to herein interchangeably as the pipe sidewall thickness of the notch pipe connector 220) of about 0.120 inches to about 0.674 inches, although example embodiments are not limited thereto. In another example, in some example embodiments, including the example embodiments shown in FIGS. 1A to 6C, the fixed pipe 110, having a first pipe connector 112 that defines the socket 214, may be 4.5-inch stainless steel pipe having an outer diameter of about 5 inches, an inner diameter 110id (and thus a socket inner diameter 214id) of about 4.290 inches to about 4.506 inches, and a fixed pipe sidewall thickness 110t (which is also the socket sidewall thickness 214t, referred to herein interchangeably as the pipe sidewall thickness of the socket 214) of about 0.247 inches to about 0.355 inches, although example embodiments are not limited thereto.

It will be understood that example embodiments are not limited thereto, and in some example embodiments the first pipe connector 112 of the fixed pipe 110 includes (e.g., defines) the plug 224 while the second pipe connector 122 of the removable pipe 120 includes (e.g., defines) the socket 214. For example, in some example embodiments at least a portion of the fixed pipe 110 including the fixed pipe proximate end 110a may extend from the vessel body sidewall inner surface 12as into the vessel interior 12v (e.g., into the arcuate space 90), and at least a portion of the fixed pipe 110 at the fixed pipe proximate end 110a having an outer surface 110os exposed to the vessel interior 12v may have an outer diameter that is equal to or smaller than an inner diameter of at least a portion of the removable pipe 120 at the removable pipe proximate end 120a, such that the removable pipe proximate end 120a may enclose (e.g., sleeve) the fixed pipe proximate end 110a such that the fixed pipe proximate end 110a is inserted into the removable pipe proximate end 120a.

In some example embodiments, including the example embodiments shown in FIGS. 1C to 5B, one pipe connector 200 of the first pipe connector 112 or the second pipe connector 122 may, in addition to defining one of the socket 214 or the plug 224, further define a lug pipe connector 210 including one or more lugs 212 extending radially in relation to a central axis 200x of the one pipe connector 200 (where central axis 200x may be at least one of 110x or 120x), and another pipe connector 202 of the second pipe connector 122 or the first pipe connector 112 may, in addition to defining another one of the plug 224 or the socket 214, further define a notch pipe connector 220 defining one or more notches 222 complementary to the one or more lugs 212 and configured to each receive a respective one of the lugs 212. For example, as shown in FIGS. 1C to 5B, the fixed pipe 110 may include lugs 212 each extending from an inner surface 110is of the fixed pipe 110 at the fixed pipe proximate end 110a, where the lugs 212 extend radially in relation to the central axis 110x of the fixed pipe proximate end 110a, which may be the central axis of the first pipe connector 112, such that the first pipe connector 112 may define the lug pipe connector 210 to include a plurality of lugs 212. In addition, as shown, the removable pipe 120 may include (e.g., may define) a plurality of notches 222 that are complementary to the lugs 212, such that the fixed pipe 110 and the removable pipe 120 are configured to engage with each other such that the lugs 212 are inserted into separate, respective notches 222 based on axial movement and/or rotation of the removable pipe 120 at the removable pipe proximate end 120a in relation to the fixed pipe 110 at the fixed pipe proximate end 110a. The lugs 212 may each be attached to a pipe surface (e.g., the inner surface 110is of the fixed pipe 110) via any known mechanism, including for example welding, although example embodiments of attachment of the lugs 212 to a pipe surface such as the inner surface 110is of the fixed pipe 110 are not limited to welding.

Referring to FIGS. 1C to 5B, in some example embodiments the removable pipe 120 may be configured to detachably connect with the fixed pipe 110 within the vessel interior 12v (e.g., within the arcuate space 90) via the bayonet connection 102 based on (1) moving (e.g., axially moving 302) the removable pipe proximate end 120a towards the fixed pipe proximate end 110a in an axial direction DA, the axial direction DA parallel to a central axis 120x of the removable pipe proximate end 120a, to (1a) cause the one or more lugs 212 of the lug pipe connector 210 to be inserted into separate, respective notches 222 via separate, respective axial notch openings 222o in the axial direction DA, and (1b) cause the plug 224 to be at least partially inserted into the socket 214 in the axial direction DA, and (2) rotating 402 at least the removable pipe proximate end 120a around the central axis 120x of the removable pipe proximate end 120a in relation to the fixed pipe proximate end 110a to cause azimuthal engagement 404 between the notch pipe connector 220 and the lug pipe connector 210 concurrently with the plug 224 being at least partially inserted into the socket 214.

Still referring to FIGS. 1C to 5B, the notch pipe connector 220 may include one or more notches 222 which may each have a respective notch depth 222t extending from at least one of an outer surface or an inner surface of the notch pipe connector 220 through at least a portion of a pipe sidewall thickness of the notch pipe connector 220 (notch connector sidewall thickness 220t). The one or more lugs 212 may each be configured to extend through at least a portion of the notch depth 222t of a respective notch 222 based on being inserted into the respective notch 222 (e.g., through a respective axial notch opening 222o). For example, as shown in FIGS. 1C and 2A to 5B, the second pipe connector 122 of the removable pipe 120 may include a notch pipe connector 220 including a plurality of notches 222 each having a respective notch depth 222t extending radially (perpendicular to the central axis 220x of the notch pipe connector 220, which may be the same as the central axis 120x) from at least one of the outer surface or the inner surface of the notch pipe connector 220 (which as shown may be the outer surface 120os of the removable pipe 120 or the inner surface 120is of the removable pipe 120, respectively). The notch depth 222t may extend through at least a portion of a sidewall thickness 120t of the removable pipe 120 sidewall, which may be the notch connector sidewall thickness 220t. As further shown, the first pipe connector 112 of the fixed pipe 110 may include a lug pipe connector 210 including a plurality of lugs 212 that are configured to each extend through at least a portion of the notch depth 222t from an inner surface 110is of the fixed pipe 110 based on being inserted into the respective notch 222 (e.g., via a respective axial notch opening 222o).

In some example embodiments, including the example embodiments shown in at least FIGS. 1C to 5B, the notch depth 222t of one or more notches 222 is equal to the notch connector sidewall thickness 220t, which may be the pipe sidewall thickness of the pipe that includes the notch pipe connector 220, such that the one or more notches 222 have a notch depth 222t extending through an entirely of the notch connector sidewall thickness 220t. For example, as shown in at least FIGS. 1C to 5B, the notch depth 222t of the notches 222 in the notch pipe connector 220 of the removable pipe 120 may be equal to the sidewall thickness 120t of the removable pipe 120 at the removable pipe proximate end 120a, such that the notches 222 extend through the entirety of the sidewall thickness 120t between the outer surface 120os and the inner surface 120is of the removable pipe 120 at the removable pipe proximate end 120a. However, example embodiments are not limited thereto, and it will be understood that one or more of the notches 222 may have a notch depth 222t that is smaller than the notch connector sidewall thickness 220t(e.g., the sidewall thickness 120t of the removable pipe 120 at the removable pipe proximate end 120a), such that the one or more notches 222 may extend through a limited portion of the notch connector sidewall thickness 220t from one of an outer surface or an inner surface of the notch pipe connector 220. For example, the notch depth 222t may extend from one of the outer surface 120os or the inner surface 120is of the removable pipe 120 through a limited portion of the sidewall thickness 120t of the removable pipe 120.

In some example embodiments, the one or more lugs 212 of the lug pipe connector 210 are each configured to extend into a respective notch 222 of the notch pipe connector 220 and to further extend radially (e.g., perpendicular to a central axis 200x, which may be one or both of the central axis 110x of the fixed pipe 110 or the central axis 120x of the removable pipe 120) through some or all of the notch connector sidewall thickness 220t based on the lug 212 being inserted into the respective notch 222 (e.g., through a respective axial notch opening 222o of the respective notch 222 as described herein). For example, as shown in FIGS. 1C to 5B, in example embodiments where the notch depth 222t of the respective notches 222 extends through an entirety of the notch connector sidewall thickness 220t (e.g., an entirety of the sidewall thickness 120t of the removable pipe 120), the lugs 212 may each extend radially from a surface of the one pipe connector that includes the lug pipe connector 210 to a radial lug height 212t that may be equal to, greater than, or smaller than the notch depth 222t of the respective notches 222 into which the respective lugs 212 may be inserted via respective axial notch openings 222o.

As shown in FIGS. 1C to 5B, in some example embodiments, the one or more lugs 212 may extend radially from an inner surface 214is of the socket 214 (e.g., may extend perpendicular to a central axis of the socket 214) to a distal lug surface 212ds at a radial lug height 212t, and the one or more notches 222 may extend radially inwards (e.g., may extend perpendicular to a central axis of the plug 224) to a notch depth 222t through some or all of a socket sidewall thickness 214t from an outer surface 224os of the plug 224.

As shown in at least FIGS. 1C and 2A to 5B, the radial lug height 212t may equal the notch depth 222t, and in example embodiments where the notch depth 222t equals the notch connector sidewall thickness 220t and the radial lug height 212t, the distal lug surface 212ds of each lug 212 may extend from one surface (of the inner or outer surfaces) of the notch pipe connector 220 through an entirety of the notch connector sidewall thickness 220t so that opposite edges of the distal lug surface 212ds may be flush or substantially flush with an opposite surface (of the inner or outer surfaces) of the notch pipe connector 220 based on the lug 212 being inserted into a respective notch 222. The distal lug surface 212ds may have a curvature (e.g., concave or convex curvature) that corresponds to (e.g., matches) the curvature of the opposite surface (of the inner or outer surfaces) of the notch pipe connector 220, such that the distal lug surface 212ds and the opposite surface (e.g., the inner surface 120is in FIGS. 1C to 5B) may collectively define a same curvature (e.g., a circle).

It will be understood that each lug 212 may include side surfaces 212s. As shown, the side surfaces 212s of each lug 212 may include the axial end surface 212rs facing towards a proximate end of the pipe that includes the lug pipe connector 210 (in the example embodiments shown in FIGS. 1A to 6C, the fixed pipe proximate end 110a) and configured to face towards the axial end surface 222rs of a notch 222 into which the lug 212 is inserted and/or received. As shown, the side surfaces 212s of each lug 212 may include an end side surface 212bs configured to face towards the azimuthal end surface 222bs of the notch 222 into which the lug 212 is inserted and/or received, based on the lug 212 being in the azimuthal notch section 222b of the notch 222 and/or being engaged with the axial end surface 222rs of the notch 222. As shown, the side surfaces 212s of each lug 212 may include a sidewall surface 212as configured to face towards an axial side surface 222as of a notch 222 that opposes (e.g., faces) the azimuthal end surface 222bs of the notch 222 into which the lug 212 is inserted and/or received, based on the lug 212 being in the notch. As shown, the side surfaces 212s of each lug 212 may include an axial rear surface 212es facing opposite to the axial end surface 212rs and configured to face towards a side surface 222es that partially defines the azimuthal notch section 222b and opposes (e.g., faces) the axial end surface 222rs of the notch 222 into which the lug 212 is inserted and/or received, based on the lug 212 being in the notch 222.

It will be understood that each notch 222 includes one or more inner surfaces 222s. As shown, the one or more inner surfaces 222s of each notch 222 may include opposing side surfaces 222as defining opposite sides of the axial notch section 222a, an axial end surface 222rs defining an axial end of the axial notch section 222a opposite the axial notch opening 222o and which may at least partially define the azimuthal notch section 222b, an azimuthal end surface 222bs defining an end of the azimuthal notch section 222b opposite (e.g., facing towards) the axial notch section 222a, a side surface 222es partially defining the azimuthal notch section 222b and facing towards the axial end surface 222rs, and in some example embodiments a chamfer inner surface 222cs defining a chamfer notch section 222c between the azimuthal and axial notch sections 222b and 222a.

Referring to FIGS. 1C to 5B, and particularly to at least FIG. 1F, each notch 222 (also referred to herein as a “channel”, a “slot”, or the like) may extend from an axial notch opening 222o at an axial end 220a of the notch pipe connector 220 (which as shown in FIG. 1F may in some example embodiments be the removable pipe proximate end 120a). Each notch 222 may extend from the respective axial notch opening 222o axially along an axial length 222L to an opposite axial end surface 222rs, in parallel with a central axis 220x of the notch pipe connector 220 (which as shown in FIG. 1F may in some example embodiments be the central axis 120x of the removable pipe proximate end 120a). Each notch 222 may define an axial notch section 222a which may extend axially in parallel with the central axis 220x of the notch pipe connector 220 from a respective axial notch opening 222o at the axial end 220a of the notch pipe connector 220 to an axial end surface 222rs of the notch 222. Each notch 222 may further define an azimuthal notch section 222b extending at least partially azimuthally around the central axis 220x of the notch pipe connector 220 from the axial notch section 222a. As shown in at least FIG. 2B, a notch 222 may include one or more inner surfaces 222s which define the axial and azimuthal notch sections 222a and 222b. As shown, the one or more inner surfaces 222s may include the axial end surface 222rs of the notch 222. Each of the axial and azimuthal notch sections 222a and 222b may be defined by the one or more inner surfaces 222s to extend radially (perpendicular to the central axis 220x) to the notch depth 222t, which may be equal to the notch connector sidewall thickness 220t (which may be the sidewall thickness 120t of the removable pipe 120 at the removable pipe proximate end 120a). As shown, the axial and azimuthal notch sections 222a and 222b may be open to each other and may be separate portions of a single, continuous channel (e.g., notch, slot, etc.) through the notch connector sidewall thickness 220t that extends for an axial length 222L (e.g., axial distance) in parallel with the central axis 220x from the axial notch opening 222o and then turns to extend for an azimuthal distance around the central axis 220x to an azimuthal end surface 222bs defined by at least one of the inner surfaces 222s. Such a notch 222 may be referred to in some example embodiments as L-shaped.

Each of the axial and azimuthal notch sections 222a and 222b of a given notch 222 may be configured to accommodate a respective lug 212 that enters the notch 222 through the axial notch opening 222o, moves axially through the axial notch section 222a (e.g., to a point where an axial end surface 212rs of the lug 212 engages the axial end surface 222rs of the notch 222) and then moves azimuthally through the azimuthal notch section 222b to engage (contact) the azimuthal end surface 222bs (e.g., at a corresponding end side surface 212bs of the lug 212). Such movement of the lug 212 in relation to the notch 222 may be based on movement of the removable pipe 120 (which may include the notch pipe connector 220 or the lug pipe connector 210) in relation to the fixed pipe 110, for example to cause the removable pipe proximate end 120a to axially move 302 (e.g., in parallel to the central axis 120x of the removable pipe proximate end 120a and/or the central axis 110x of the fixed pipe proximate end 110a) in relation to the fixed pipe proximate end 110a, to cause the axial movement of a lug 212 through an axial notch section 222a of a notch 222 towards the axial end surface 222rs, and to then rotate 402 around the central axis 120x and/or the central axis 110x (e.g., central axis 200x) to cause azimuthal movement 404 of the lug 212 through the azimuthal notch section 222b of the notch 222 to engage the azimuthal end surface 222bs at an end side surface 212bs of the lug 212.

Still referring to FIGS. 1C to 5B, and particularly to at least FIG. 1F, each notch 222 may further define (e.g., may include one or more inner surfaces 222s that define) a chamfer notch section 222c (also referred to as a ramp notch section) extending both axially and azimuthally between the axial notch section 222a and the azimuthal notch section 222b. The chamfer notch section 222c may engage a lug 212 located in the notch 222 and may induce axial movement of the notch pipe connector 220 in relation to the lug pipe connector 210 based on engagement of a lug 212 with a chamfer inner surface 222cs of the notch 222 that defines the chamfer notch section 222c due to rotation 402 of the notch pipe connector 220 around the central axis 220x. As a result, axial movement 302 of the removable pipe 120 towards the fixed pipe 110 may be induced based on rotation 402 of the removable pipe proximate end 120a around a central axis 120x and/or 110x, thereby enabling engagement of the bayonet connection 102 with reduced or minimized axial force applied to the removable pipe 120 to induce the axial movement 302 thereof, instead leveraging torque 401 applied to the removable pipe 120 that induces rotation 402 to further induce axial movement 302 based on engagement between a lug 212 and a chamfer notch section 222c of a corresponding notch 222.

Still referring to FIGS. 1C to 5B, in some example embodiments the fixed pipe 110 may define a first pipe connector 112 at the fixed pipe proximate end 110a that may define both a socket 214 and a lug pipe connector 210, and the removable pipe 120 may define a second pipe connector 122 at the removable pipe proximate end 120a that may define both a plug 224 and a notch pipe connector 220. The socket 214 and the plug 224 may be complementary to each other, where the plug 224 is configured to be inserted into the socket 214, and the lug pipe connector 210 may be complementary to the notch pipe connector 220 such that the lug pipe connector 210 may include a plurality of lugs 212 that are configured to be inserted into separate, respective notches 222 of the notch pipe connector 220 and to move through respective axial and azimuthal notch sections of the respective notches 222 based on axial and azimuthal movement of the removable pipe 120 in relation to the fixed pipe 110.

Still referring to FIGS. 1C to 5B, in some example embodiments the pipe connection assembly 100 may include an outer seal/stop structure 182 (also referred to interchangeably as a seal, a stop, or any combination thereof) on an outer surface 224os of the plug 224 and configured to engage the socket 214, to at least partially seal an interface 226 between opposing surfaces 224os and 214is. In some example embodiments, the pipe connection assembly 100 may include an inner seal/stop structure 184 on an inner surface 214is of the socket 214 and configured to engage the plug 224, to at least partially seal the interface 226 between opposing surfaces of the plug 224 and the socket 214. It will be understood that a “seal/stop structure” as described herein, including outer seal/stop structure 182, inner seal/stop structure 184, or the like, include at least one of a seal structure, a gasket structure, a stop structure, or any combination thereof, including for example one or more of any known seal, gasket, O-ring, stop, or the like. For example, in example embodiments where the second pipe connector 122 of the removable pipe 120 defines the plug 224 such that the outer surfaces 120os of the removable pipe 120 at the removable pipe proximate end 120a define the outer surface 224os of the plug 224, the removable pipe 120 may further include an outer seal/stop structure 182 extending at least partially around the circumference of the outer surface 120os, where the outer seal/stop structure 182 is configured to engage the fixed pipe proximate end 110a (which includes the socket 214) based on the plug 224 being inserted into the socket 214. In another example, in example embodiments where the first pipe connector 112 of the fixed pipe 110 defines the socket 214, for example such that the inner surfaces 110is of the fixed pipe 110 at the fixed pipe proximate end 110a define the inner surface 214is of the socket 214, the fixed pipe 110 may further include an inner seal/stop structure 184 within the fixed pipe conduit 110c, where the inner seal/stop structure 184 is configured to engage the removable pipe proximate end 120a (which includes the plug 224) based on the plug 224 being inserted into the socket 214. The outer and inner seal/stop structures 182 and 184 may each independently include one or more of any known seal, gasket, O-ring, stop, or the like that is configured to limit axial movement of the removable pipe proximate end 120a in relation to the fixed pipe proximate end 110a and/or to establish a seal of the interface 226 (also referred to herein as a socket interface, a sleeve interface, or the like) between the removable pipe 120 and the fixed pipe 110. As shown, the outer and inner seal/stop structures 182 and 184 may define an axial length 112L of the first pipe connector 112 from the fixed pipe proximate end 110a and/or an axial length 122L of the second pipe connector 122 from the removable pipe proximate end 120a. As shown, the outer and inner seal/stop structures 182 and 184 may at least partially define the insertion depth 224id of the plug 224 (e.g., the removable pipe 120) into the socket 214 (e.g., the fixed pipe 110) to engage the bayonet connection 102 between the fixed pipe 110 and the removable pipe 120.

It will be understood that an element that is “at” the fixed pipe proximate end 110a may be at least one of adjacent to, bounded by, or proximate to the fixed pipe proximate end 110a. For example, as shown, a first pipe connector 112, or any portion thereof, that is at the fixed pipe proximate end 110a may be understood to be at a portion of the fixed pipe 110 that is adjacent to, bounded by and/or extends from the fixed pipe proximate end 110a. It will be understood that an element that is “at” the removable pipe proximate end 120a may be at least one of adjacent to, bounded by, or proximate to the removable pipe proximate end 120a. For example, as shown, a second pipe connector 122, or any portion thereof, that is at the removable pipe proximate end 120a may be understood to be at a portion of the removable pipe 120 that is adjacent to, bounded by and/or extends from the removable pipe proximate end 120a.

In some example embodiments, including example embodiments shown in FIGS. 1A to 6C, the vessel 12 may be a thick-walled vessel (e.g., a thick-walled pressure vessel, a pressure vessel, or the like) configured to support a relatively high internal pressure within the vessel interior 12v. In some example embodiments, one or both of the fixed pipe 110 and the removable pipe 120 may be thick-walled, high-pressure metal pipes having relatively large sidewall thicknesses 110t and/or 120t, respectively, and configured to support a high-pressure flow of fluid 26 through the respective conduits 110c and 120c thereof. In some example embodiments, including example embodiments where the removable pipe 120 is detachably coupled to the fixed pipe 110 via the bayonet connection 102, such that the conduits 110c and 120c collectively define a continuous fluid conduit, a fluid 26 flowing through the fixed pipe conduit 110c and into the removable pipe conduit 120c may be flowing at a relatively high pressure and/or flow rate and may impart an ejection force 230 on the removable pipe 120, for example based on impinging on an inner surface of a bend 120e in the removable pipe 120. For example, in example embodiments where a sudden flow or surge in flow rate of fluid 26 through the fixed pipe conduit 110c to the removable pipe conduit 120c occurs, which may cause a surge in pressure in the conduits 120c, the sudden flow or surge in flow of fluid 26 may cause a surge in pressure (e.g., a pressure surge of up to about 1200 psi) on an inner surface of the bend 120e in the removable pipe conduit 120c and may, as a result, impart an ejection force 230 on the removable pipe due to hydraulic shock (also referred to herein interchangeably as fluid hammer or water hammer) as a result of the pressure surge in the removable pipe 120 due to the surge in fluid flow and/or pressure. The load on the removable pipe 120 due to such hydraulic shock is referred to herein as an ejection force 230 imparted on the removable pipe 120. It will be understood that the ejection force 230 may be imparted on the removable pipe 120 due to hydraulic shock (e.g., water hammer) on another component or piping connected to the removable pipe 120 (e.g., hydraulic shock on the vessel internal piping 30, vessel internal fixture 40, or any combination thereof) where the ejection force 230 is then transferred to the removable pipe 120.

Still referring to FIGS. 1C to 5B, and in particular referring to at least FIGS. 1D and 1F, in some example embodiments the bayonet connection 102, which is engaged based on the second pipe connector 122 of the removable pipe 120 detachably connecting with the first pipe connector 112 of the fixed pipe 110, may be configured to resist an ejection force 230 exerted on the removable pipe 120 in the axial direction (e.g., parallel to central axis 120x), based on a fluid 26 moving between respective conduits 110c and 120c of the fixed pipe 110 and the removable pipe 120. As a result, the bayonet connection 102 may be configured to transfer a load between a pipe sidewall 110s of the fixed pipe 110 and a pipe sidewall 120s of the removable pipe 120 to counteract (e.g., resist) the ejection force 230. In example embodiments where the removeable pipe 120 is coupled to at least one of vessel internal piping 30 or a vessel internal fixture 40 (e.g., a fixture, for example a spray head, sparger, or the like) and is configured to discharge the fluid 26 flowing through the removable pipe conduit 120c thereto through the removable pipe distal end 120b, and where the removable pipe 120 or at least one of the at least one of vessel internal piping 30 or a vessel internal fixture 40 includes an elbow or bend (for example bend 120e of the removable pipe 120), or the like, significant ejection forces 230 could be imparted on or through the removable pipe 120 due to fluid 26 flow through at least the removable pipe conduit 120c. As shown, the removable pipe 120 may include a bend 120e that causes the removable pipe conduit 120c to change direction between the removable pipe proximate end 120a and the removable pipe distal end 120b. Therefore, when the removable pipe 120 is detachably connected to the fixed pipe 110, such that the conduits 110c and 120c are in open fluid communication with each other, a fluid 26 flowing into the removable pipe conduit 120c from the fixed pipe conduit 110c may initially flow through the conduit 120c in an axial direction DA parallel to the central axis 120x of the removable pipe proximate end 120a and may then impinge on an inner surface 120is of the removable pipe 120 defining the bend 120e. Such impingement of the fluid 26 on the inner surface 120is may cause the fluid 26 to change direction to flow through the bend 120e towards the removable pipe distal end 120b and may impart an ejection force 230 on the removable pipe 120. The bayonet connection 102 may be configured to resist the ejection force 230, to reduce or minimize the risk that the ejection force 230 may cause the removable pipe 120 to be detached from the fixed pipe 110, thereby improving reliability of the pipe connection assembly 100. In some example embodiments, the bayonet connection 102 may define a load path to resist the ejection force 230, for example to transmit force between the removable pipe 120 and the fixed pipe 110 through the respective structure (e.g., respective sidewall thickness 120t or 110t) of the removable pipe 120 and the fixed pipe 110, to resist the ejection force 230. For example, the bayonet connection 102 may be configured to transfer loads applied on the inside of the bend 120e in the axial direction DA parallel to a central axis 120x, 110x, and/or 200x (e.g., ejection force 230) between the removable pipe 120 and the fixed pipe 110 through the respective sidewall thicknesses 120t and 110t of the removable pipe 120 and the fixed pipe 110, and further through axially engaging side surfaces 222es and 212es of the notches 222 and the lugs 212, respectively, where such axially engaging side surfaces 222es and 212es may define an axial interface 228 between the lug pipe connector 210 and the notch pipe connector 220. Accordingly, the load path 240 between the removable pipe 120 and the fixed pipe 110 may extend at least partially in the axial direction (e.g., parallel to the central axis 200x which may be one or both of the central axes 110x and 120x) through at least one of the plug 224 or the socket 214 to an axial interface 228 between the lug pipe connector 210 (e.g., a axial rear surface 212es thereof) and the notch pipe connector 220 (e.g., an opposing side surface 222es thereof engaging a axial rear surface 212es of at least one lug 212). For example, the notches 222 may each have an “L” shape, due to each having an axial notch section 222a extending into the notch pipe connector 220 from an axial notch opening 222o and further having an azimuthal notch section 222b extending azimuthally (e.g., at a right angle 222r to the distal end of the axial notch section 222a opposite the axial notch opening 222o). The axial length of the axial notch section 222a of a notch 222 may be greater than the azimuthal length of the azimuthal notch section 222b of the notch 222, such that the axial notch section 222a may define a “long part” of the L shape of the notch 222 and the azimuthal notch section 222b may define a “short part” of the L shape of the notch 222. As shown, the notches 222 of a notch pipe connector 220 may be defined by material 220e (e.g., metal) of the pipe that includes the notch pipe connector 220, and such material 220e may provide strength and load-bearing capability to the connection between the pipe that defines the notches 222 and the pipe that includes the lugs 212. The “L” shape of the notches 222, as defined by at least the axial and azimuthal notch sections 222a and 222b thereof, may be configured to provide sufficient ligament strength for the material 220e (e.g., the metal) of the pipe comprising the notch pipe connector 220 (e.g., the removable pipe 120) next to the axial notch section 222a (e.g., the long part of the L shape, also referred to as a “slot”) that may restrain the removable pipe 120 from ejection due to the ejection force 230 (e.g., in example embodiments where the second pipe connector 122 of the removable pipe 120 defines the plug 224 and the notch pipe connector 220, the L shape of the notches 222 may be configured to provide sufficient ligament strength for the metal of the removable pipe 120 next to the axial notch section 222a (e.g., the long part of the L shape, also referred to as a “slot”) that may restrain the removable pipe 120 from ejection from the fixed pipe 110. In some example embodiments, increasing the length 222L of the axial notch section 222a of the notches 222 of the notch pipe connector 220 may increase the amount of pipe material 220e (e.g., metal) defining the notches 222, which may increase the ligament strength of the material 220e (e.g., metal) of the pipe (e.g., the removable pipe 120) to resist the ejection force 230 and transfer the load induced by the ejection force 230 along a load path 240 to the other connected pipe (e.g., the fixed pipe 110) through the bayonet connection 102. In some example embodiments, the axial and azimuthal notch sections 222a and 222b may define a 90-degree, right angle 222r turn of the L shape of the notch 222 at the axial end surface 222rs of the notch 222. Such a right angle 222r turn may configure the notch 222 to enable entrance (insertion) of the lug 212 into the azimuthal notch section 222b (also referred to as the flat or bottom of the L) from the axial notch section 222a.

As shown, the axial notch section 222a may have an axial length 222L and an azimuthal width 222aw (also referred to herein as an angular width, a curve length, or an arc length). The azimuthal width 222aw may be a width of the axial notch section 222a in a direction of the circumference (e.g., a circumferential direction) of the notch pipe connector 220 (which may be the circumference of the pipe that includes the notch pipe connector 220, such as the removable pipe 120 as shown). As shown, the azimuthal width 222aw may extend in the circumferential direction and thus may vary with distance from the central axis 200x (e.g., central axis 220x and/or 120x) in the radial direction (e.g., vary from inner surface 120is to outer surface 120os along the direction of the removable pipe sidewall thickness 120t), although example embodiments are not limited thereto. As further shown, the azimuthal notch section 222b may have an axial width 222bw in a direction parallel to the central axis 200x (e.g., parallel to central axis 220x and/or 120x). The widths 222aw and 222bw of the axial and azimuthal notch sections 222a and 222b (e.g., the width of both legs of the L) may be based on the quantity and size of lugs 212 that the lug pipe connector 210 is configured to engage with the notch pipe connector 220 (e.g., in a flush or substantially flush fit between opposing surfaces of the lugs 212 and corresponding notches 222) to achieve sufficient strength of the bayonet connection 102 to prevent pipe ejection of the removable pipe 120 from the fixed pipe 110, or to reduce or minimize the likelihood of such ejection.

As shown, each lug 212 may have an azimuthal width 212aw (also referred to herein as an angular width, a curve length, or an arc length) and an axial width 212bw. The azimuthal width 212aw may be a width of the lug 212 in a direction of the circumference (e.g., a circumferential direction) of the lug pipe connector 210 (which may be the circumference of the pipe that includes the lug pipe connector 210, such as the fixed pipe 110 as shown). As shown, the azimuthal width 212aw may extend in a circumferential direction and thus may vary with distance from the central axis of the proximate end of the pipe that includes the lug pipe connector 210 (e.g., central axis 200x, which may be central axis 110x) in the radial direction (e.g., vary from distal lug surface 212ds to inner surface 110is along a radial direction extending radially from central axis 110x), although example embodiments are not limited thereto. As further shown, the axial width 212bw may be a width of the lug 212 in a direction parallel to the central axis of the proximate end of the pipe including the lug pipe connector 210 (e.g., parallel to central axis 110x).

As shown, the azimuthal width 222aw and the axial width 222bw at a given radial distance from a central axis 200x (e.g., central axis 110x and/or 120x) may correspond to (e.g., may be equal to or greater than) respective azimuthal and axial widths 212aw and 212bw of the lugs 212 to enable a tight fit (e.g., flush contact) between the lugs 212, and thus the lug pipe connector 210, and the notches 222 (and thus between the lug pipe connector 210 and the notch pipe connector 220) to thereby reduce or minimize “play” in the axial and/or azimuthal directions between the lug pipe connector 210 and the notch pipe connector 220. For example, as shown, the opposing notch inner surfaces 222as in the axial notch section 222a may extend radially from the central axis 220x (e.g., central axis 120x), in the thickness direction of the notch pipe connector 220 (e.g., in the thickness direction of thickness 120t), such that the azimuthal width 222aw, and thus the opposing notch inner surfaces 222as, may at least partially define a first central angle having a vertex at central axis 200x (e.g., central axis 220x and/or 120x). In some example embodiments, the lug side surfaces 212as and 212bs may extend radially from the central axis 200x (e.g., central axis 110x) such that the azimuthal width 212aw, and thus the opposite lug side surfaces 212as and 212bs, may at least partially define a second central angle having a vertex at central axis 200x (e.g., central axis 110x).

In some example embodiments, the opposing notch inner surfaces 222as and the opposing lug side surfaces 212as and 212bs may be complementary such that the first and second central angles are a same or substantially same central angle having a vertex at central axis 200x, and the lug 212 may be configured to establish flush or substantially flush contact between the opposing lug side surfaces 212as and 212bs and corresponding opposite notch inner surfaces 222as based on the lug 212 moving axially through the axial notch section 222a. In some example embodiments, the notch azimuthal end surface 222bs may extend radially from the central axis 220x (e.g., central axis 120x), in the thickness direction of the notch pipe connector 220 (e.g., in the thickness direction of thickness 120t) and may be complementary to the lug end side surface 212bs, such that the lug 212 may be configured to establish flush or substantially flush contact between the lug end surface 212bs and the notch azimuthal end surface 222bs based on the lug 212 moving azimuthally through the azimuthal notch section 222b from the axial notch section 222a to engage the notch azimuthal end surface 222bs. For example, each of the side surfaces and/or inner surfaces 222as, 222bs, 212as, and/or 212bs may extend in a radial direction from a central axis of the proximate end of one or both of the removable pipe 120 or the fixed pipe 110. However, it will be understood that example embodiments are not limited thereto. For example, in some example embodiments the opposing notch inner surfaces 222as in the axial notch section 222a may extend in parallel or substantially in parallel with each other away from the central axis 200x such that the notch azimuthal width 222aw is constant with varying distance from central axis 200x and the axial notch section 222a is configured to receive and establish flush contact with a lug 212 having a constant azimuthal width 212aw with varying distance from central axis 200x which may be the same or substantially the same as the constant azimuthal width 222aw. In some example embodiments, the lug side surfaces 212as and 212bs may extend in parallel or substantially parallel with each other away from the central axis 200x such that the lug azimuthal width 212aw is constant with varying distance from central axis 200x. In some example embodiments, the azimuthal widths 212aw and 222aw may be equal or substantially equal to each other and may each be constant or substantially constant with varying distance from a central axis 200x (e.g., central axis 120x and/or 110x).

It will be understood that, in some example embodiments, the engagement and interface 226 between the socket 214 and the plug 224, referred to herein as a “socket connection”, a “socket interface,” a “sleeve connection”, or a “sleeve interface,” such that portions of the fixed pipe 110 and the removable pipe 120 (e.g., the first and second pipe connectors 112 and 122) overlap each other in a radial direction that is perpendicular to at least one of the central axis 200x, 120x, or 110x, in combination with the engagement between the lugs 212 and corresponding notches 222 of the fixed pipe 110 and the removable pipe 120, may improve the strength and pressure-retaining capability of the connection between the fixed pipe 110 and the removable pipe 120 and improve the ability of the connection to resist disengagement or leakage (e.g., due to an ejection force 230 imparted on the removable pipe 120 due to water hammer effects), relative to a connection between pipes wherein respective proximate ends (e.g., openings, faces, etc.) of the pipes engage each other in flush face contact.

While example embodiments of the pipe connection assembly 100 are shown in FIGS. 1C to 5B to include a lug pipe connector 210 with four lugs 212 and a corresponding notch pipe connector 220 with four corresponding notches 222, example embodiments are not limited thereto. For example, the lug pipe connector 210 of the pipe connection assembly 100 may include any quantity of lugs 212, and the notch pipe connector 220 may include any quantity of notches 222. The quantity of notches 222 of the notch pipe connector 220 may be equal to or greater than the quantity of lugs 212 of the lug pipe connector 210, and at least some of the notches 222 may be configured to respectively receive a separate lug 212 of the lug pipe connector 210 through a respective axial notch opening 222o based on the plug 224 being inserted into the socket 214. In some example embodiments where the quantity of notches 222 of the notch pipe connector 220 are greater than the quantity of lugs 212 of the lug pipe connector 210.

As shown in FIGS. 1D and 1F, the axial notch section 222a may extend in an axial length 222L from a respective axial notch opening 222o at the axial end 220a of the notch pipe connector 220 (e.g., the removable pipe proximate end 120a) to an axial end surface 222rs. As further shown in FIG. 1D, the lugs 212 may be axially spaced apart (e.g., at the axial end surface 212rs thereof) from a proximate end of the pipe that includes the lugs (e.g., the fixed pipe proximate end 110a) by an axial length 212L. As shown in FIG. 1D, the sum of the axial lengths 222L and 212L may correspond to (e.g., may equal) the insertion depth 224id of the plug 224 into the socket 214. In example embodiments where the second pipe connector 122 of the removable pipe 120 defines the plug 224, the sum of the axial lengths 222L and 212L may correspond to (e.g., may equal) the insertion depth 224id as a depth that a portion of the removable pipe 120 extends into the fixed pipe 110 to engage the bayonet connection 102 between the lugs 212 of the first pipe connector 112 and separate, respective notches 222 of the second pipe connector 122 at respective azimuthal end surfaces 222bs thereof. As shown, the inner seal/stop structure 184 may be located at the insertion depth 224id into the fixed pipe conduit 110c, but example embodiments are not limited thereto. As shown, the outer seal/stop structure 182 may be axially offset from the removable pipe proximate end 120a by the insertion depth 224id, but example embodiments are not limited thereto. In some example embodiments, the insertion depth 224id (e.g., the sum of axial lengths 212L and 222L) may define axial boundaries of the first and second pipe connectors 112 and 122. For example, the first pipe connector 112 may be defined as a portion of the fixed pipe 110 extending to the insertion depth 224id from the fixed pipe proximate end 110a which defines the socket 214 and further including the lugs 212 comprising the lug pipe connector 210. In another example, the second pipe connector 122 may be defined as a portion of the removable pipe 120 extending to the insertion depth 224id from the removable pipe proximate end 120a along central axis 120x which defines the plug 224 and further including the notches 222 comprising the notch pipe connector 220.

As shown, the removable pipe 120 may be sized to have a maximum axial length 120L extending from the removable pipe proximate end 120a in a direction parallel to the central axis 120x of the removable pipe proximate end 120a, where the maximum axial length 120L may be configured to approximate (e.g., may be within about 1% to about 20%, within about 1% to about 10%, within about 1% to about 5%, etc., although example embodiments are not limited thereto) the radial clearance 90d of the arcuate space 90 at least at the first vertical distance 190 of the fixed pipe 110 from the vessel body top opening 12au. As a result, the removable pipe 120 may be configured to be lifted and/or lowered through the arcuate space 90 with relatively small clearances 290a and 290b (e.g., which may each independently be between about 0.05 inches to about 1 inch, although example embodiments are not limited thereto) between the removable pipe 120 and the one or more vessel internal process components 14 (e.g., upper vessel internal process component 18) and the vessel body sidewall inner surface 12as, respectively. The pipe connection assembly 100 may define the insertion depth 224id, based on the combined axial lengths 212L and 222L defined by the lug and notch pipe connectors 210 and 220 in separate ones of the first and second pipe connectors 112 and 122, to be equal or smaller than the clearance 90c between the removable pipe 120 and the one or more vessel internal process components 14 when the bayonet connection 102 is engaged.

Referring to FIGS. 1C to 5B, and further referring to FIGS. 6A to 6C, in some example embodiments the pipe connection assembly 100 may include an anti-rotation assembly 130. The anti-rotation assembly 130 may be configured to at least partially restrict (e.g., fix or substantially fix, arrest or substantially arrest, limit or substantially limit, inhibit or substantially inhibit, etc.) movement of an azimuthal orientation 120z of at least the removable pipe proximate end 120a, and thus at least partially restrict movement of the removable pipe 120, in relation to the vessel 12 independently of the bayonet connection 102 (e.g., independently of at least the fixed pipe 110), based on the removable pipe 120 being detachably connected with the fixed pipe 110 via the bayonet connection 102. Based on at least partially restricting movement of the azimuthal orientation 120z of the removable pipe 120, and thus at least partially restrict movement of the removable pipe 120, in relation to the vessel 12 independently of the bayonet connection 102 and/or the fixed pipe 110, the anti-rotation assembly 130 may reduce, minimize, or prevent the risk of inadvertent or undesired rotation 402 of the removable pipe proximate end 120a (e.g., due to vibrations during operation of the process unit 10 which includes the vessel 12 and/or due to vibrations induced by fluid 26 flowing around the outer surface 120os of the removable pipe 120 in the vessel interior 12v during operation of the process unit 10) which might cause the bayonet connection 102 to at least partially disengaged due to rotation which causes the azimuthal orientation 120z to change. Accordingly, the anti-rotation assembly 130 may reduce, minimize, or prevent undesired disengagement of the bayonet connection 102 or leakage of fluid 26 from the conduits 110c and/or 120c through the interface 226 between the fixed pipe 110 and the removable pipe 120. The anti-rotation assembly 130 may enable the azimuthal orientation 120z to be at least partially restricted without using separate fasteners at the location of the bayonet connection 102, for example based on actions by an operator located at the vessel body top opening 12au.

In some example embodiments, the azimuthal orientation 120z is a particular orientation, direction, or the like that extends perpendicular from the central axis 120x and is fixed in relation to the removable pipe 120 and thus may move in relation to a fixed structure (e.g., the vessel body 12a, the fixed, pipe 110, etc.) based on movement of the removable pipe 120 in relation to the fixed structure. For example, as shown, in some example embodiments, the azimuthal orientation 120z of the removable pipe 120 extends from the central axis 120x of the removable pipe proximate end 120a (e.g., extends perpendicular to the central axis 120x) and in parallel with one or more structures, surfaces, or the like of the removable pipe 120 and/or any structure connected (e.g., fixed) thereto. For example, the azimuthal orientation 120z may extend perpendicularly from the central axis 120x in a direction that is parallel with the longitudinal axis 132x of the first conduit 132c of the first conduit structure 132 that is connected to the removable pipe 120. For example, the azimuthal orientation 120z may extend from the central axis 120x and through the first conduit 132c (e.g., coaxially with the longitudinal axis 132x).

It will be understood that at least partially restricting movement of the azimuthal orientation 120z of at least the removable pipe proximate end 120a may be referred to interchangeably as at least partially restricting movement of the azimuthal orientation 120z of the removable pipe 120, at least partially restricting an angle 120r between the azimuthal orientation 120z and a fixed direction (e.g., a vertical direction DV and/or a direction in which the conduit axis 130x extends) from changing, causing the angle 120r to remain constant or substantially constant, at least partially restricting movement of the removable pipe 120, any combination thereof, or the like. As described herein, at least partially restricting movement of the azimuthal orientation 120z may include causing the azimuthal orientation 120z to remain the same or substantially the same over time (e.g., during operation of the process unit 10), which may include restricting time-variation of the azimuthal orientation 120z in relation to a fixed direction (e.g., the vertical direction DV, the conduit axis 130x, any combination thereof, or the like), restricting time-variation of the angle 120r between the azimuthal orientation and the fixed direction, causing the angle 120r to remain the same or substantially the same over time, any combination thereof, or the like. As described herein, causing the azimuthal orientation 120z to remain the same or substantially the same over time may include restricting variation of the angle 120r between the azimuthal orientation 120z and a fixed direction (e.g., the vertical direction DV, the direction in which the conduit axis 130x extends, the direction in which the longitudinal axis 134x extends, etc.) to between 0 degrees and about 5 degrees, between 0 degrees and about 2 degrees, between 0 degrees and about 1 degree, between 0 degrees and about 0.5 degrees, between 0 degrees and about 0.1 degrees, between 0 degrees and about 0.01 degrees, between about 0.1 degrees and about 5 degrees, between about 0.1 degrees and about 2 degrees, between about 0.1 degrees and about 1 degree, between about 0.1 degrees and about 0.5 degrees, or between about 0.1 degrees and about 0.2 degrees, although example embodiments are not limited thereto.

In some example embodiments, the vertical direction DV extends from the central axis 110x of the fixed pipe proximate end 110a in parallel with the longitudinal axis of the vessel interior 12v. In some example embodiments, the vertical direction DV extends from the central axis 110x and in parallel with a longitudinal axis 134x of at least the second conduit 134c, for example extending through the second conduit 134c parallel (e.g., coaxial) with the longitudinal axis 134x. The angle 120r of the azimuthal orientation 120z may represent an angular (or azimuthal) displacement of the first conduit 132c from the second conduit 134c with regard to a central axis 200x (which may be coaxial with one or both of the central axes 110x and 120x). For example, the angle 120r of the azimuthal orientation 120z may represent an angle defined between the longitudinal axis 132x of the first conduit 132c and the longitudinal axis 134x of the second conduit 134c.

As shown in at least FIGS. 1C to 6C, the anti-rotation assembly 130 may include a first conduit structure 132 which is connected to the removable pipe 120, for example via any known means including bonding, welding, based on the first conduit structure 132 being integral to the material of the removable pipe 120 as a single unitary piece of material, etc. As shown, the first conduit structure 132 may be defined by one or more pieces of material; for example, the first conduit structure 132 may include a single block of material. The first conduit structure 132 may have one or more inner surfaces 132s defining a first conduit 132c that extends along a longitudinal axis 132x at least partially through the first conduit structure 132 from a top opening 132a.

The anti-rotation assembly 130 may include a second conduit structure 134 which is connected (e.g., directly or indirectly connected, fixed, etc.) to the vessel 12 (e.g., the vessel body 12a), for example via any known means including bonding, welding, based on the second conduit structure 134 being integral to the material of the vessel body 12a as a single unitary piece of material, etc. As shown, the second conduit structure 134 may be defined by one or more pieces of material; for example, the second conduit structure 134 may include a single block of material. The second conduit structure 134 may have one or more inner surfaces 134s defining a second conduit 134c that extends along a longitudinal axis 134x at least partially through the second conduit structure 134 from a top opening 134a. As shown, the second conduit structure 134 may define the second conduit 134c to extend through an entire thickness of the second conduit structure 134 between a top opening 134a and a bottom opening 134b, but example embodiments are not limited thereto.

The anti-rotation assembly 130 may include a retainer pin 140 configured to extend at least partially through each of the first conduit 132c and the second conduit 134c based on the first and second conduits 132c and 134c being at least partially aligned to establish a collective conduit 130c extending through both the first and second conduits 132c and 134c. For example, as shown, the pipe connection assembly 100 may be configured to position the first conduit structure 132 in relation to the second conduit structure 134 based on the removable pipe 120 being detachably connected to the fixed pipe 110 via the bayonet connection 102 to align the first conduit 132c with the second conduit 134c, for example such that the respective longitudinal axes 132x and 134x of the first and second conduits 132c and 134c are aligned in relation to a single conduit axis 130x (e.g., such that the respective longitudinal axis of the first conduit 132c is aligned to extend in parallel or coaxial with the respective longitudinal axis 134x of the second conduit 134c as a single longitudinal axis, referred to herein as a conduit axis 130x. The collective conduit 130c may be at least partially defined by the aligned first and second conduits 132c and 134c. As shown, a retainer pin 140 may include a pin shaft 140a which may be extended through the collective conduit 130c so that the retainer pin 140 extends through both the first and second conduits 132c and 134c. based on extending through both the first and second conduits 132c and 134c, the retainer pin 140 may act to reduce, minimize, or prevent movement of the first conduit structure 132, and the removable pipe 120 fixed thereto, in relation to the second conduit structure 134, and the vessel fixed thereto in one or more horizontal directions that are perpendicular or substantially perpendicular to the conduit axis 130x (e.g., reducing, minimizing, or preventing lateral movement of the first conduit structure 132), thereby further reducing, minimizing, or preventing rotation 402 of the removable pipe proximate end 120a and thereby reducing, minimizing, or preventing disengagement of the bayonet connection 102 between the removable pipe 120 and the fixed pipe 110.

Referring to at least FIGS. 1C to 1E and 6A to 6C, the anti-rotation assembly 130 may include additional conduit structures and conduits, but example embodiments are not limited thereto. For example, as shown, in example embodiments where a vessel internal piping 30 (e.g., a removable pipe) is connected to the removable pipe distal end 120b of the removable pipe 120, the anti-rotation assembly 130 may include a third conduit structure 136 which is connected (e.g., directly or indirectly connected, fixed, etc.) to the vessel internal piping 30, for example via any known means including bonding, welding, based on the third conduit structure 136 being integral to the material of the vessel internal piping 30 as a single unitary piece of material, etc. As shown, the third conduit structure 136 may be defined by one or more pieces of material; for example, the third conduit structure 136 may include a single block of material. The third conduit structure 136 may have one or more inner surfaces 136s defining a third conduit 136c that extends along a longitudinal axis 136x at least partially through the third conduit structure 136 from a top opening 136a. As shown, the third conduit structure 136 may define the third conduit 136c to extend through an entire thickness of the third conduit structure 136 between a top opening 136a and a bottom opening 136b, but example embodiments are not limited thereto. The first to third conduit structures 132, 134, and 136 may be aligned with each other to align the respective longitudinal axes 132x, 134x, and 136x of the first to third conduits 132c, 134c, and 136c to collectively at least partially define the collective conduit 130c having the conduit axis 130x as a longitudinal axis thereof, and the pin shaft 140a may be inserted into the collective conduit 130c to extend through each of the first to third conduits 132c, 134c, and 136c to reduce, minimize, or prevent lateral movement of the first and third conduit structures 132 and 136 in relation to the second conduit structure 134, based on at least partially restricting lateral movement (e.g., movement in a direction perpendicular to the conduit axis 130x) of the first and third conduits 132c and 136c in relation to the second conduit 134c, so as to reduce, minimize, or prevent rotation of the removable pipe proximate end 120a in relation to the vessel 12.

The anti-rotation assembly 130 may include a fourth conduit structure 138 which is connected (e.g., directly or indirectly connected, fixed, etc.) to the vessel 12 (e.g., the vessel body 12a), for example via any known means including bonding, welding, based on the fourth conduit structure 138 being integral to the material of the vessel body 12a as a single unitary piece of material, etc. As shown, the fourth conduit structure 138 may be defined by one or more pieces of material; for example, the second conduit structure 134 may include a single block of material. The fourth conduit structure 138 may have one or more inner surfaces 138s defining a fourth conduit 138c that extends along a longitudinal axis 138x at least partially through the fourth conduit structure 138 from a top opening 138a. As shown, the fourth conduit structure 138 may define the fourth conduit 138c to extend through an entire thickness of the fourth conduit structure 138 between a top opening 138a and a bottom opening 138b, but example embodiments are not limited thereto. The fourth conduit structure 138 may be vertically offset and vertically aligned with the second conduit structure 134 so that the second and fourth conduits 134c and 138c are vertically aligned with each other (e.g., the respective longitudinal axes 134x and 138x of the second and fourth conduits 134c and 138c may be coaxial to at least partially define the conduit axis 130x). As shown in FIGS. 6A to 6C, the third conduit structure 136 may be positioned to be at least partially between the second and fourth conduit structures 134 and 138 along the conduit axis 130x, based on the removable pipe 120 being detachably connected to the fixed pipe 110 via the bayonet connection 102 and further based on the vessel internal piping 30 being connected (e.g., detachably connected) to the removable pipe 120 at the removable pipe distal end 120b, so that the third conduit 136c may be aligned between the second and fourth conduits 134c and 138c along the conduit axis 130x, and thus to align (e.g., overlap along conduit axis 130x) the first to fourth conduits 132c, 134c, 136c, and 138c. As shown in FIGS. 6A to 6C, the third conduit structure 136 may be moved to be positioned at least partially between the second and fourth conduit structures 134 and 138, and to align the third conduit 136c between the second and fourth conduits 134c and 138c, based on the vessel internal piping 30 being axially moved 602 into axial engagement with the removable pipe distal end 120b while the third conduit structure 136 is azimuthally offset from the conduit axis 130x extending through (e.g., at least partially defined by) at least the second and fourth conduits 134c and 138c. Based on the vessel internal piping 30 being connected with the removable pipe distal end 120b, the vessel internal piping 30 may be rotated 604 around its respective longitudinal axis to azimuthally move the third conduit structure 136 to be positioned at least partially between the second and fourth conduit structures 134 and 138 to align the third conduit 136c between the second and fourth conduits 134c and 138c along the conduit axis 130x. It will be understood that each of the first to fourth conduit structures 132 to 138 as described herein may be interchangeably referred to as a block, retaining block, or the like.

As shown, the first to fourth conduit structures 132, 134, 136, and 138 may be aligned with each other to align the first to fourth conduits 132c, 134c, 136c, and 138c to collectively at least partially define the collective conduit 130c extending along the conduit axis 130x, and the pin shaft 140a may be inserted into the collective conduit 130c to extend through each of the first to fourth conduits 132c, 134c, 136c, and 138c to reduce, minimize, or prevent lateral movement of the first and third conduit structures 132 and 136 in relation to the second and fourth conduit structures 134 and 138, based on at least partially limiting lateral movement (e.g., in any direction perpendicular to the conduit axis 130x) of the first and third conduits 132c and 136c in relation to the second and fourth conduits 134c and 138c, so as to reduce, minimize, or prevent rotation of the removable pipe proximate end 120a in relation to the vessel 12 and/or the fixed pipe 110.

In some example embodiments, the first conduit structure 132 may include a bottom inner surface 132bs defining a bottom end 132b of the first conduit 132c within the first conduit structure 132, such that the first conduit structure 132 defines the first conduit 132c to extend through a limited portion of the first conduit structure 132 from the top opening 132a to a bottom end 132b of the first conduit 132c that is defined by the bottom inner surface 132bs of the first conduit structure 132. In some example embodiments, where the pin shaft 140a of the retainer pin 140 extends through at least the first and second conduits 132c and 134c, the first conduit structure 132 may structurally support a distal end 140bs of the retainer pin 140 (e.g., a distal end of the pin shaft 140a) at the bottom end 132b of the first conduit 132c (e.g., at the bottom inner surface 132bs of the first conduit structure 132), so that the retainer pin 140 may “rest” on the bottom inner surface 132bs defining the bottom end 132b of the first conduit 132c.

In some example embodiments, the retainer pin 140 may include a pin head 140b on the proximate end of the pin shaft 140a, where the pin head 140b may be wider than the pin shaft 140a and may be configured to rest upon the upper surface of a conduit structure (e.g., one of the first to fourth conduit structures 132 to 138) to structurally support the retainer pin 140 while the pin shaft 140a is extended through some or all of the collective conduit 130c defined by some or all of the first to fourth conduits 132c, 134c, 136c, and 138c. As shown, in example embodiments where the anti-rotation assembly 130 includes first to fourth conduit structures 132 to 138, the retainer pin 140 may include a pin head 140b that may be configured to rest on an upper surface 138us of the fourth conduit structure 138 based on the pin shaft 140a extending through some or all of the first to fourth conduits 132c to 138c. The retainer pin 140 may rest on the upper surface of a conduit structure (e.g., upper surface 138us) instead of resting on a bottom inner surface 132bs of the first conduit structure 132, but example embodiments are not limited thereto, and in some example embodiments the retainer pin 140 may rest on both the upper surface of a conduit structure (e.g., upper surface 138us) and a bottom inner surface 132bs of the first conduit structure 132.

Based on the retainer pin 140 being structurally supported on one or more surfaces of one or more conduits (e.g., the bottom inner surface 132bs of the first conduit structure 132, the upper surface 138us of the fourth conduit structure 138, or any combination thereof), the anti-rotation assembly 130 may be configured to reduce, minimize, or prevent the likelihood that the retainer pin 140 may inadvertently move out of at least the first conduit 132c during operation of the process unit 10 (e.g., due to vibration of the process unit 10 and/or due to vibrations induced by fluid 26 flowing around the outer surface 120os of the removable pipe 120 in the vessel interior 12v during operation of the process unit 10).

In some example embodiments, the top end of the collective conduit 130c (e.g., the top opening 138a of the fourth conduit 138c at the upper surface 138us as shown in FIGS. 1C, 6A, and 6C, may be at a relatively small third vertical distance 194 from the vessel body top opening 12au, such that the retainer pin 140 may be easily inserted or removed from the top end of the collective conduit 130c via direct manual manipulation of the retainer pin 140 by an operator at the top opening 12au. As a result, the anti-rotation assembly 130 may be configured to enable the retainer pin 140 to be inserted into the collective conduit 130c from a location proximate to the vessel body top opening 12au, so that the retainer pin 140 may be easily manually inserted into or removed from the collective conduit 130c (e.g., inserted into or removed from the first to fourth conduits 132c to 138c) by an operator at the top of the vessel body 12a to at least partially restrict movement of the azimuthal orientation 120z of at least the removable pipe proximate end 120a (which may include the azimuthal orientation of the entire removable pipe 120), and thus at least partially restricting movement of the removable pipe 120 in relation to the vessel body 12a and/or the fixed pipe 110, without complex tooling and to remotely control the azimuthal orientation 120z at a relatively great first vertical distance 190 beneath the top opening 12au in the arcuate space 90 (and potentially submerged beneath a fluid surface 26s of fluid 26 in the vessel interior 12v as shown).

The azimuthal orientation 120z of at least a removable pipe proximate end 120a (e.g., the azimuthal orientation of the entire removable pipe 120) that is relatively distant from the top opening 12au in the arcuate space 90 may be at least partially restricted from moving in relation to a fixed direction (e.g., DV, 130x, etc.) based on enabling direct (e.g., manual) manipulation of a retainer pin from a location that is distant from the bayonet connection 102 and is instead proximate to the top opening 12au (e.g., at a third vertical distance 194 which may be smaller than the first vertical distance 190), for example where the third vertical distance 194 is about 2 inches and the first vertical distance 190 is about 5 feet. Thereby, control of the azimuthal orientation 120z of at least the removable pipe proximate end 120a at the first vertical distance 190 based on remotely manipulating a portion of the anti-rotation assembly 130 (e.g., retainer pin) at the bayonet connection 102 at the first vertical distance 190, and potentially submerged deep under the fluid surface 26s, may be precluded, thereby reducing, minimizing, or precluding risks and complexities associated with remotely manipulating the portion of the anti-rotation assembly 130 (e.g., retainer pin), including complex tooling to remotely manipulate a retainer pin to be inserted into or removed from one or more conduits at the first vertical distance 190 of the bayonet connection 102, difficulties of remotely manipulate a retainer pin to be inserted into or removed from one or more conduits at the first vertical distance 190 even with the benefit of tooling, and risks of foreign material within the vessel interior 12v associated with attempts to engage or disengage the anti-rotation assembly 130 (e.g., dropping the retainer pin being remotely manipulated at the first vertical distance 190).

It will be understood that, in some example embodiments, the retainer pin 140 may omit the pin head 140b and may be at least partially defined by pin shaft 140a. It will be understood that in some example embodiments the retainer pin 140 may be entirely submerged within the fluid 26 in the vessel interior 12v when fully inserted into the collectively conduit, but the top end of the retainer pin 140 (e.g., the pin head 140b as shown in FIGS. 1A, 1C, and 6C) may be sufficiently proximate to the top opening 12au (e.g., at a fourth vertical distance 196 below the top opening 12au, which may be greater or smaller than the third vertical distance 194) to enable an operator to directly (e.g., manually) manipulate the retainer pin 140 to insert the retainer pin 140 into the collective conduit 130c or remove the retainer pin 140 therefrom with reduced or minimal interaction with fluid 26 in the vessel interior.

Still referring to FIGS. 1C to 1D and 6A to 6C, the pipe connection assembly 100 may include a retaining element 142 which may be configured to engage the retainer pin 140 to at least partially restrict (e.g., at least partially limit, at least partially inhibit, at least partially arrest, at least partially fix, etc.) axial movement of the retainer pin 140 out of at least one conduit of the anti-rotation assembly 130 (e.g., at least one of the first conduit 132c or the second conduit 134c). In some example embodiments, the retaining element 142 may be a device, structure, block, or the like which may be configured to be moved to engage (e.g., contact) at least a portion of the retainer pin 140 to at least partially restrict the axial movement of the retainer pin 140 along the conduit axis 130x, to thereby at least partially hold the retainer pin 140 in place, in relation to at least the first conduit structure 132 (and in some example embodiments to at least partially hold the retainer pin 140 in place in the collective conduit 130c defined by at least the first and second conduits 132c and 134c). In some example embodiments, the retaining element 142 may be directly connected to a vessel head 12b of the vessel 12 independently of the vessel body 12a. For example, in some example embodiments, including the example embodiments shown in FIGS. 1C to 1D and 6A to 6C, where the anti-rotation assembly 130 includes first to fourth conduit structures 132 to 138, and the pin head 140b is proximate to the vessel body top opening 12au based on the pin shaft 140a being inserted through the first to fourth conduits 132c to 138c, the retaining element 142 may include a structure (e.g., a block) that is connected (e.g., directly connected) to the underside 12bs of the vessel head 12b and may be configured to approach or to engage (e.g., contact) the pin head 140b based on the vessel head 12b being coupled to the vessel body 12a to close the vessel interior 12v, to thereby at least partially limit axial movement the retainer pin 140 along the conduit axis 130x and thus to at least partially prevent the retainer pin 140 from moving along the conduit axis 130x out of at least one conduit defining the collective conduit 130c (e.g., at least one of the first conduit 132c or the second conduit 134c).

It will be understood that example embodiments of the retaining element 142 are not limited to a structure (e.g., disc) that is connected (e.g., directly or indirectly connected, attached, etc.) to the vessel head 12b. For example, the retaining element 142 may include any device which may be configured to engage at least a portion of the retainer pin 140 to at least partially restrict axial movement of the retainer pin 140 along the conduit axis 130x in relation to at least one conduit defining the collective conduit 130c (e.g., at least one of the first conduit 132c or the second conduit 134c) when the retainer pin 140 is at least partially inserted through the collective conduit 130c to extend through at least a portion of both the first and second conduits 132c and 134c. For example, the retaining element 142 may include a latch structure or fastener configured to engage the retainer pin 140 based on the pin shaft 140a being inserted through the collective conduit 130c to extend at least partially into the first conduit 132c, a separate pin (including for example a cotter pin) which may be configured to be inserted through a corresponding hole or conduit extending transversely through at least the retainer pin 140 (e.g., between vertically adjacent conduit structures or through a conduit extending through at least a portion of a conduit structure of the first to fourth conduit structures 132 to 138 into a respective conduit of the conduit structure, etc.) to restrict, limit, arrest, prevent, etc. axial movement of the retainer pin 140 along the conduit axis 130x based on the pin shaft 140a being inserted through the collective conduit 130c to extend at least partially into the first conduit 132c, or the like.

In some example embodiments, the weight of the retainer pin 140 (e.g., the weight of at least the pin shaft 140a) may reduce, minimize, or prevent the likelihood of the retainer pin 140 exiting at least one conduit (e.g., at least one of the first conduit 132c or the second conduit 134c) due to operation of the process unit 10 (e.g., operation-induced vibrations of the pipe connection assembly 100 and/or fluid flow induced vibrations of the pipe connection assembly 100). In some example embodiments, the retaining element 142 may be configured to at least partially restrict (e.g., at least partially limit, inhibit, etc.) relative movement of the retainer pin 140 along the conduit axis 130x in relation to at least one conduit at least partially defining the collective conduit 130c (e.g., the first conduit 132c) to reduce, minimize, or prevent rotation 402 of at least the removable pipe proximate end 120a in relation to the vessel body 12a and/or the fixed pipe 110 and thus to reduce, minimize, or prevent the likelihood of the retainer pin 140 exiting at least the first conduit 132c due to operation of the process unit 10 (e.g., operation-induced vibrations of the pipe connection assembly 100 and/or due fluid flow induced vibrations of the pipe connection assembly 100).

While example embodiments shown in FIGS. 1A to 6C illustrate an anti-rotation assembly 130 including first to fourth conduit structures 132 to 138 defining respective first to fourth conduits 132c to 138c, where the first conduit structure 132 is connected to the removable pipe 120, the second and fourth conduit structures 134 and 138 are connected to the vessel body 12a, and the third conduit structure 136 is connected to a vessel internal piping 30, and where a retainer pin 140 may extend through a collective conduit 130c collectively defined by the first to fourth conduits 132c to 138c to rest on at least one of a bottom end 132b of the first conduit 132c or a upper surface 138us of the fourth conduit structure 138, and further secured in the collective conduit 130c by a retaining element 142, example embodiments are not limited thereto. For example, one or more of the elements of the anti-rotation assembly 130 as shown in FIGS. 1A to 6C, including for example the third and fourth conduit structures 136 and 138, may be omitted from the anti-rotation assembly 130. In another example, the first conduit 132c may extend through an entire thickness of the first conduit structure 132 between opposite top and bottom openings, such that a pin shaft 140a may be inserted through the entire first conduit 132c and out through the bottom end 132b or top opening 132a to thus extend through the entire thickness of the first conduit structure 132. In another example, the retainer pin 140 may be omitted, and the first conduit structure 132 may be connected to the vessel body 12a via a connector, fastener, or the like.

Based on reducing, minimizing, or preventing such rotation 402, the anti-rotation assembly 130 may reduce, minimize, or prevent the likelihood of the bayonet connection 102 being inadvertently disconnected during operation of the process unit 10, thereby reducing the likelihood of potential process faults, damage to devices in the vessel interior 12v due to removable pipe 120 becoming disconnected from the fixed pipe 110 during operation of the process assembly, or the like, thereby improving the reliability of the process unit 10 itself.

Referring now to FIGS. 2A to 6C and as further shown in FIG. 7A, a method S700 of configuring a vessel to include a pipe connection assembly 100 may include providing a vessel body 12a including a fixed pipe 110, the vessel body 12a including one or more vessel body sidewall inner surfaces 12as at least partially defining a vessel interior 12v, the fixed pipe extending through a vessel body sidewall thickness 12at of the vessel body 12a to a fixed pipe proximate end 110a, the fixed pipe proximate end 110a open to the vessel interior 12v and fixed in relation to the vessel body 12a, the fixed pipe 110 including a first pipe connector 112 at the fixed pipe proximate end 110a. The method may include detachably connecting a removable pipe 120 within the vessel interior 12v with the fixed pipe 110 via a bayonet connection 102, the removable pipe 120 extending between a removable pipe proximate end 120a and a removable pipe distal end 120b, the removable pipe including a second pipe connector 122 at the removable pipe proximate end 120a, the first and second pipe connectors 112 and 122 collectively defining the bayonet connection 102. The method may include connecting the removable pipe 120 to at least a portion of the vessel body 12a independently of the bayonet connection 102 and/or independently of the fixed pipe 110 to at least partially restrict movement of an azimuthal orientation 120z of at least the removable pipe proximate end 120a, and thus at least partially restrict movement of the removable pipe 120, in relation to the vessel body 12a independently of the bayonet connection 102 and/or independently of the fixed pipe 110, based on the removable pipe being detachably connected with the fixed pipe 110 via the bayonet connection 102.

While some example embodiments, including the example embodiments shown in FIGS. 1A to 6C, show a pipe connection assembly 100 which includes at least a first conduit structure 132 that defines a first conduit 132c and which is connected (e.g., directly or indirectly connected, fixed, etc.) to the removable pipe 120, example embodiments are not limited thereto. For example, in some example embodiments the first conduit structure 132 may be omitted, such that the anti-rotation assembly 130 includes the third conduit structure 136 connected to the vessel internal piping 30 and at least one or both of the second and fourth conduit structures 134 and 138, such that at least the third conduit 136c and at least one of both of the second and fourth conduits 134c and 138c define the collective conduit 130c, and the retainer pin 140 that is inserted into the collective conduit 130c may at least partially limit movement of the azimuthal orientation 120z of at least the removable pipe proximate end 120a, and thus at least partially restrict movement of the removable pipe 120, based on at least partially limiting movement (in a directly perpendicular to the conduit axis 130x) of the third conduit structure 136 and thus the vessel internal piping 30 that is connected to the removable pipe 120.

As described herein, properties, characteristics, and operations relating to the removeable pipe proximate end 120a may apply equally to the removable pipe 120 as a whole. For example, the azimuthal orientation 120z of the removable pipe proximate end 120a may be referred to interchangeably as an azimuthal orientation of the removable pipe 120 as a whole, axial movement 302 of the removable pipe proximate end 120a may be referred to interchangeably as axial movement of the removable pipe 120 as a whole, and rotation 402 of the removable pipe proximate end 120a around a central axis (e.g., at last one of central axis 200x, 120x, or 110x) may be referred to interchangeably as rotation of the removable pipe 120 around the central axis. Similarly, properties, characteristics, and operations relating to the fixed pipe proximate end 110a may apply equally to the fixed pipe 110 as a whole.

In some example embodiments, the fixed pipe 110, removable pipe 120, conduit structures 132 to 138, retainer pin 140, or any combination thereof may comprise one or more metal materials, including for example stainless steel. However, example embodiments are not limited thereto, and in some example embodiments one or more of the fixed pipe 110, removable pipe 120, one or more conduit structures 132 to 138, or the retainer pin 140 may independently comprise any known structural material, including any known piping material, including for example any known metal or plastic material, including for example stainless steel, carbon steel, a polymer including for example polyvinyl chloride (PVC), or the like.

FIG. 7A is a flowchart illustrating a method S700 of configuring a process unit that includes a vessel to complete a pipe connection assembly, according to some example embodiments. The method S700 shown in FIG. 7A may be performed with regard to any of the example embodiments of a pipe connection assembly as described herein, including any of the example embodiments shown in FIGS. 1A-1F, 2A-2D, 3A-3B, 4A-4B, 5A-5B, 6A-6C, 8, 9, or any combination thereof. It will be understood that operations of the method S700 as shown in FIG. 7A may be rearranged relative to what is shown in FIG. 7A. One or more operations may be added to the method S700 relative to what is shown in FIG. 7A. One or more operations shown in FIG. 7A may be omitted from the method S700.

Referring first to at least FIGS. 1C, 2A to 2D and 7A, at S701, the method S700 may include moving one or more removable devices, including for example one or more vessel internal process components 14 (e.g., upper vessel internal process component 18) into the vessel interior 12v at least partially defined by the vessel body sidewall inner surface 12as to at least partially define an arcuate space 90 within the vessel interior 12v. The arcuate space 90 may be defined as an at least partially annular space extending at least partially azimuthally around one or more outer surfaces of the one or more vessel internal process components 14 (e.g., one or more outer surfaces 18s of the upper vessel internal process component 18) and further defined radially and axially between the one or more outer surfaces of the one or more vessel internal process components 14 and vessel body sidewall inner surfaces 12as of the vessel body 12a. For example, referring to FIGS. 1A-1C, in example embodiments where the vessel 12 is a pressure vessel comprising an open-topped cylindrical vessel body 12a having a top opening 12au to be closed (covered) by a separate vessel head 12b, one or more vessel internal process components 14 such as a steam separator, a steam dryer, or the like (where the steam dryer may be an upper vessel internal process component 18) may be lowered into place within the vessel interior 12v through the top opening 12au. As shown in at least FIGS. 1B and 1C, such one or more removable vessel internal process components (e.g., an upper vessel internal process component 18) may at least partially define an arcuate space 90 within the vessel interior 12v between one or more outer surfaces of the one or more vessel internal process components 14 (e.g., outer surfaces 18s of the upper vessel internal process component 18) and one or more vessel body sidewall inner surfaces 12as of the vessel body 12a. As shown, the arcuate space 90 may be an annular space extending azimuthally around the one or more vessel internal process components 14 and between the one or more vessel internal process components 14 and the vessel body 12a. As further shown, the arcuate space 90 may have a relatively small radial clearance 90d, or clearance in the radial direction between an outer surface 18s of the upper vessel internal process component 18 and a vessel body sidewall inner surface 12as of the vessel body 12a.

As further shown in FIGS. 1A-1D, and 2A, a fixed pipe 110 may be coupled (e.g., welded, bolted, fastened, or the like) to the vessel body 12a to cause the fixed pipe 110 to extend (“penetrate”) through a sidewall thickness 12at of the vessel body 12a such that a fixed pipe proximate end 110a of the fixed pipe 110 is open to the vessel interior 12v and is fixed in relation to the vessel body 12a. As shown, the fixed pipe 110 may include a first pipe connector 112 at the fixed pipe proximate end 110a. As shown, the first pipe connector 112 may include (e.g., may define) a socket 214 having a length corresponding to (e.g., equaling) the insertion depth 224id (which may be defined between the fixed pipe proximate end 110a and an inner seal/stop structure 184) and a lug pipe connector 210 comprising one or more lugs 212 extending radially in relation to (e.g., towards, from one or more inner surfaces 110is) the central axis 110x of the fixed pipe proximate end 110a which is also the central axis of the first pipe connector 112 and which may also extend axially, in parallel to the central axis of the first pipe connector 112 (e.g., central axis 110x). As shown, the fixed pipe proximate end 110a may be submerged under a fluid surface 26s of fluid 26 (e.g., feedwater) within the vessel interior 12v.

Referring to FIGS. 2A to 2D and 7A, at S702, the method S700 may include lowering 290 the removable pipe 120 in a vertical direction DV (which may be a direction parallel to the direction of gravity, the conduit axis 130x as described herein, or the like) into the arcuate space 90 to align (e.g., overlap) the removable pipe proximate end 120a of the removable pipe 120 with the fixed pipe proximate end 110a of the fixed pipe 110 penetrating through the vessel body sidewall thickness 12at to be exposed to the vessel interior 12v (e.g., the arcuate space 90) through the vessel body sidewall inner surface 12as. Aligning the removable pipe proximate end 120a with the fixed pipe proximate end 110a may include causing the central axis 120x of the removable pipe proximate end 120a to align (e.g., overlap, extend coaxially) with the central axis 110x of the fixed pipe proximate end 110a. As shown, such lowering 290 may include lowering at least the removable pipe proximate end 120a of the removable pipe 120 to be submerged under a fluid surface 26s of fluid 26 (e.g., feedwater) within the vessel interior 12v. The lowering 290 may include lowering the removable pipe 120 into the arcuate space 90 in the vertical direction DV while offset from the central axis 110x of the fixed pipe proximate end 110a in a direction perpendicular to both the vertical direction DV and the axial direction DA, so as to avoid contact between the removable pipe proximate end 110a and at least the second conduit structure 134 (and in some example embodiments with the fourth conduit structure 138), and subsequently moving the removable pipe 120 to align the central axis 120x of the removable pipe proximate end 120a with the central axis 110x of the fixed pipe proximate end 110a based on at least the removable pipe proximate end 120a being lowered beneath the second conduit structure 134 in the vertical direction DV.

As shown in at least FIGS. 2A to 2D and 7A, at S702, the method S700 may include moving the removable pipe 120 to be aligned with the fixed pipe 110 at an azimuthal orientation 120z extending at an angle 120r from the vertical direction DV so as to align (e.g., overlap in an axial direction DA parallel to the central axis 200x) the axial notch openings 222o of the notches 222 of the notch pipe connector 220 defined by the second pipe connector 122 with separate, respective (e.g., corresponding) lugs 212 of the lug pipe connector 210 defined by the first pipe connector 112. As shown in FIGS. 2B to 2D, the azimuthal orientation 120z of the removable pipe proximate end 120a may be at a particular angle 120r from the vertical direction DV based on the lugs 212 being aligned (e.g., overlapped) with separate, respective axial notch openings 222o in an axial direction DA parallel to the central axis 200x (e.g., 110x and/or 120x). Such a particular angle 120r when the lugs 212 being aligned (e.g., overlapped) with separate, respective axial notch openings 222o in the axial direction DA, as shown in FIGS. 2A to 2D, may be, for example, between about 10 degrees to about 20 degrees, about 10 degrees to about 30 degrees, or about 10 degrees to about 45 degrees, although example embodiments are not limited thereto.

At S704, and as shown for example in FIGS. 2A-5B and 7A, the method S700 may include detachably connecting the removable pipe 120 within the vessel interior 12v (e.g., within the arcuate space 90) with the fixed pipe 110 via a bayonet connection 102. Such detachable connection of the removable pipe 120 with the fixed pipe 110 at S704 may include moving 302 the removable pipe proximate end 120a towards the fixed pipe proximate end 110a in an axial direction DA at S706 to cause one or more lugs 212 of the lug pipe connector 210 (defined by one of the first pipe connector 112 or the second pipe connector 122) to be inserted into separate, respective notches 222 of the notch pipe connector 220 (defined by another of the first pipe connector 112 or the second pipe connector 122) via separate, respective axial notch openings 222o in the axial direction DA (where the axial direction DA may be parallel to a central axis 120x of the removable pipe proximate end 120a), and to cause the plug 224 (defined by one of the first pipe connector 112 or the second pipe connector 122) to be at least partially inserted into the socket 214 (defined by another one of the first pipe connector 112 or the second pipe connector 122) in the axial direction DA. The detachable connection of the removable pipe 120 with the fixed pipe 110 at S704 may include rotating 402 at least the removable pipe proximate end 120a around the central axis 120x of the removable pipe proximate end 120a in relation to the fixed pipe proximate end 110a at S708 to cause azimuthal movement 404 of the notch pipe connector 220 in relation to the lug pipe connector 210 (also referred to herein interchangeably as azimuthal engagement of the notch pipe connector 220 and the lug pipe connector 210) concurrently with the plug 224 being at least partially inserted into the socket 214. Moving 302 the removable pipe 120 may be referred to herein interchangeably as axially moving the removable pipe 120 towards the fixed pipe 110 and/or the vessel body sidewall inner surface 12as. Rotation 402 of at least the removable pipe proximate end 120a around the central axis 120x may be referred to herein interchangeably as rotation 402 of the removable pipe 120 around a central axis 200x that may include at least one of the central axis 110x or the central axis 120x.

Referring to FIGS. 3A to 3B and 7A, at S706 the detachable connection S704 may include axially moving 302 the removable pipe proximate end 120a, in an axial direction DA that is parallel with a central axis 200x, that is at least one of the central axis 120x of the removable pipe proximate end 120a or the central axis 110x of the fixed pipe proximate end 110a, towards at least the fixed pipe proximate end 110a of the fixed pipe 110, to cause the one or more lugs 212 to be inserted into separate, respective notches 222 of notch pipe connector 220 via separate, respective axial notch openings 222o in the axial direction DA while remaining aligned with the respective axial notch openings 222o in the axial direction DA, and to cause the plug 224 to be at least partially inserted into the socket 214 in the axial direction DA. As shown, the central axis 110x of the fixed pipe proximate end 110a of the fixed pipe 110 may be extending in the axial direction DA, and the central axes 120x and 110x may be aligned (e.g., coaxial) with each other so that both of the central axis 120x and 110x may extend in the axial direction DA based on the removable pipe proximate end 120a being aligned with the fixed pipe proximate end 110a to align the lugs 212 with separate, respective axial notch openings 222o in the axial direction DA.

As shown, the removable pipe 120 may be oriented so that the axial notch opening 222o of each notch 222 align (e.g., overlap) with a respective lug 212 in the axial direction DA. As further shown in FIGS. 3A and 3B, the removable pipe 120 may be moved 302 in the axial direction DA while maintaining the alignment of the axial notch openings 222o with separate, respective lugs 212 in the axial direction DA so that the removable pipe proximate end 120a moves in the altitudinal direction DA towards the lugs 212, such that the lugs 212 may each be received into a separate, respective notch 222 via a respective axial notch opening 222o and to further move axially through the axial notch section 222a of the respective notch 222. As further shown, the movement 302 in the axial direction DA (referred to herein interchangeably as axial movement) of the removable pipe proximate end 120a towards the fixed pipe proximate end 110a, where the first pipe connector 112 defines a socket 214 and the second pipe connector 122 defines a plug 224, may cause the removable pipe proximate end 120a to be inserted into the conduit 110c of the fixed pipe 110 at the fixed pipe proximate end 110a which defines the socket 214, to cause axial sliding engagement (e.g., sliding contact) between the first and second pipe connectors 112 and 122, for example between the opposing surfaces 120os and 110is of the removable pipe 120 and the fixed pipe 110 defining the outer surface 224os of the plug 224 and the inner surface 214is of the socket 214, respectively. Such axial sliding engagement may be referred to herein as socket engagement 306.

In some example embodiments, the moving 302 of the removable pipe 120 in the axial direction DA may proceed through an axial notch section 222a of a corresponding notch 222 into which the lug 212 is inserted or received until an axial end surface 212rs of one or more lugs 212 engage (e.g., contact) an axial end surface 222rs of the corresponding notch 222, through the full axial length 222L of the axial notch section 222a. However, example embodiments are not limited thereto, and in some example embodiments the movement 302 may proceed until the lugs 212 reach a chamfer notch section 222c of the corresponding notches 222.

As shown in FIGS. 3A-3B, the removable pipe proximate end 120a may be moved 302 in the axial direction DA to cause axial sliding engagement between the notch and lug pipe connectors 220 and 210 and to further cause the plug 224 to at least partially overlap the socket 214 in a radial direction extending perpendicular to the axial direction DA (e.g., in the vertical direction DV, the direction of the azimuthal orientation 120z, or the like) to establish socket engagement 306 between the first and second pipe connectors 112 and 122.

Referring to FIGS. 4A-4B, 5A-5B, and 7A, at S708 the detachable connection S704 may include, for example subsequent to the axial movement 302 at S704 to insert the plug 224 into the socket 214 and to cause lugs 212 of the lug pipe connector 210 to be inserted or received into separate, respective notches 222 of the notch pipe connector 220, rotating 402 at least the removable pipe proximate end 120a (e.g., rotating the entire removable pipe 120) around the central axis 200x, including at least one of the central axis 120x of the removable pipe proximate end 120a or the central axis 110x of the fixed pipe proximate end 110a, in relation to the fixed pipe proximate end 110a, to cause azimuthal movement 404 and thus azimuthal sliding engagement 406 between the first and second pipe connectors 112 and 122 (e.g., between opposing, engaged or contacting surfaces of the socket 214 and plug 224, the lugs 212 and the notches 222, or the like) while maintaining socket engagement 306 between the first and second pipe connectors 112 and 122 (e.g., between opposing, engaged or contacting surfaces of the socket 214 and plug 224). As shown, a torque 401 may be applied to the removable pipe 120, for example at the removable pipe distal end 120b based on manipulation of the removable pipe distal end 120b by at least one of a tool or an operator reaching into the vessel interior 12v from the vessel body top opening 12au, to induce the rotation 402 of at least the removable pipe proximate end 120a around the central axis 200x (e.g., 120x and/or 110x) and further causing relative azimuthal movement 404 (e.g., azimuthal engagement) of the notches 222 and corresponding lugs 212 at least partially located therein. As shown, the azimuthal movement 404 due to the rotation 402 may include relative azimuthal movement of each lug 212 through a corresponding azimuthal notch section 222b of the respective notch 222 in which the lug 212 is located, for example to cause the lug 212 to move from the axial notch section 222a of the respective notch 222 and through the azimuthal notch section 222b until an axial end surface 212bs of the lug 212 contacts an opposing azimuthal end surface 222bs of the notch 222. The azimuthal end surface 222bs may be an inner surface 222s of the notch 222 that at least partially defines an end of the azimuthal notch section 222b opposite the axial notch section 222a. The magnitude of the rotation 402 of at least the removable pipe proximate end 120a at S708 (for example, rotation of the entire removable pipe 120) to cause the lugs 212 to move from an axial notch section 222a of a respective notch 222 (e.g., to move from being aligned with an axial notch opening 222o of the respective notch 222) to engagement with an azimuthal end surface 222bs of the respective notch 222, also referred to herein as turning or rotating the removable pipe 120 to latch the lugs 212 into place, may be a magnitude that is equal or substantially equal to the angle 120r of the azimuthal orientation 120z from the vertical direction DV when the lugs 212 are aligned with the axial notch openings 222o of the respective notches 222 as shown in at least FIGS. 3A and 3B. For example, the magnitude of the rotation 402 to rotate (e.g., “turn”) the removable pipe 120 around the central axis 120x and/or the central axis 110x from the position where the lugs 212 are aligned in the axial direction DA with axial notch openings 222o in respective notches 222 as shown in at least FIGS. 3A and 3B to the position in relation to the fixed pipe 110 where the lugs 212 engage azimuthal end surfaces 222bs of respective notches 222 as shown in FIGS. 5A and 5B and further shown in FIGS. 1C to 1F may be, for example, between about 10 degrees to about 20 degrees, about 10 degrees to about 30 degrees, or about 10 degrees to about 45 degrees, although example embodiments are not limited thereto.

As further shown, in example embodiments where the notch pipe connector 220 includes a chamfer notch section 222c (or “ramp”), the rotation 402, which may be implemented based on at least one of an operator or tool exerting a torque 401 on the removable pipe distal end 120b, may cause both the azimuthal movement 404 of the notches 222 in relation to the corresponding lugs 212 and additional axial movement 302 of the notches 222 in relation to the corresponding lugs 212 to assist in completing the axial engagement of the first and second pipe connectors 112 and 122 (e.g., socket engagement 306 of the socket 214 and the plug 224) with minimal translation force exerted on the removable pipe 120 (e.g., at the removable pipe distal end 120b) to induce further axial movement 302. Completion of the axial engagement may include causing the removable pipe 120 to move axially to engage one or more outer seal/stop structures 182 between the fixed pipe 110 and the removable pipe 120, one or more inner seal/stop structures 184 between the fixed pipe 110 and the removable pipe 120, or any combination thereof. Completion of the axial engagement may include causing the removable pipe 120 to move axially to cause axial engagement between axial end surfaces 212rs of the lugs 212 and opposing axial end surfaces 222rs of corresponding notches 222 in which the lugs 212 are inserted or received.

As shown in FIGS. 4B and 5B, the torque 401 may be applied concurrently with a force being applied on the removable pipe 120 to cause the axial movement 302 of the removable pipe proximate end 120a towards the fixed pipe proximate end 110a. As shown in FIGS. 3A and 3B, azimuthal movement 404 of the notches 222 in relation to the lugs 212 may be resisted based on contact between the lugs 212 and axial side surfaces 222as of the corresponding notches 222 while the lugs 212 are located in the axial notch sections 222a of the slots. As shown in FIGS. 4A-4B and 5A-5B, once the removable pipe 120 is moved 302 axially sufficiently towards the fixed pipe 110 as to cause the lugs 212 to move through the distal end of the axial notch section 222a and into at least one of the azimuthal notch section 222b or the chamfer notch section 222c, the resistance to rotation 402 by the lug/slot contact may partially or entirely cease, and the torque 401 may cause rotation 402 of at least the removable pipe proximate end 120a (e.g., rotation 402 of the entire removable pipe 120) around the central axis 120x and/or 110x (e.g., central axis 200x), such that the relative azimuthal movement 404 occurs to cause the lugs 212 to move at least partially azimuthally in relation to the respective notches 222 in which the lugs 212 are located. The lugs 212 may move azimuthally through the respective azimuthal notch sections 222b until one or more of the lugs 212 contacts an azimuthal end surface 222bs of the respective notch 222 in which the one or more lugs 212 is located, which may arrest further azimuthal movement 404 and thus arrest the rotation 402.

As shown in FIGS. 4A-4B and 5A-5B, the rotating 402 may cause the azimuthal orientation 120z of the removable pipe 120 to change in relation to the vertical direction DV (e.g., to cause the angle 120r therebetween to be reduced in magnitude) until one or more lugs 212 engage an azimuthal end surface 222bs of a corresponding notch 222 to arrest the rotation 402, at which point the azimuthal orientation 120z may align with the vertical direction DV so as to extend in parallel or substantially in parallel with the vertical direction DV and the angle 120r may have a value that is equal or about 0 degrees (e.g., about 0 degrees to about 5 degrees, about 0 degrees to about 2 degrees, about 0 degrees to about 1 degree, about 0 degrees to about 0.5 degrees, etc., although example embodiments are not limited thereto). As a result, based on the azimuthal orientation 120z being changed to align with the vertical direction DV due to the rotation 402, the first conduit 132c of the first conduit structure 132 connected to the removable pipe 120 may be moved due to the rotation 402 to be aligned (e.g., overlapped) with at least a corresponding second conduit 134c of a second conduit structure 134 that is connected to the vessel body 12a (e.g., directly connected to vessel body sidewall inner surface 12as), for example to cause the longitudinal axis 132x of the first conduit 132c to extend in parallel (e.g., coaxial) with the longitudinal axis 134x of the second conduit 134c (which may define the conduit axis 130x).

As shown, the axial movement at S706 and the azimuthal movement at S708 of at least the removable pipe proximate end 120a (e.g., the entire removable pipe) in relation to at least the fixed pipe proximate end 110a (e.g., in relation to the fixed pipe 110) may engage a bayonet connection between the lugs 212 and corresponding notches 222 (e.g., based on contact between opposing lug and notch side surfaces 212bs and 222bs and/or between opposing lug and notch end surfaces 212rs and 222rs and/or between opposing lug and notch side surfaces 212es and 222es in the azimuthal notch section 222b) and a socket connection between engaged surfaces 214is and 224os, thereby establishing a bayonet connection 102 between the removable pipe 120 and the fixed pipe 110.

As shown in FIGS. 4A-4B and 5A-5B, the pipe connection assembly 100 may include an outer seal/stop structure 182 on an outer surface of the plug 224 (e.g., on outer surface 120os) and/or an inner seal/stop structure 184 on an inner surface of the socket 214 (e.g., on inner surface 110is). The axial movement 302 may be at least partially arrested based on contact between a seal/stop structure (e.g., outer seal/stop structure 182 and/or inner seal/stop structure 184) and a proximate end (e.g., 120a and/or 110a). The axial movement 302 may cause at least partial compression of the outer seal/stop structure 182 and/or the inner seal/stop structure 184 based on contact with a proximate end 120a or 110a. The outer and/or inner seal/stop structures 182 and/or 184 may be a ring-type seal which may be configured to engage the socket 214 (e.g., the fixed pipe proximate end 110a) to at least partially seal an interface 226 between opposing surfaces of the plug 224 and the socket 214 based on the axial movement 302 of the removable pipe 120 in relation to the fixed pipe 110.

Referring to FIGS. 1B to 1D, 6A to 6C, and 7A, at S710 the method S700 may include engaging the anti-rotation assembly 130, based on the removable pipe 120 being detachably connected with the fixed pipe 110 via the bayonet connection 102 at S704, to at least partially restrict (e.g., at least partially limit, inhibit, arrest, fix, etc.) movement of the azimuthal orientation 120z of at least the removable pipe proximate end 120a of the removable pipe 120, and thus to at least partially restrict movement of the removable pipe 120, in relation to the vessel body 12a independently of the bayonet connection 102 and/or independently of the fixed pipe 110. For example, as shown, based on the removable pipe 120 being detachably connected with the fixed pipe 110 via the bayonet connection 102 at S704, the first conduit 132c of the first conduit structure 132 which is connected (e.g., affixed) to the removable pipe 120 may be caused to be aligned with at least the second conduit 134c of the second conduit structure 134 that is connected (e.g., affixed) to the vessel body 12a. Such alignment of the first and second conduits 132c and 134c may include the first and second conduits 132c and 134c overlapping along the conduit axis 130x direction such that the respective longitudinal axes 132x and 134x of the first and second conduits 132c and 134c extend in parallel (or coaxial) to the conduit axis 130x.

As further shown, in example embodiments where vessel internal piping 30 (e.g., a detachable pipe) may be coupled to the removable pipe 120 (e.g., at the removable pipe distal end 120b), and where the vessel internal piping 30 includes a third conduit structure 136 having a third conduit 136c extending therethrough, at S710 the vessel internal piping 30 may be coupled to the removable pipe 120 (e.g., at the removable pipe distal end 120b) to cause the third conduit structure 136 to be positioned in relation to the first and second conduit structures 132 and 134 so that the third conduit 136c is aligned with the first and second conduits 132c and 134c (e.g., such that the longitudinal axis 136x of the third conduit 136c extends in parallel (or coaxial) to the conduit axis 130x. As shown, the anti-rotation assembly 130 may include an additional, fourth conduit structure 138 connected (e.g., affixed) to the vessel body sidewall inner surface 12as, where the fourth conduit structure 138 may have a respective fourth conduit 138c extending therethrough, and the third conduit 136c may be positioned to be between the second and fourth conduit structures 134 and 138 along the vertical direction DV, so that the third conduit 136c may be aligned between the second and fourth conduits 134c and 138c. As a result, the first to fourth conduits 132c, 134c, 136c, and 138c may be aligned (e.g., overlapping) in a direction extending along the conduit axis 130x.

The third conduit structure 136 may be moved to be positioned between the second and fourth conduit structures 134 and 138 based on the vessel internal piping 30 being axially moved 602 into axial engagement with the removable pipe distal end 120b, which may further include engaging the vessel internal piping 30 with an inner seal/stop structure 606 within the removable pipe conduit 120c and/or engaging the removable pipe distal end 120b with an outer seal/stop structure 608 on an outer surface of the vessel internal piping 30, while the third conduit structure 136 (e.g., the longitudinal axis 136x thereof) is at position 600a azimuthally offset 610 (e.g., around the longitudinal axis 30x of the vessel internal piping 30) from the conduit axis 130x extending through at least the second and fourth conduits 134c and 138c. Based on the vessel internal piping 30 being connected with the removable pipe distal end 120b, the vessel internal piping 30 may be rotated 604 around its longitudinal axis 30x to azimuthally move the third conduit structure 136 from position 600a to be positioned at position 600b between the second and fourth conduit structures 134 and 138 to align the third conduit 136c (e.g., the longitudinal axis 136x thereof) between the second and fourth conduits 134c and 138c (e.g., the respective longitudinal axes 134x and 138x thereof). Based on the first to fourth conduits 132c to 138c being aligned along the conduit axis 130x, the first to fourth conduits 132c to 138c may at least partially define a collective conduit 130c extending along the conduit axis 130x and through each of the first to fourth conduits 132c to 138c and therefore extending through the second to fourth conduit structures 134 to 138 and through at least a portion of the first conduit structure 132 (e.g., to the bottom inner surface 132bs thereof which defines a bottom end 132b of the first conduit 132c and therefore defines a bottom of the collective conduit 130c). The azimuthal offset 610 between the longitudinal axis 136x and the conduit axis 130x at the initial axial engagement of the vessel internal piping 30 with the removable pipe 120, and thus the angular displacement of the rotation 604 around the longitudinal axis 30x to align the third conduit 136c with at least one of the second or fourth conduits 134c or 138c may, in some example embodiments, be about 15 degrees to about 30 degrees, although example embodiments are not limited thereto.

As shown in FIGS. 1C and 6C, the vessel internal piping 30 may be partially or entirely submerged beneath the fluid surface 26s of fluid 26 in the vessel interior 12v based on being axially 602 engaged with the removable pipe 120. In some example embodiments, a fifth vertical distance 198 of the uppermost portion (e.g., end 30a) of the vessel internal piping 30 from the top opening 12au, once the vessel internal piping 30 is connected with the removable pipe 120, may be a relatively small distance that is smaller than first and second vertical distances 190 and 192 and may be smaller or greater than the third vertical distance 194 of the fluid surface 26s from the top opening 12au. For example, the magnitude of the fifth vertical distance 198 may be about 1 foot to about 2 feet, about 6 inches to about 1 foot, about 6 inches to about 2 feet, about 1 inch to about 2 feet, about 1 inch to about 1 foot, about 1 inch to about 6 inches, or the like, while the third vertical distance 194 may be about 1 inch to about 2 inches, although example embodiments are not limited thereto. In example embodiments where the fifth vertical distance 198 is relatively small (e.g., about 1 inch to about 2 feet), the axial engagement (due to axial movement 602) and the rotating 604 to align the third conduit 136c with at least one of the second or fourth conduits 134c or 138c may be performed based on direct (e.g., manual) manipulation of the vessel internal piping 30 by an operator (e.g., human operator) at the vessel body top opening 12au, even if the vessel internal piping 30 is partially or entirely submerged below the fluid surface 26s such that the operator reaches through a small amount of fluid 26 to axially move 602 and/or rotate 604 the vessel internal piping 30.

As shown in FIGS. 1A and 1C, a vessel internal fixture 40 may be connected at an interface 40a to the vessel internal piping 30 at an end 30a of the vessel internal piping 30 opposite from the end connected to the removable pipe distal end 120b, so that the vessel internal piping 30 is connected between the removable pipe 120 and the vessel internal fixture 40, and further such that the vessel internal piping 30 may be configured to direct a fluid 26 flowing through the removable pipe distal end 120b through a conduit of the vessel internal piping 30 to the vessel internal fixture 40. The vessel internal fixture 40 may include, for example, a fluid discharge assembly (e.g., a spray head, sparger, nozzle, or the like) configured to discharge the fluid 26 received from the removable pipe 120 (e.g., via the vessel internal piping 30) into the vessel interior 12v, for example via one or more discharge ports 40b which may be in fluid communication with the interface 40a through an interior of the vessel internal fixture 40. While example embodiments show vessel internal piping 30 being connected to the removable pipe distal end 120b and thus between the removable pipe 120 and the vessel internal fixture 40 and including the third conduit structure 136 connected thereto, example embodiments are not limited thereto. For example, in some example embodiments the vessel internal piping 30 is omitted, and the vessel internal fixture 40 is connected to the removable pipe distal end 120b. In some example embodiments the third conduit structure 136 may be connected (e.g., directly or indirectly connected, fixed, etc.) to the vessel internal fixture 40. As shown, the vessel internal fixture 40 may be connected (e.g., directly connected, affixed, etc.) to the vessel head 12b such that the vessel internal fixture 40 may be connected (e.g., axially engaged with) to an end 30a of the vessel internal piping 30 based on the vessel head 12b being lowered onto the top opening 12au and coupled to the vessel body 12a, and the vessel internal fixture 40 may be disconnected (e.g., axially disengaged with) the end 30a of the vessel internal piping 30 based on the vessel head 12b being disconnected from the vessel body 12a and raised off of the top opening 12au and coupled to the vessel body 12a. However, example embodiments are not limited thereto, and in some example embodiments the vessel internal fixture 40 may be connected to one or more structures in the vessel interior 12v independently of the vessel head 12b, and/or and may be isolated from direct contact with the vessel head 12b, such that the vessel internal fixture 40 may remain in the vessel interior 12v and may be connected to and disconnected form the vessel internal piping 30 independently of the vessel head 12b.

As shown at FIGS. 1C, 1D, 6C, and 7A, at S710 the retainer pin 140 may be inserted through the collective conduit 130c, such that the pin shaft 140a extends at least partially through each of at least the first and second conduits 132c and 134c along the conduit axis 130x. In example embodiments where the anti-rotation assembly 130 includes the first to fourth conduit structures 132 to 138 and the first to fourth conduits 132c to 138c are aligned along the conduit axis 130x to at least partially define the collective conduit 130c, the pin shaft 140a may be inserted through the entirety of the fourth conduit structure 138 via the fourth conduit 138c, through the entirety of the third conduit structure 136 via the third conduit 136c, through the entirety of the second conduit structure 134 via the second conduit 134c, and through at least a portion of the first conduit structure 132 via the first conduit 132c.

As shown, in example embodiments where the first conduit 132c extends through a limited portion of the first conduit structure 132 from a top opening 132a to a bottom end 132b defined by a bottom inner surface 132bs of the first conduit structure 132, the distal end 140bs of the pin shaft 140a may be inserted through the collective conduit 130c to rest on the bottom inner surface 132bs of the first conduit structure 132, such that the retainer pin 140 may be structurally supported at the bottom inner surface 132bs, but example embodiments are not limited thereto. As shown, in some example embodiments the retainer pin 140 may include a pin head 140b, which may be shaped as a disc or some other object, which may rest on the upper surface 138us of the fourth conduit structure 138 based on the pin shaft 140a being inserted through the collective conduit 130c. As a result, the retainer pin 140 may be at least partially structurally supported by the upper surface 138us of the fourth conduit structure 138. The pin shaft 140a may be spaced apart from the bottom inner surface 132bs of the first conduit 132c, based on the pin head 140b engaging and resting on the upper surface 138us of the fourth conduit structure 138.

Based on the retainer pin 140 being inserted through the collective conduit 130c, and thus extending at least partially through at least the first and second conduits 132c and 134c (and in some example embodiments further through one or more additional conduits such as the third conduit 136c and/or the fourth conduit 138c), the retainer pin 140 may reduce, minimize, or prevent horizontal movement (e.g., perpendicular to the conduit axis 130x, the vertical direction DV, or the like) of at least the first conduit structure 132 in relation to the second conduit structure 134 (and thus in relation to the vessel body 12a), thereby reducing, minimizing, or preventing azimuthal rotation 402 of the removable pipe 120 to which the first conduit structure 132 is connected in relation to the vessel body 12a and/or the fixed pipe 110. Accordingly, the retainer pin 140 inserted into the collective conduit 130c at least partially defined by the aligned first and second conduits 132c and 134c of the first and second conduit structures 132 and 134 may at least partially restrict (e.g., partially or completely limit, inhibit, arrest, fix, etc.) movement of the azimuthal orientation 120z of the removable pipe 120, and thus at least partially restrict movement of the removable pipe 120, in relation to the vessel body 12a and/or the fixed pipe 110 independently of the bayonet connection 102 and/or the fixed pipe 110. Therefore, the anti-rotation assembly 130 may reduce, minimize, or prevent the risk of inadvertent or undesired rotation 402 of at least the removable pipe proximate end 120a (e.g., the entire removable pipe 120), for example due to vibrations during operation of the process unit 10 which includes the vessel 12 and/or due to vibrations induced by fluid 26 flowing around the outer surface 120os of the removable pipe 120 in the vessel interior 12v during operation of the process unit 10, either or both of which might cause the bayonet connection 102 to at least partially disengaged due to rotation 402 which causes the azimuthal orientation 120z to change. Accordingly, the anti-rotation assembly 130, including the retainer pin 140 inserted through at least the first and second conduits 132c and 134c of the first and second conduits structures 132 and 134, may reduce, minimize, or prevent undesired disengagement of the bayonet connection 102 without using separate fasteners at the location of the bayonet connection 102, based on including a retainer pin 140 which can easily be inserted or removed via the vessel body top opening 12au with ease by an operator located at the top opening 12au.

As further shown in FIGS. 1C and 7A, at S710 a retaining element 142 may be moved to engage the retainer pin 140 to at least partially limit axial movement of the retainer pin 140 along the conduit axis 130x in relation to the collective conduit 130c, for example to at least partially hold the retainer pin 140 in place in relation to at least the first and second conduit structures 132 and 134, to reduce, minimize, or prevent the risk of inadvertent removal of the retainer pin 140 from at least one of the first conduit 132c or the second conduit 134c. As shown, the retaining element 142 may be a structure (e.g., a block) that is directly connected to the underside 12bs of the vessel head 12b, such that the retaining element 142 may engage the pin head 140b based on the vessel head 12b being coupled to the vessel body 12a. However, example embodiments are not limited thereto. For example, the retaining element 142 may include a latch structure or fastener configured to engage the retainer pin 140 at S710 based on the pin shaft 140a being inserted through the collective conduit 130c to extend at least partially into the first conduit 132c, a separate pin (including for example a cotter pin) which may be configured to be inserted through a corresponding hole or conduit through at least the retainer pin 140 (e.g., between vertically adjacent conduit structures or through a conduit extending through at least a portion of a conduit structure of the first to fourth conduit structures 132 to 138 into a respective conduit of the conduit structure, etc.) to limit, arrest, prevent, etc. movement of the retainer pin 140 along the conduit axis 130x based on based on the pin shaft 140a being inserted through the collective conduit 130c to extend at least partially into the first conduit 132c, or the like.

Referring to FIGS. 1A to 1D and 7A, at S712, the method S700 may include connecting one or more removable devices to the removable pipe distal end 120b of the removable pipe 120. For example, the connecting at S712 may include connecting a vessel internal fixture 40 (e.g., a fixture, including for example a spray head, sparger, or the like) to the removable pipe distal end 120b. In example embodiments where vessel internal piping 30 is connected at one end to the removable pipe 120 at S710, the connecting at S712 may include connecting the vessel internal fixture 40, at an interface 40a thereof, to an opposite end 30a of the vessel internal piping 30. As described herein, the interface 40a may comprise a socket or plug connector configured to establish a “sleeved” or socket connection with the vessel internal piping 30 and which may include one or more seal/stop structures which may establish a fluid seal of the interface between the vessel internal fixture 40 and the vessel internal piping 30 In some example embodiments, the vessel internal piping 30 is absent and the connecting at S712 connects the vessel internal fixture 40 to the removable pipe distal end 120b. In some example embodiments, the vessel internal fixture 40 includes one or more fluid discharge assemblies, including for example one or more sprayer heads, discharge ports, or the like, which may be connected to the vessel internal piping 30 and/or removable pipe distal end 120b to configure the pipe connection assembly 100 to discharge (e.g., spray) a fluid 26 (e.g., intake fluid 26a, such as feedwater) into the vessel interior 12v during operation of a process unit 10 that includes the vessel 12 and the pipe connection assembly 100 (e.g., a nuclear reactor). In some example embodiments, the connecting at S712 may include connecting the removable pipe distal end 120b to one or more removable vessel internal process components installed in the vessel interior 12v at S701 instead of connecting the removable pipe distal end 120b with vessel internal piping 30 and/or a vessel internal fixture 40, for example based on establishing a connection between the removable pipe 120 and the one or more vessel internal process components 14 (e.g., an upper vessel internal process component 18, which may be a steam dryer in some example embodiments).

Referring to FIGS. 1A and 1C and 7A, at S714 the method S700 may include connecting the vessel head 12b to the vessel body 12a (e.g., via a flange connection) to close the vessel interior 12v. As shown, the vessel head 12b may omit fluid pipe penetrations through the vessel head thickness 12bt thereof, such that fluid pipe penetrations through the vessel thickness into the vessel interior 12v may be limited to ‘side fluid pipe penetrations’ through the vessel body sidewall thickness 12at, thereby reducing, minimizing, or preventing the need to establish fluid pipe connections (e.g., via hot work, contaminated work, etc.) as part of connecting the vessel head 12b to the vessel body 12a.

As shown in at least FIGS. 1A and 1C, in some example embodiments the vessel internal fixture 40 may be connected (e.g., directly connected, affixed, etc.) to the vessel head 12b such that the connecting at S712 is performed as part of connecting the vessel head 12b to the vessel body 12a at S714. For example, the connecting at S714 may include lowering the vessel head 12b, with the vessel internal fixture 40 connected thereto, onto the top opening 12au of the vessel body 12a such that an interface 40a of the vessel internal fixture 40 is lowered to axially engage an exposed end 30a of the vessel internal piping 30. However, example embodiments are not limited thereto, and in some example embodiments the vessel internal fixture 40 may be connected to one or more structures in the vessel interior 12v independently of the vessel head 12b, and/or may be isolated from direct contact with the vessel head 12b, such that S712 and S714 may be performed separately and at last partially independently of each other.

At S716, the method S700 may include operating the process unit 10 including the vessel 12 while using the pipe connection assembly 100, for example, based on circulating a fluid 26 (e.g., feedwater) between the vessel interior 12v and an exterior of the vessel 12 (e.g., through a coolant loop) via flow of the fluid 26 between the fixed pipe 110 and the removable pipe 120 through the respective conduits 110c and 120c thereof, concurrently with the removable pipe 120 being detachably connected with the fixed pipe 110 via the bayonet connection 102. Such circulation may be controlled based on operation of a controller, for example based on control of at least one pump to control a flow of fluid that is pumped through the fixed pipe 110 into the removable pipe 120 and further through one or more removable devices (e.g., vessel internal piping 30, one or more vessel internal fixture 40, etc.) into the vessel interior 12v. The flow of fluid 26 from the fixed pipe 110 into the removable pipe 120 may, upon impinging on a bend 120e in the removable pipe conduit 120c, impart an ejection force 230 on the removable pipe 120, and the pipe connection assembly 100 may resist such an ejection force 230 to prevent detachment of the fixed pipe 110 and the removable pipe 120 due to such ejection force 230, or to reduce, minimize, or reduce disengagement of a sealing of the interface 226 between the fixed pipe 110 and the removable pipe 120 to thereby reduce, minimize, or prevent leakage of fluid 26 through the interface due to the ejection force 230.

FIG. 7B is a flowchart illustrating a method S750 of configuring a vessel assembly to disconnect a pipe connection assembly, according to some example embodiments. The method S750 shown in FIG. 7B may be performed with regard to any of the example embodiments of a pipe connection assembly as described herein, including any of the example embodiments shown in FIGS. 1A-1F, 2A-2D, 3A-3B, 4A-4B, 5A-5B, 6A-6C, 8, 9, or any combination thereof. It will be understood that operations of the method S750 as shown in FIG. 7B may be rearranged relative to what is shown in FIG. 7B. One or more operations may be added to the method S750 relative to what is shown in FIG. 7B. One or more operations shown in FIG. 7B may be omitted from the method S750.

At S752, method S750 may include detaching the vessel head 12b from the vessel body 12a to expose the vessel body top opening 12au, thereby exposing the vessel interior 12v though a top end thereof. In some example embodiments, the vessel head 12b does not include any fluid pipe penetrations through the vessel head thickness 12bt thereof, and therefore the vessel head 12b may be detached at S752 without performing any disassembly or disconnection of fluid pipe connections of a top fluid pipe penetration through the vessel head 12b and thus without hot work, contaminated work, or the like associated with such connections (e.g., a high-pressure steam discharge piping 24). At S752, the exposed vessel interior 12v may include one or more vessel internal process components 14 (e.g., an upper vessel internal process component 18, which may include for example a steam dryer), which cooperate with the vessel body sidewall inner surface 12as to at least partially define one or more arcuate spaces 90 (e.g., an annular space) within the vessel interior 12v. A pipe connection assembly 100 may be connected to the vessel 12 and may include a removable pipe 120 at least partially located in the arcuate space 90 and detachably connected, via a bayonet connection 102 at the removable pipe proximate end 120a, to a fixed pipe 110 that penetrates through a vessel body sidewall thickness 12at of the vessel body 12a. One or more detachable devices (e.g., vessel internal piping 30, vessel internal fixture 40, etc.) may be coupled to the removable pipe distal end 120b of the removable pipe 120.

At S754, the method S750 may include disengaging the anti-rotation assembly 130 to remove a restriction otherwise imposed by the anti-rotation assembly 130 on the azimuthal orientation 120z of the removable pipe proximate end 120a in relation to the vessel body 12a and/or the fixed pipe 110. The disengaging of the anti-rotation assembly 130 may free at least the removable pipe proximate end 120a (e.g., the entire removable pipe 120) to rotate 402 around the central axis 200x (e.g., at least one of central axis 120x or central axis 110x) in relation to the vessel body 12a and/or the fixed pipe 110. Such disengaging at S754 may include at least partially removing the retainer pin 140 from the collective conduit 130c, which may include removing the retainer pin 140 (e.g., the pin shaft 140a) from at least one of the first conduit 132c or the second conduit 134c. The disengaging at S754 may include removing the retainer pin 140 (e.g., the pin shaft 140a) from each of the first and second conduits 132c and 134c. In example embodiments where the anti-rotation assembly 130 includes first to fourth conduit structures 132 to 138 having respective first to fourth conduits 132c to 138c that collectively define the collective conduit 130c, the disengaging at S754 may include removing the retainer pin 140 (e.g., the pin shaft 140a) from each of the first to fourth conduits 132c to 138c. In some example embodiments, where the anti-rotation assembly 130 includes a retaining element 142 configured to secure or fasten the retainer pin 140 into place to be at least partially within at least the first conduit 132c, the disengaging at S754 may include disengaging the retaining element 142 from the retainer pin 140 to enable free movement of the retainer pin 140 out of at least the first conduit 132c. In some example embodiments, the retaining element 142 is connected (e.g., directly connected, fixed, etc.) to the vessel head 12b, such that the retaining element 142 is disengaged from the retainer pin 140 based on detaching the vessel head 12b from the vessel body 12a at S752.

At S756, the method S750 may include detaching one or more removable devices from the removable pipe distal end 120b of the removable pipe 120. For example, the detaching at S756 may include detaching a vessel internal fixture 40, such as a sprayer head from vessel internal piping 30 which may be connected between the vessel internal fixture 40 and the removable pipe distal end 120b. The detaching at S756 may include detaching the vessel internal piping 30 from the removable pipe distal end 120b. As a result of the detaching at S756, the removable pipe distal end 120b may be exposed. In example embodiments where the vessel internal piping 30 includes a third conduit structure 136 having a third conduit 136c aligned (e.g., overlapping along conduit axis 130x) between at least second and fourth conduits 134c and 138c of second and fourth conduit structures 134 and 138, the detaching at S756 may include rotating 604 the vessel internal piping 30 around its longitudinal axis 30x at an end thereof that is connected to the removable pipe 120 to azimuthally move the third conduit structure 136 out of alignment (e.g., move away from aligning in in a direction extending parallel or coaxial with the conduit axis 130x) with at least the first and second conduit structures 132 and 134, thereby enabling the vessel internal piping 30 and the third conduit structure 136 connected thereto to be detached from the removable pipe 120 along an axial direction extending parallel to the central axis of the removable pipe distal end 120b. As a result of the disengaging at S754 and the detaching at S756, the removable pipe 120 may be connected exclusively to the fixed pipe 110 via the bayonet connection 102.

As shown in at least FIGS. 1A and 1C, in some example embodiments the vessel internal fixture 40 may be connected (e.g., directly connected, affixed, etc.) to the vessel head 12b such that the detaching at S756 is performed as part of detaching the vessel head 12b from the vessel body 12a to expose the vessel body top opening 12au at S752. For example, the detaching at S752 may include raising the vessel head 12b, with the vessel internal fixture 40 connected thereto, up from the vessel body top opening 12au such that an interface 40a of the vessel internal fixture 40 is raised to axially disengage from an end 30a of the vessel internal piping 30. However, example embodiments are not limited thereto, and in some example embodiments the vessel internal fixture 40 may be connected to one or more structures in the vessel interior 12v independently of the vessel head 12b and/or may be isolated from direct contact with the vessel head 12b, such that S752 and S756 may be performed separately and at last partially independently of each other.

At S758, the method S750 may include disengaging the bayonet connection 102 of the pipe connection assembly 100 to detach the removable pipe 120 from the fixed pipe 110. At S760, the disengaging of S758 may include rotating 402 at least the removable pipe proximate end 120a (e.g., rotating the entire removable pipe 120) around the central axis 120x in relation to the fixed pipe 110 to cause azimuthal movement 404 of the lugs 212 of the lug pipe connector 210 (included in one of the first pipe connector 112 of the fixed pipe 110 or the second pipe connector 122 of the removable pipe 120) through respective azimuthal notch sections 222b of respective notches 222 of the notch pipe connector 220 (included in the other one of the first pipe connector 112 or the second pipe connector 122) to respective axial notch sections 222a of the respective notches 222. The socket engagement 306 between the socket 214 (included in one of the first pipe connector 112 or the second pipe connector 122) and the plug 224 (included in the other one of the first pipe connector 112 or the second pipe connector 122) may be maintained during the rotating at S760. The rotating at S760 may continue until the azimuthal orientation 120z of the removable pipe proximate end 120a reaches an angle 120r in relation to the vertical direction DV at which the lug(s) 212 moving azimuthally 404 through respective azimuthal notch sections 222b contact one or more axial side surfaces 222as at least partially defining an axial notch section 222a. In some example embodiments, the rotating at S760 may include the azimuthally moving lug(s) 212 contacting a chamfer inner surface 222cs defining a chamfer notch section 222c of the respective notch 222, such that further rotation 402 and resultant azimuthal movement 404 of the lug(s) 212 in relation to the notch(es) 222 may induce axial movement 302 of the removable pipe proximate end 120a away from the fixed pipe proximate end 110a in the axial direction DA, thereby partially removing the plug 224 from the socket 214.

At S762, the disengaging of S758 may include axially moving 302 the removable pipe proximate end 120a of the removable pipe 120 away from the fixed pipe proximate end 110a of the fixed pipe 110 in the axial direction DA along the aligned central axes 120x, 110x of the proximate ends 120a, 110a (e.g., along the central axis 200x) to cause axial relative movement of the lug(s) 212 through respective axial notch section(s) 222a of respective notch(es) 222 and further through respective axial notch openings 222o of the respective notch(es) 222 and to further cause the plug 224 to exit the socket 214. As a result, the lug and notch pipe connectors 210 and 220 may be disengaged, and the plug 224 may be disengaged (e.g., removed) from the socket 214, thereby disengaging the bayonet connection 102 and disconnecting the removable pipe 120 from the fixed pipe 110 into the arcuate space 90 of the vessel interior 12v.

At S764, the method S750 may include lifting the detached removable pipe 120 out of the arcuate space 90 of the vessel interior 12v through the exposed top opening 12au. As the vessel interior 12v may be at least partially filled with a fluid 26, and where the fixed pipe proximate end 110a of the fixed pipe 110 may penetrate through the vessel body sidewall thickness 12at at a level that is submerged below the fluid surface 26s of the fluid 26 in the vessel interior 12v, the removable pipe 120 may be at least partially submerged in the fluid 26 within the arcuate space 90 prior to detachment from the fixed pipe 110 at S758. As a result, at S764, the lifting may include lifting at least a portion of the detached removable pipe 120 out of the fluid 26 in the vessel interior 12v. As a result of the detached removable pipe 120 being lifted out of the vessel interior 12v, the clearance between the vessel body sidewall inner surface 12as and one or more vessel internal process components 14 in the vessel interior 12v, including for example an upper vessel internal process component 18 (e.g., steam dryer), may be improved, thereby enabling improved ease of removal of one or more vessel internal process components (e.g., upper vessel internal process component 18) from the vessel interior 12v subsequent to the detaching and removal of the removable pipe 120 from the vessel interior 12v at S758 and S764.

At S766, the method S750 may include removing one or more removable devices, including for example one or more vessel internal process components 14, from the vessel interior 12v through the exposed top opening 12au of the vessel body 12a. Such removal at S766 may enable replacement and/or maintenance of the one or more vessel internal process components 14. Such removal at S766 may enable access to and/or maintenance of one or more additional devices in the vessel interior 12v, including for example a lower vessel internal process component 16 (e.g., a nuclear reactor core, steam separator, etc.) which may be exposed based on removal of an upper vessel internal process component 18 from the vessel interior 12v at S766. Subsequent to any inspection, maintenance or the like subsequent to S766, the method S700 may be performed to reconfigure the process unit 10 for operation without requiring excessive connections, hot work, contaminated work, or the like and with reduced complexity of connections within the vessel interior 12v and with reduced risk foreign material in the vessel interior 12v (e.g., losing flange bolts into the vessel interior 12v while attempting to establish a flange connection between the fixed pipe 110 and the removable pipe 120).

Referring generally to FIGS. 1A to 7B, in some example embodiments, the pipe connection assembly 100 reduces, minimizes, or replaces the use of bolted flanges (e.g., a flange connection) for connection of vessel internal piping in a vessel 12 of a process unit 10, significantly reducing vessel internal piping installation/removal time, risk of leaving foreign material associated with the vessel internal pipe connections within the vessel interior 12v (e.g., dropped bolts or washers) or need for complicated remote operated tooling. The pipe connection assembly 100 may reduce, minimize, or eliminate the need for pipe connections in the vessel head 12b, which otherwise may have to be disconnected before the vessel head 12b could be removed (e.g., detached from the vessel body 12a) to remove the vessel internals (e.g., one or more vessel internal process components 14, vessel internal piping 30, vessel internal fixture 40, etc.). As shown, the pipe connection assembly 100 may enable a connection between the fixed pipe 110 (penetrating through the vessel body sidewall thickness 12at) and a removable pipe 120 extending into the vessel interior 12v via a bayonet connection 102 which may be engaged based on manipulating the removable pipe 120 from the removable pipe distal end 120b thereof (e.g., by an operator reaching into the vessel interior 12v from the vessel body top opening 12au), and further based on manipulation of the anti-rotation assembly 130 from the top opening 12au (e.g., based on an operator at the top opening 12au inserting the retainer pin 140 into the collective conduit 130c defined by at least the first and second conduits 132c and 134c from the top opening 12au). Thus, the pipe connection assembly 100 may enable the bayonet connection 102 to be engaged, and the anti-rotation assembly 130 to be engaged, without at-pipe connection work (e.g., at-pipe connection work by a human operator at the connection between the fixed pipe 110 and the removable pipe 120). Accordingly, the pipe connection assembly 100 may be suitable for low clearance applications, as the insertion depth 224id of the plug 224 (of the first pipe connector 112 or the second pipe connector 122) into the socket 214 needed to engage the removable pipe 120 to the fixed pipe 110 in a bayonet connection 102 can be reduced or minimized by the design of the notches 222 (e.g., engagement L's) and pipe thickness/metal strength of one or both of the removeable pipe 120 and the fixed pipe 110.

In some example embodiments, providing the pipe connection assembly 100 in a process unit 10 to connect a fixed pipe 110 penetrating through the vessel body sidewall thickness 12at to a removable pipe 120 at least partially in the vessel interior 12v may enable increasing the size of one or more pipes extending into, out of, and/or through the vessel interior 12v. In addition, such providing of the pipe connection assembly 100 in a process unit 10 may enable adding a vessel internal fixture 40 (e.g., a head spray device) to the vessel 12 without the addition of vessel head 12b penetrations and any associated required isolation valves on the vessel head. Accordingly, such providing of the pipe connection assembly 100 in the process unit 10 may reduce costs associated with the process unit 10 based on avoiding costs due to installation of the piping and required pipe supports up to the head penetration point for fluid pipe penetration through the vessel head 12b.

In addition, such providing of the pipe connection assembly 100 may reduce maintenance outage time associated with the process unit 10 as the omission of the vessel head fluid pipe penetrations (head piping) due to use of the pipe connection assembly 100 may avoid having to remove and install piping and pipe supports connected to the vessel head 12b during each outage when the vessel head 12b has to be removed (e.g., detached from the vessel body 12a). Omission of the head piping due to providing the pipe connection assembly 100 in the process unit 10 may avoid operations to disconnect the head piping as part of removing the vessel head 12b, including disconnecting a flange at the vessel head 12b, disconnecting the flange at the other end of the pipe section that will be removed, installation of a blank flange on the open pipe that will exist after pipe removal and disconnecting the bolts/pins associated with the pipe support connections for any pipe supports that must be removed to allow vessel head removal. By enabling such operations to be omitted during removal of the vessel head 12b, the pipe connection assembly 100 may reduce operation and maintenance costs and/or reduce time (e.g., outage time) and complexity of operations including removal or installation of the vessel head 12b.

In addition, such providing of the pipe connection assembly 100 may omit electrical and/or hydraulic connections to any valves on the vessel head 12b would otherwise need to be disconnected and reconnected during each outage in cases where vessel head piping is present, including avoiding the need to make provisions to allow sealing any open pipes to prevent debris intrusion while the fluid pipes are disconnected. As a result, design complexity, and duration and complexity of outage operations (including removal or installation of the vessel head 12b) may be reduced, thereby reducing costs associated with the process unit 10 (e.g., reducing costs incurred due to outages).

In addition, a process unit 10, based on including the pipe connection assembly 100 may omit devices including one or more (or all) of the above mentioned flanges on the vessel head 12b that create additional potential leakage points, and hot piping to reach the vessel connection if hot fluids are processed and which would, if present, create additional areas where personnel safety would be an issue.

In addition, a process unit 10, based on including the pipe connection assembly 100 may enable vessel head 12b insulation to be attached to the inside of any vessel cover or dome, so that the insulation package can be removed with the cover or dome (e.g., removed with the vessel head 12b), instead of after pipes and pipe supports are disconnected from the vessel head 12b in embodiments where fluid pipe penetrations through the vessel head 12b are present. As a result, complexity of maintenance (outage) operations involving removal or installation of the vessel head 12b may be reduced.

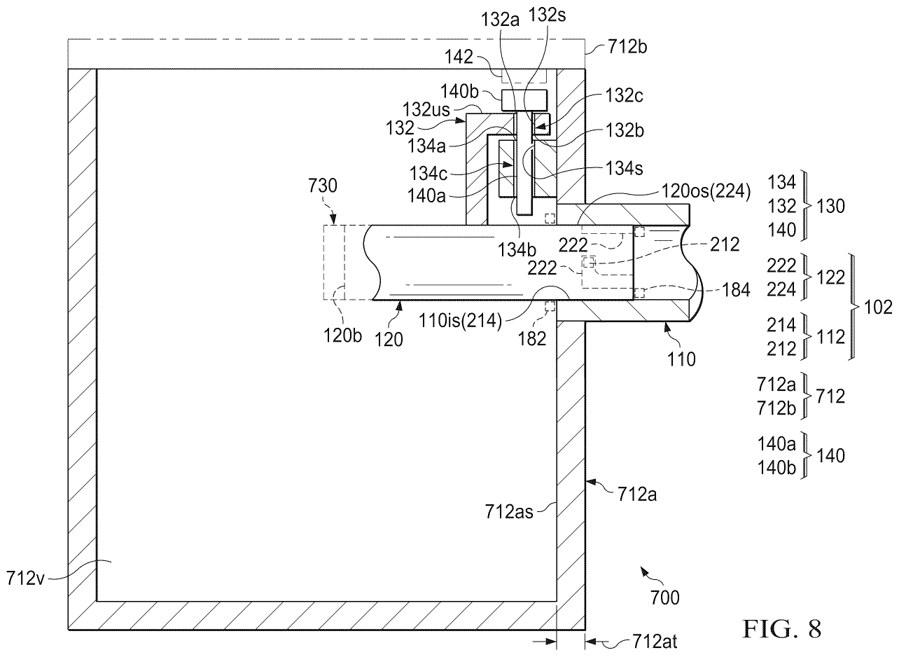

FIG. 8 is a cross-sectional view of a vessel including a pipe connection assembly, according to some example embodiments.

Referring to FIG. 8, in some example embodiments a process unit 700 may include a vessel 712 having at least a vessel body 712a. The pipe connection assembly 100 may extend through the vessel body sidewall thickness 712at of the vessel body 712a into a vessel interior 712v at least partially defined by one or more vessel body sidewall inner surfaces 712as of the vessel body 712a. The vessel 712 may include a vessel head 712b that may be coupled to the top end opening of the vessel body 712a to enclose the vessel interior 712v, but example embodiments are not limited thereto. In some example embodiments, the vessel head 712b may be omitted. While some example embodiments of a pipe connection assembly 100, including example embodiments shown in FIGS. 1A to 6B, may be included in a vessel 12 that is a thick-walled vessel, example embodiments are not limited thereto. For example, the vessel 712 may be a thin-walled vessel, where the vessel body sidewall thickness 712at may be relatively small (e.g., ½ inch, ⅜ inch, ¼ inch, ⅛ inch, etc.). The vessel body 712a and/or 712b may comprise any material, including for example any metal material, including for example stainless steel, carbon steel, or aluminum, but example embodiments are not limited thereto.

As shown in FIG. 8, the removable pipe 120 of the pipe connection assembly 100 may omit the bend 120e as shown in FIGS. 1A to 6B and may extend as a straight or substantially straight pipe from the fixed pipe 110 into the vessel interior 712v. In some example embodiments, the removable pipe distal end 120b of the removable pipe 120 may be coupled to one or more additional vessel internal components 730, for example a fluid discharge assembly which may include a sprayer head, a nozzle, or the like. However, example embodiments are not limited thereto, and in some example embodiments the removable pipe distal end 120b of the removable pipe 120 may not be directly connected to any other component and may be directly exposed to the vessel interior 712v, so that the removable pipe 120 may direct a fluid 26 flowing through the removable pipe conduit 120c into the vessel interior 712v via the removable pipe distal end 120b.

While some example embodiments of an anti-rotation assembly 130, including for example the example embodiments shown in FIGS. 1A to 6B, may include one or more conduit structures connected (e.g., directly or indirectly connected, fixed, etc.) to the vessel body, a conduit structure connected (e.g., directly or indirectly connected, fixed, etc.) to the removable pipe 120, and another conduit structure connected (e.g., directly or indirectly connected, fixed, etc.) to a removable device coupled to the removable pipe distal end 120b, such that a retainer pin 140 that is inserted into the conduit structure conduits extends alternatingly at least partially through a conduit of one of the conduit structures connected to the vessel body 712a and a conduit of one of the conduit structures connected to the removable pipe 120, example embodiments are not limited thereto. For example, as shown in FIG. 8, in some example embodiments, an anti-rotation assembly 130 may include a single first conduit structure 132 connected (e.g., directly or indirectly connected, fixed, etc.) to the removable pipe 120 and a single second conduit structure 134 connected (e.g., directly or indirectly connected, fixed, etc.) to the vessel body 712a (e.g., the vessel body sidewall inner surface 712as), where each of the first and second conduit structures 132 and 134 includes a respective inner surface 132s and 134s that defines a respective conduit 132c and 134c extending through an entirety of a thickness (e.g., in the vertical direction DV) of the respective conduit structure between opposite outer surfaces thereof.

As shown, the anti-rotation assembly 130 may be configured to enable a retainer pin 140 to be inserted through each of the first and second conduits 132c and 134c based on the conduit structures 132 and 134 being aligned (e.g., due to movement and/or positioning of the removable pipe 120 in relation to the vessel body 712a and/or the fixed pipe 110) so as to align the first and second conduits 132c and 134c along a conduit axis 130x, based on the removable pipe 120 being detachably connected to the fixed pipe 110 via the bayonet connection 102. The retainer pin 140 may be extended partially or entirely through both of the aligned first and second conduits 132c and 134c to at least partially restrict movement of the azimuthal orientation 120z of at least the removable pipe proximate end 120a, and thus at least partially restrict movement of the removable pipe 120, in relation to the vessel body 712a independently of the bayonet connection 102 and/or independently of the fixed pipe 110. As shown, a pin head 140b of the retainer pin 140 may rest on an upper surface 132us of the first conduit structure 132 based on the pin shaft 140a extending through the aligned first and second conduits 132c and 134c, but example embodiments are not limited thereto. As further shown, the anti-rotation assembly 130 may include a retaining element 142 that may be configured to engage the retainer pin (e.g., the pin head 140b and/or the pin shaft 140a) to hold the retainer pin 140 in place in relation to the first and second conduits 132c and 134c and thus to arrest or fix the azimuthal orientation of the removable pipe proximate end 120a, but example embodiments are not limited thereto. For example, in some example embodiments the retaining element 142 may be omitted from the anti-rotation assembly 130.

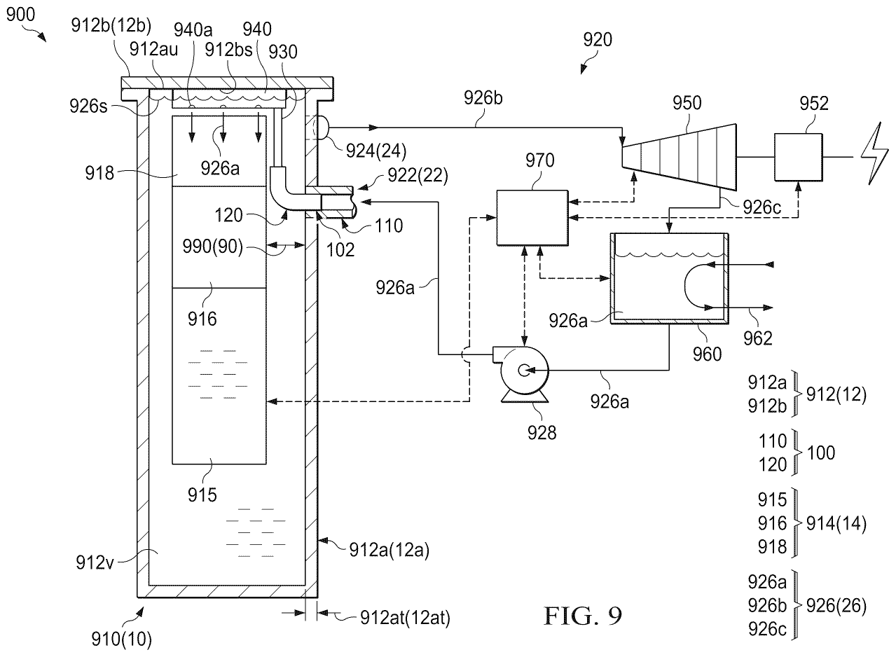

FIG. 9 is a schematic of a nuclear power plant 900 including a pipe connection assembly 100 according to some example embodiments. The pipe connection assembly 100 shown in FIG. 9 may be a pipe connection assembly 100 according to any of the example embodiments, including for example the pipe connection assembly 100 as shown in FIGS. 1A to 6B, the pipe connection assembly 100 as shown in FIG. 8, or the like.

Referring to FIG. 9, a nuclear power plant 900 may include a process unit (corresponding to the process unit 10 shown in at least FIG. 1A) that is a nuclear reactor 910, and the nuclear power plant 900 may include a coolant circuit 920, or “coolant loop”, that circulates coolant fluid 926 (corresponding to the fluid 26) to remove process heat from the nuclear reactor 910, where the process heat may then be used to drive a separate process unit such as a turbine 950 and electrical generator 952 to generate electricity, although example embodiments are not limited thereto.

As shown, the nuclear reactor 910 may include a pressure vessel 912 (corresponding to vessel 12 shown in FIGS. 1A to 6C although example embodiments are not limited thereto). The pressure vessel 912 may include a pressure vessel body 912a and a pressure vessel head 912b connected thereto such that respective inner surfaces 912as and 912bs of the pressure vessel body 912a and the pressure vessel head 912b at least partially define a pressure vessel interior 912v of the pressure vessel 912. The nuclear reactor 910 may include one or more vessel internal process components 914 (corresponding to the one or more vessel internal process components 14) within the pressure vessel interior 912v, including for example a nuclear reactor core 915 that is configured to generate heat based on nuclear (e.g., fission) reactions within the nuclear reactor core 915, a steam separator 916, and a steam dryer 918.

As shown, the nuclear reactor 910 may be a Boiling Water Reactor (BWR), where the nuclear reactor 910 may circulate liquid water coolant fluid (e.g., feedwater 926a) into a lower portion of the pressure vessel interior 912v to vaporize into steam 926b (e.g., high pressure steam) based on absorbing heat from the nuclear reactor core 915, where the steam 926b is further discharged from the nuclear reactor 910 (e.g., at an upper end of the pressure vessel interior 912v) to be directed to drive a turbine 950. As shown, the nuclear power plant 900 may include a coolant circuit 920. The coolant circuit 920 may direct feedwater 926a into the nuclear reactor via intake piping 922 (corresponding to intake piping 22) and may direct steam 926b out of the nuclear reactor 910 via the discharge piping 924 (corresponding to discharge piping 24). The coolant circuit 920 may direct the steam 926b from the discharge piping 924 to drive a turbine 950 (which may be any known turbine) to further drive an electrical generator 952 (which may be any known electrical generator) to generate electricity. The coolant circuit 920 may direct steam 926c exhausted from the turbine 950 (e.g., low-pressure steam) to a condenser 960 to condense into feedwater 926a (e.g., based on circulating a separate heat sink coolant 962 in thermal communication with the steam 926b and/or feedwater 926a in the condenser 960). The coolant circuit 920 may pump the condensed feedwater 926a via one or more pumps 928 back to the intake piping 922.

The nuclear power plant 900 may include a controller 970 that is electrically coupled to one or more portions of the nuclear power plant 900, including the nuclear reactor 910, the pump 928, the turbine 950, the electrical generator 952, the condenser 960, one or more valves or other devices associated therewith, or the like. The controller 970 may operate the one or more portions of the nuclear power plant to control circulation of the coolant fluid 926 through the coolant circuit 920. A controller as described herein, including for example controller 970, may be implemented using processing circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner. The controller may include a memory (e.g., a solid state memory) storing a program of instructions (e.g., computer executable code) and a processor (e.g., a CPU) configured to execute the program of instructions to perform an operation, including for example controlling one or more portions of the nuclear power plant 900 to circulate coolant fluid 926 through the coolant circuit 920, including circulating coolant fluid 926 through the detachably connected fixed and removable pipes 110 and 120 of a pipe connection assembly 100 (e.g., based on operating a pump 928 that is coupled to at least one of the fixed pipe 110 or the removable pipe 120).

While the nuclear reactor 910 is shown to be a boiling water reactor (BWR), and the coolant fluid 926 is described above to be water, example embodiments are not limited thereto. In some example embodiments, the nuclear reactor 910 may include a Pressurized Water Reactor (PWR), a liquid metal cooled reactor, a Molten Salt Reactor (MSR), an Advanced Boiling Water Reactor (ABWR), an Economic Simplified Boiling Water Reactor (ESBWR), a BWRX-300 reactor, or the like.

As shown, the nuclear reactor 910 may include one or more vessel internal process components 914 above the nuclear reactor core 915, including for example a steam separator 916 and a steam dryer 918. As shown, at least the steam dryer 918 may, together with the pressure vessel body sidewall inner surface 912as, define an arcuate space 990 (corresponding to arcuate space 90) within the pressure vessel interior 912v between an outer surface of the steam dryer 918 and a pressure vessel body sidewall inner surface 912as of the pressure vessel body 912a. One or both of the steam dryer 918 and the steam separator 916 may be removable from the pressure vessel interior 912v based on detachment of the pressure vessel head 912b from the pressure vessel body 912a.

As shown, the nuclear reactor 910 may include a pipe connection assembly 100 according to any of the example embodiments, including for example the pipe connection assembly 100 as shown in FIGS. 1A to 6C, the pipe connection assembly 100 as shown in FIG. 8, or the like. As shown, the fixed pipe 110 of the pipe connection assembly 100 may extend (“penetrate”) through a sidewall thickness 912at of the pressure vessel body 912a such that the fixed pipe proximate end 110a is open to the arcuate space 990 within the pressure vessel interior 912v. The removable pipe 120 of the pipe connection assembly 100 may be detachably connected with the fixed pipe 110 within the arcuate space 990 to establish fluid communication between an exterior of the pressure vessel 912 and the pressure vessel interior 912v via a conduit extending through the sidewall thickness 912at of the pressure vessel body 912a, the conduit at least partially defined by respective conduits 110c and 120c of the fixed pipe 110 and the removable pipe 120. As further shown, the pipe connection assembly 100 in the nuclear reactor 910 may include an anti-rotation assembly 130 according to any of the example embodiments, including for example the example embodiments shown in FIGS. 1A to 6C, the example embodiments shown in FIG. 8, or the like.

The fixed pipe 110 may at least partially define or may be connected to, at a distal end opposite from the fixed pipe proximate end 110a, the intake piping 922, such that the fixed pipe 110 and the removable pipe 120 detachably coupled therewith via the bayonet connection 102, are configured to direct feedwater 926a into the pressure vessel interior 912v. The removable pipe 120 may be coupled, at the removable pipe distal end 120b, to a fluid discharge assembly 940 (e.g., a spray head), which may correspond to the vessel internal fixture 40, either directly or via vessel internal piping 930 connected between the fluid discharge assembly 940 and the removable pipe distal end 120b. The fluid discharge assembly 940 may be configured to discharge (e.g., spray) feedwater 926a into the pressure vessel interior 912v via one or more discharge ports 940a, for example based on controller 970 operating a pump 928 to direct a flow of feedwater 926a through the fixed pipe 110 and the removable pipe 120, the vessel internal piping 930, and the fluid discharge assembly 940, such that the pipe connection assembly 100 may be configured to direct a fluid to the fluid discharge assembly 940 to be discharged (e.g., sprayed) into the pressure vessel interior 912v through the sidewall thickness 912at of the pressure vessel body 912a.

As further shown, the fluid discharge assembly 940 may be above the steam dryer 918 at an upper end of the pressure vessel interior 912v and configured to discharge (e.g., spray) feedwater 926a downwards from the upper end of the pressure vessel interior 912v without a top fluid pipe penetration through the pressure vessel head 912b to provide feedwater 926a into the pressure vessel interior 912v. As shown, the fluid discharge assembly 940 may be connected to the pressure vessel head 912b, such that the fluid discharge assembly 940 may be connected to the vessel internal piping 930 based on the pressure vessel head 912b being lowered onto and coupled with the top opening 912au of the pressure vessel body 912a, and the fluid discharge assembly 940 may be detached from the vessel internal piping 930 based on the pressure vessel head 912b being decoupled and raised above the top opening 912au of the pressure vessel body 912a. However, example embodiments are not limited thereto, and in some example embodiments the fluid discharge assembly 940 may be connected to one or more structures in the pressure vessel interior 912v independently of the pressure vessel head 912b, and in some example embodiments may be isolated from direct contact with the pressure vessel head 912b. Accordingly, in some example embodiments, the fluid discharge assembly 940 may remain in the pressure vessel interior 912v and may be connected to and disconnected from the vessel internal piping 930 therein independently of the pressure vessel head 912b.

As a result, the pipe connection assembly 100 may configure the nuclear reactor 910 to avoid fluid pipe penetrations through the pressure vessel head 912b, thereby avoiding issues associated with disconnecting, isolating, and/or reconnecting piping and/or pipe connections at (e.g., through) the pressure vessel head 912b to enable detaching and installing the pressure vessel head 912b on the pressure vessel body 912a. Thereby the pipe connection assembly 100 may configure the nuclear reactor 910 to have reduced complexity, installation costs, maintenance costs, and outage durations associated with installing, operating, and/or maintaining the nuclear reactor 910, including for example removing the pressure vessel head 912b to enable removal and/or replacement of at least the steam dryer 918 (alone or together with the steam separator 916) from the pressure vessel interior 912v.

In some example embodiments, the pipe connection assembly 100 may enable the vessel internal piping to provide feedwater 926a into the pressure vessel interior 912v through a fluid discharge assembly 940 to extend from a “side” fluid pipe penetration through the pressure vessel body 912a sidewall thickness and through a low-clearance arcuate space 990 without requiring complex tooling, connections, separate fasteners which pose a risk of leaving foreign material associated with attempts to connect or disconnect the vessel internal piping (dropped bolts or washers) within the pressure vessel interior 912v, or at-pipe connection work to establish a connection between a removable pipe 120 and a fixed pipe 110 to provide further clearance for removal and/or replacement of the steam dryer 918 and/or steam separator 916. As a result, the pipe connection assembly 100 may improve ease of replacement of at least the steam dryer 918 and/or steam separator 916 in the pressure vessel interior 912v and may reduce complexity of the piping connections in the pressure vessel interior 912v, particularly in cases where the fixed pipe proximate end 110a may be open to the pressure vessel interior 912v at a location that is submerged beneath the surface 926s of feedwater 926a in the pressure vessel interior 912v. The pipe connection assembly 100 is configured to enable the removable pipe 120 to be detachably connected to the fixed pipe 110 via a bayonet connection 102 which may be engaged or disengaged based on manipulation of the removable pipe 120 by an operator located outside the arcuate space 990. For example, an operator at the vessel body top opening 912au may reach into the arcuate space 990 to grasp and directly manipulate the removable pipe 120 at or proximate to the removable pipe distal end 120b or manipulating a tool from the top opening to manipulate the removable pipe 120 in relation to the fixed pipe 110 from outside the arcuate space 990, without the operator physically entering the arcuate space 990 or the pressure vessel interior 912v.

In view of at least the above, the pipe connection assembly 100 may enable a side fluid pipe penetration into a low-clearance arcuate space 990 to enable vessel internal piping to provide a fluid discharge assembly connection that avoids a top fluid pipe penetration through the pressure vessel head 912b while also enabling piping to be attached or detached from the side fluid pipe penetration (e.g., fixed pipe 110) without requiring at-connection work by an operator in the arcuate space 990 and without requiring separate fasteners at the connection between the fixed pipe 110 and the removable pipe 120 to thereby reduce the risk of foreign material (e.g., bolts, nuts, washers, etc.) associated with the connection being inadvertently dropped into the pressure vessel interior 912v to thereby reduce potential risks to operation of the nuclear reactor 910 (e.g., damage to the nuclear reactor 910 due to foreign material). As a result, the pipe connection assembly 100 may reduce the complexity, costs, outage duration, and potential sources of damage to the nuclear reactor 910 while enabling improved efficiency of space usage within the pressure vessel interior 912v, thereby improving cost efficiency and space efficiency of the nuclear reactor 910 with further reduced maintenance outage durations.

Some Example Embodiments of the inventive concepts are as follows below:
Example Embodiment 1: A pipe connection assembly (100), comprising:
a fixed pipe (110), the fixed pipe extending to a fixed pipe proximate end (110a) through a sidewall thickness (12at) of a vessel body (12a) of a vessel (12) such that the fixed pipe proximate end is open to a vessel interior (12v) and fixed in relation to the vessel body, the vessel interior at least partially defined by one or more vessel body sidewall inner surfaces (12as) of the vessel body, the fixed pipe including a first pipe connector (112) at the fixed pipe proximate end;
a removable pipe (120), the removable pipe extending between a removable pipe proximate end (120a) and a removable pipe distal end (120b), the removable pipe including a second pipe connector (122) at the removable pipe proximate end, the first and second pipe connectors collectively defining a bayonet connection (102), the removable pipe configured to detachably connect with the fixed pipe via the bayonet connection; and
an anti-rotation assembly (130) configured to at least partially restrict movement of the removable pipe in relation to the vessel independently of the bayonet connection, based on the removable pipe being detachably connected with the fixed pipe via the bayonet connection.
Example Embodiment 2: The pipe connection assembly of Example Embodiment 1, wherein
one pipe connector (200) of the first pipe connector or the second pipe connector defines one of a socket (214) or a plug (224), and another pipe connector (202) of the second pipe connector or the first pipe connector defines another one of the plug or the socket,
the one pipe connector of the first pipe connector or the second pipe connector further defines a lug pipe connector (210) including one or more lugs (212) extending radially in relation to a central axis (200x) of the one pipe connector, and the other pipe connector further defines a notch pipe connector (220) including one or more notches (222) configured to receive the one or more lugs, and
the removable pipe is configured to detachably connect with the fixed pipe via the bayonet connection based on
   moving (302) the removable pipe proximate end towards the fixed pipe proximate end in an axial direction (DA), the axial direction parallel to a central axis (120x) of the removable pipe proximate end, to
      cause the one or more lugs to be inserted into separate, respective notches of the one or more notches via separate, respective axial notch openings (222o) in the axial direction, and
      cause the plug to be at least partially inserted into the socket in the axial direction, and
   rotating (402) at least the removable pipe proximate end around the central axis of the removable pipe proximate end in relation to the fixed pipe proximate end to cause azimuthal engagement (404) between the notch pipe connector and the lug pipe connector concurrently with the plug being at least partially inserted into the socket.
Example Embodiment 3: The pipe connection assembly of Example Embodiments 1 or 2, wherein
the one or more notches each have a notch depth (222t) extending through at least a portion of a pipe sidewall thickness (220t) of the notch pipe connector, and
the one or more lugs are each configured to extend through at least a portion of a respective notch depth of a respective notch of the one or more notches based on being inserted into the respective notch.
Example Embodiment 4: The pipe connection assembly of any of Example Embodiments 1 to 3, wherein
each notch depth (222t) extends through an entirety of the pipe sidewall thickness of the notch pipe connector.
Example Embodiment 5: The pipe connection assembly of any of Example Embodiments 1 to 4, wherein
the one or more lugs are each configured to each extend into a respective notch of the one or more notches and to further extend through some or all of the pipe sidewall thickness based on being inserted into the respective notch.
Example Embodiment 6: The pipe connection assembly of any of Example Embodiments 1 to 5, wherein
the one or more lugs each extend radially inwards to a radial lug height (212t) from an inner surface (214is) of the socket, and
the one or more notches each extend radially inwards to a respective notch depth (222t) through some or all of a pipe sidewall thickness (224t) of the plug from an outer surface (224os) of the plug.
Example Embodiment 7: The pipe connection assembly of any of Example Embodiments 1 to 6, wherein
the first pipe connector at the fixed pipe proximate end defines both the socket and the lug pipe connector, and
the second pipe connector at the removable pipe proximate end defines both the plug and the notch pipe connector.
Example Embodiment 8: The pipe connection assembly of any of Example Embodiments 1 to 7, further comprising at least one of
an outer seal/stop structure (182) on an outer surface (224os) of the plug and configured to engage the socket to at least partially seal an interface (226) between opposing surfaces of the plug and the socket, or
an inner seal/stop structure (184) on an inner surface (214is) of the socket and configured to engage the plug to at least partially seal an interface (226) between opposing surfaces of the plug and the socket.
Example Embodiment 9: The pipe connection assembly of any of Example Embodiments 1 to 8, wherein each notch of the one or more notches defines
an axial notch section (222a) extending axially in parallel with a central axis (220x) of the notch pipe connector from an axial notch opening (222o) at an axial end of the notch pipe connector, and
an azimuthal notch section (222b) extending at least partially azimuthally around the central axis of the notch pipe connector from the axial notch section.
Example Embodiment 10: The pipe connection assembly of any of Example Embodiments 1 to 9, wherein each notch of the one or more notches defines
a chamfer notch section (222c) extending both axially and azimuthally between the axial notch section and the azimuthal notch section.
Example Embodiment 11: The pipe connection assembly of any of Example Embodiments 1 to 10, wherein
the bayonet connection is configured to resist an ejection force (230) exerted on the removable pipe in the axial direction, based on a fluid (26) moving between respective conduits (110c, 120c) of the fixed pipe and the removable pipe, such that the bayonet connection is configured to transfer a load between a pipe sidewall (110s) of the fixed pipe and a pipe sidewall (120s) of the removable pipe to counteract the ejection force.
Example Embodiment 12: The pipe connection assembly of any of Example Embodiments 1 to 11, wherein
the bayonet connection defines a load path (240) to resist the ejection force, the load path extending at least partially in the axial direction through at least one of the plug or the socket to an axial interface (228) between the lug pipe connector and the notch pipe connector.
Example Embodiment 13: The pipe connection assembly of any of Example Embodiments 1 to 12, wherein the anti-rotation assembly includes
a first conduit structure (132) connected to the removable pipe, the first conduit structure including a first conduit (132c) extending at least partially through the first conduit structure,
a second conduit structure (134) connected to the vessel, the second conduit structure including a second conduit (134c) extending at least partially through the second conduit structure, and
a retainer pin (140) configured to extend at least partially through each of the first conduit and the second conduit based on the first and second conduits being at least partially aligned to at least partially define a collective conduit (130c) extending through both the first and second conduits.
Example Embodiment 14: The pipe connection assembly of any of Example Embodiments 1 to 13, further comprising:
a retaining element (142) configured to engage the retainer pin to at least partially limit movement of the retainer pin out of at least the first conduit.
Example Embodiment 15: The pipe connection assembly of any of Example Embodiments 1 to 14, wherein the retaining element is directly connected to a vessel head (12b) of the vessel independently of the vessel body.
Example Embodiment 16: The pipe connection assembly of any of Example Embodiments 1 to 15, wherein
the second conduit extends entirely between opposite outer surfaces of the second conduit structure, and
the first conduit extends through a limited portion of the first conduit structure to a bottom end (132b) defined by a bottom inner surface (132bs) of the first conduit, such that the first conduit structure is configured to structurally support a distal end (140bs) of the retainer pin at the inner surface of the first conduit.
Example Embodiment 17: A nuclear reactor (910), comprising:
a pressure vessel (912), the pressure vessel including a vessel body (912a) and a pressure vessel head (912b) on a top opening (912au) of the vessel body, respective inner surfaces (912as, 912bs) of the vessel body and the vessel head at least partially defining a pressure vessel interior (912v) of the pressure vessel;
a nuclear reactor core 915, a steam separator (916), and a steam dryer (918) that are each within the pressure vessel interior, the steam dryer at least partially defining an arcuate space (990) between an outer surface of the steam dryer and a vessel body sidewall inner surface of the vessel body; and
the pipe connection assembly of any of Example Embodiments 1 to 16, the fixed pipe of the pipe connection assembly extending through a sidewall thickness (912at) of the vessel body such that the fixed pipe proximate end is open to the arcuate space within the pressure vessel interior, the removable pipe of the pipe connection assembly detachably connected with the fixed pipe within the arcuate space to establish fluid communication between an exterior of the pressure vessel and the pressure vessel interior via a conduit extending through the sidewall thickness of the vessel body, the conduit at least partially defined by respective conduits (110c, 120c) of the fixed pipe and the removable pipe.
Example Embodiment 18: The nuclear reactor of any of Example Embodiments 1 to 17, wherein the removable pipe is coupled to a fluid discharge assembly (940) at the removable pipe distal end of the removable pipe, such that the pipe connection assembly is configured to direct a fluid (926) to the fluid discharge assembly to be discharged into the pressure vessel interior through the sidewall thickness of the vessel body.
Example Embodiment 19: A method of operating a vessel (12) including the pipe connection assembly of any of Example Embodiments 1 to 16, the method comprising circulating a fluid (26) between the vessel interior and an exterior of the vessel via flow of the fluid between the fixed pipe and the removable pipe detachably connected with the fixed pipe via the bayonet connection.
Example Embodiment 20: A method of configuring a vessel to include a pipe connection assembly, the method comprising:
providing a vessel body (12a) including a fixed pipe (110), the vessel body including one or more vessel body sidewall inner surfaces (12as) at least partially defining a vessel interior (12v), the fixed pipe extending through a sidewall thickness (12at) of the vessel body to a fixed pipe proximate end (110a), the fixed pipe proximate end open to the vessel interior and fixed in relation to the vessel body, the fixed pipe including a first pipe connector (112) at the fixed pipe proximate end;
detachably connecting a removable pipe (120) within the vessel interior with the fixed pipe via a bayonet connection (102), the removable pipe extending between a removable pipe proximate end (120a) and a removable pipe distal end (120b), the removable pipe including a second pipe connector (122) at the removable pipe proximate end, the first and second pipe connectors collectively defining the bayonet connection; and
connecting the removable pipe to at least a portion of the vessel body independently of the bayonet connection to at least partially restrict movement of the removable pipe in relation to the vessel body independently of the bayonet connection, based on the removable pipe being detachably connected with the fixed pipe via the bayonet connection.
Example Embodiment 21: The method of Example Embodiment 20, wherein
one pipe connector (200) of the first pipe connector or the second pipe connector defines one of a socket (214) or a plug (224), and another pipe connector (202) of the second pipe connector or the first pipe connector defines another one of the plug or the socket,
the one pipe connector of the first pipe connector or the second pipe connector further defines a lug pipe connector (210) including one or more lugs (212) extending radially in relation to a central axis (200x) of the one pipe connector, and the other pipe connector further defines a notch pipe connector including one or more notches (222) configured to receive the one or more lugs, and
the detachably connecting the removable pipe with the fixed pipe via the bayonet connection includes
   moving (302) the removable pipe proximate end towards the fixed pipe proximate end in an axial direction (DA), the axial direction parallel to a central axis (120x) of the removable pipe proximate end, to
      cause the one or more lugs to be inserted into separate, respective notches of the one or more notches via separate, respective axial notch openings (222o) in the axial direction, and
      cause the plug to be at least partially inserted into the socket in the axial direction, and
rotating (402) at least the removable pipe proximate end around the central axis of the removable pipe proximate end in relation to the fixed pipe proximate end to cause azimuthal engagement (404) between the notch pipe connector and the lug pipe connector concurrently with the plug being at least partially inserted into the socket.
Example Embodiment 22: The method of Example Embodiments 20 or 21, wherein
the one or more notches each have a notch depth (222t) extending through at least a portion of a pipe sidewall thickness (220t) of the notch pipe connector, and
the one or more lugs are each configured to extend through at least a portion of a respective notch depth of a respective notch of the one or more notches based on being inserted into the respective notch.
Example Embodiment 23: The method of any of Example Embodiments 20 to 22, wherein
the notch depth extends through an entirety of the pipe sidewall thickness of the notch pipe connector.
Example Embodiment 24: The method of any of Example Embodiments 20 to 23, wherein
the one or more lugs are each configured to extend into a respective notch of the one or more notches and to further extend through some or all of the pipe sidewall thickness based on being inserted into the respective notch.
Example Embodiment 25: The method of any of Example Embodiments 20 to 24, wherein
the one or more lugs each extend radially inwards to a radial lug height (212t) from an inner surface (214is) of the socket, and
the one or more notches each extend radially inwards to a notch depth (222t) through some or all of a pipe sidewall thickness (224t) of the plug from an outer surface (224os) of the plug.
Example Embodiment 26: The method of any of Example Embodiments 20 to 25, wherein
the first pipe connector at the fixed pipe proximate end defines both the socket and the lug pipe connector, and
the second pipe connector at the removable pipe proximate end defines both the plug and the notch pipe connector.
Example Embodiment 27: The method of any of Example Embodiments 20 to 26, wherein the detachably connecting the removable pipe with the fixed pipe via the bayonet connection includes at least one of
engaging an outer seal/stop structure (182) on an outer surface (224os) of the plug with the socket to at least partially seal an interface (226) between opposing surfaces of the plug and the socket, or
engaging an inner seal/stop structure (184) on an inner surface (214is) of the socket with the plug to at least partially seal an interface (226) between opposing surfaces of the plug and the socket.
Example Embodiment 28: The method of any of Example Embodiments 20 to 27, wherein each notch of the one or more notches defines
an axial notch section (222a) extending axially in parallel with a central axis (220x) of the notch pipe connector from an axial notch opening (222o) at an axial end of the notch pipe connector, and
an azimuthal notch section (222b) extending at least partially azimuthally around the central axis of the notch pipe connector from the axial notch section.
Example Embodiment 29: The method of any of Example Embodiments 20 to 28, wherein each notch of the one or more notches defines
a chamfer notch section (222c) extending both axially and azimuthally between the axial notch section and the azimuthal notch section.
Example Embodiment 30: The method of any of Example Embodiments 20 to 29, wherein
the bayonet connection is configured to resist an ejection force (230) exerted on the removable pipe in the axial direction, based on a fluid (26) moving between respective conduits (110c, 120c) of the fixed pipe and the removable pipe, such that the bayonet connection is configured to transfer a load between a pipe sidewall (110s) of the fixed pipe and a pipe sidewall (120s) of the removable pipe to counteract the ejection force.
Example Embodiment 31: The method of any of Example Embodiments 20 to 30, wherein
the bayonet connection defines a load path (240) to resist the ejection force, the load path extending at least partially in the axial direction through at least one of the plug or the socket to an axial interface (228) between the lug pipe connector and the notch pipe connector.
Example Embodiment 32: The method of any of Example Embodiments 20 to 31, wherein the connecting the removable pipe to at least the portion of the vessel independently of the bayonet connection includes extending a retainer pin (140) at least partially through each of a first conduit (132c) and a second conduit (134c), the first conduit extending at least partially through a first conduit structure (132), the first conduit structure connected to the removable pipe, the second conduit extending at least partially through a second conduit structure (134), the second conduit structure connected to the vessel, the retainer pin extending at least partially through both the first conduit and the second conduit based on the first and second conduits being at least partially aligned to at least partially define a collective conduit (130c) extending through both the first and second conduits.
Example Embodiment 33: The method of any of Example Embodiments 20 to 32, further comprising:
engaging a retaining element (142) with the retainer pin to at least partially limit movement of the retainer pin out of at least the first conduit.
Example Embodiment 34: The method of any of Example Embodiments 20 to 33, wherein the retaining element is directly connected to a vessel head (12b) of the vessel independently of the vessel body.
Example Embodiment 35: The method of any of Example Embodiments 20 to 34, wherein
the second conduit extends entirely between opposite outer surfaces of the second conduit structure, and
the first conduit extends through a limited portion of the first conduit structure to a bottom end defined by a bottom inner surface (132bs) of the first conduit, such that the first conduit structure is configured to structurally support a distal end (140bs) of the retainer pin at the inner surface of the first conduit.

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims. In addition, while processes have been disclosed herein, it should be understood that the described elements of the processes may be implemented in different orders, using different selections of elements, some combination thereof, etc. For example, some example embodiments of the processes of the inventive concepts may be implemented using fewer elements than that of the illustrated and described processes, and some example embodiments of the processes of the inventive concepts may be implemented using more elements than that of the illustrated and described processes.

1. A pipe connection assembly, comprising:
a fixed pipe, the fixed pipe extending to a fixed pipe proximate end through a sidewall thickness of a vessel body of a vessel such that the fixed pipe proximate end is open to a vessel interior and fixed in relation to the vessel body, the vessel interior at least partially defined by one or more vessel body sidewall inner surfaces of the vessel body, the fixed pipe including a first pipe connector at the fixed pipe proximate end;
a removable pipe, the removable pipe extending between a removable pipe proximate end and a removable pipe distal end, the removable pipe including a second pipe connector at the removable pipe proximate end, the first and second pipe connectors collectively defining a bayonet connection, the removable pipe configured to detachably connect with the fixed pipe via the bayonet connection; and
an anti-rotation assembly configured to at least partially limit movement of the removable pipe in relation to the vessel independently of the bayonet connection, based on the removable pipe being detachably connected with the fixed pipe via the bayonet connection.

2. The pipe connection assembly of claim 1, wherein
one pipe connector of the first pipe connector or the second pipe connector defines one of a socket or a plug, and another pipe connector of the second pipe connector or the first pipe connector defines another one of the plug or the socket,
the one pipe connector of the first pipe connector or the second pipe connector further defines a lug pipe connector including one or more lugs each extending radially in relation to a central axis of the one pipe connector, and the other pipe connector further defines a notch pipe connector including one or more notches configured to receive the one or more lugs, and
the removable pipe is configured to detachably connect with the fixed pipe via the bayonet connection based on
moving the removable pipe proximate end towards the fixed pipe proximate end in an axial direction, the axial direction parallel to a central axis of the removable pipe proximate end, to
cause the one or more lugs to be inserted into separate, respective notches of the one or more notches via separate, respective axial notch openings in the axial direction, and
cause the plug to be at least partially inserted into the socket in the axial direction, and
rotating at least the removable pipe proximate end around the central axis of the removable pipe proximate end in relation to the fixed pipe proximate end to cause azimuthal engagement between the notch pipe connector and the lug pipe connector concurrently with the plug being at least partially inserted into the socket.

3. The pipe connection assembly of claim 2, wherein
the one or more notches each have a notch depth extending through at least a portion of a pipe sidewall thickness of the notch pipe connector, and
the one or more lugs are each configured to extend through at least a portion of a respective notch depth of a respective notch of the one or more notches based on being inserted into the respective notch.

4. The pipe connection assembly of claim 3, wherein
the notch depth extends through an entirety of the pipe sidewall thickness of the notch pipe connector.

5. The pipe connection assembly of claim 4, wherein
the one or more lugs are each configured to each extend into a respective notch of the one or more notches and to further extend through some or all of the pipe sidewall thickness based on being inserted into the respective notch.

6. The pipe connection assembly of claim 2, wherein
the one or more lugs each extend radially inwards to a radial lug height from an inner surface of the socket, and
the one or more notches each extend radially inwards to a respective notch depth through some or all of a pipe sidewall thickness of the plug from an outer surface of the plug.

7. The pipe connection assembly of claim 2, wherein each notch of the one or more notches defines
an axial notch section extending axially in parallel with a central axis of the notch pipe connector from an axial notch opening at an axial end of the notch pipe connector, and
an azimuthal notch section extending at least partially azimuthally around the central axis of the notch pipe connector from the axial notch section.

8. The pipe connection assembly of claim 7, wherein each notch of the one or more notches defines
a chamfer notch section extending both axially and azimuthally between the axial notch section and the azimuthal notch section.

9. The pipe connection assembly of claim 1, wherein the anti-rotation assembly includes
a first conduit structure connected to the removable pipe, the first conduit structure including a first conduit extending at least partially through the first conduit structure,
a second conduit structure connected to the vessel, the second conduit structure including a second conduit extending at least partially through the second conduit structure, and
a retainer pin configured to extend at least partially through each of the first conduit and the second conduit based on the first and second conduits being at least partially aligned to at least partially define a collective conduit extending through both the first and second conduits.

10. The pipe connection assembly of claim 9, further comprising:
a retaining element configured to engage the retainer pin to at least partially limit movement of the retainer pin out of at least the first conduit.

11. The pipe connection assembly of claim 9, wherein
the second conduit extends entirely between opposite outer surfaces of the second conduit structure, and
the first conduit extends through a limited portion of the first conduit structure to a bottom end defined by a bottom inner surface of the first conduit, such that the first conduit structure is configured to structurally support a distal end of the retainer pin at the inner surface of the first conduit.

12. A method of operating a vessel including the pipe connection assembly of claim 1, the method comprising circulating a fluid between the vessel interior and an exterior of the vessel via flow of the fluid between the fixed pipe and the removable pipe detachably connected with the fixed pipe via the bayonet connection.

13. A method of configuring a vessel to include a pipe connection assembly, the method comprising:
providing a vessel body including a fixed pipe, the vessel body including one or more vessel body sidewall inner surfaces at least partially defining a vessel interior, the fixed pipe extending through a sidewall thickness of the vessel body to a fixed pipe proximate end, the fixed pipe proximate end open to the vessel interior and fixed in relation to the vessel body, the fixed pipe including a first pipe connector at the fixed pipe proximate end;
detachably connecting a removable pipe within the vessel interior with the fixed pipe via a bayonet connection, the removable pipe extending between a removable pipe proximate end and a removable pipe distal end, the removable pipe including a second pipe connector at the removable pipe proximate end, the first and second pipe connectors collectively defining the bayonet connection; and
connecting the removable pipe to at least a portion of the vessel body independently of the bayonet connection to at least partially restrict movement of the removable pipe in relation to the vessel body independently of the bayonet connection, based on the removable pipe being detachably connected with the fixed pipe via the bayonet connection.

14. The method of claim 13, wherein
one pipe connector of the first pipe connector or the second pipe connector defines one of a socket or a plug, and another pipe connector of the second pipe connector or the first pipe connector defines another one of the plug or the socket,
the one pipe connector of the first pipe connector or the second pipe connector further defines a lug pipe connector including one or more lugs each extending radially in relation to a central axis of the one pipe connector, and the other pipe connector further defines a notch pipe connector including one or more notches configured to receive the one or more lugs, and
the detachably connecting the removable pipe with the fixed pipe via the bayonet connection includes
moving the removable pipe proximate end towards the fixed pipe proximate end in an axial direction, the axial direction parallel to a central axis of the removable pipe proximate end, to
cause the one or more lugs to be inserted into separate, respective notches of the one or more notches via separate, respective axial notch openings in the axial direction, and
cause the plug to be at least partially inserted into the socket in the axial direction, and
rotating at least the removable pipe proximate end around the central axis of the removable pipe proximate end in relation to the fixed pipe proximate end to cause azimuthal engagement between the notch pipe connector and the lug pipe connector concurrently with the plug being at least partially inserted into the socket.

15. The method of claim 14, wherein
the one or more notches each have a notch depth extending through at least a portion of a pipe sidewall thickness of the notch pipe connector, and
the one or more lugs are each configured to extend through at least a portion of a respective notch depth of a respective notch of the one or more notches based on being inserted into the respective notch.

16. The method of claim 15, wherein
the notch depth extends through an entirety of the pipe sidewall thickness of the notch pipe connector.

17. The method of claim 16, wherein
the one or more lugs are each configured to each extend into a respective notch of the one or more notches and to further extend through some or all of the pipe sidewall thickness based on being inserted into the respective notch.

18. The method of claim 14, wherein each notch of the one or more notches defines
an axial notch section extending axially in parallel with a central axis of the notch pipe connector from an axial notch opening at an axial end of the notch pipe connector, and
an azimuthal notch section extending at least partially azimuthally around the central axis of the notch pipe connector from the axial notch section.

19. The method of claim 18, wherein each notch of the one or more notches defines
a chamfer notch section extending both axially and azimuthally between the axial notch section and the azimuthal notch section.

20. The method of claim 13, wherein the connecting the removable pipe to at least the portion of the vessel independently of the bayonet connection includes extending a retainer pin at least partially through each of a first conduit and a second conduit, the first conduit extending at least partially through a first conduit structure, the first conduit structure connected to the removable pipe, the second conduit extending at least partially through a second conduit structure, the second conduit structure connected to the vessel, the retainer pin extending at least partially through both the first conduit and the second conduit based on the first and second conduits being at least partially aligned to at least partially define a collective conduit extending through both the first and second conduits.
